(19) United States
(12) Patent Application Publication
(10) Pub. No.: US 2009/0109379 A1
(43) Pub. Date: Apr. 30, 2009

(54) LIQUID CRYSTAL DISPLAY DEVICE

(75) Inventors: Nobutaka Fukagawa, Kanagawa (JP); Hiroaki Sata, Kanagawa (JP)

Correspondence Address: BUCHANAN, INGERSOLL & ROONEY PC, POST OFFICE BOX 1404, ALEXANDRIA, VA, 22313-1404, US

(73) Assignee: Fujifilm Coporation, Tokyo (JP)

(21) Appl. No.: 12/295,122

(22) PCT Filed: Mar. 29, 2007
(86) PCT No.: PCT/JP2007/057606

§ 371 Date: Sep. 29, 2008

(30) Foreign Application Priority Data
Mar. 29, 2006 (JP) 2006-092083

(51) Int. Cl. G02F 1/1335; C08K 5/43

(52) U.S. Cl. 349/96; 524/168

(57) ABSTRACT

A polymer film satisfying the following formulae (1) to (4):

−25 nm≦Rth(548)≦25 nm (1)

0≦Rth(446)−Rth(548)≦50 (2)

0≦Rth(548)−Rth(629)≦20 (3)

0 nm≦Re(548)≦5 nm (4)

wherein Rth(λ) represents the value of Rth that is measured at a wavelength of λ nm.

### FIELD OF THE INVENTION

The present invention relates to a polymer film having a specified retardation and wavelength dispersion property, a polarizing plate protective film, a polarizing plate, and a liquid crystal display device employing the polymer film.

### BACKGROUND ART

Widely used conventionally are liquid crystal display devices for monitor with a system in which a liquid crystal layer of twist-aligned nematic liquid crystals are interposed between two orthogonal polarizing plates and an electric field is applied in the perpendicular direction to the substrate, a so-called TN mode. In the system, however, since the liquid crystal rises relative to the substrate at the time of black level, when the screen is viewed from oblique directions, birefringence due to the liquid crystalline compound generates and light leakage occurs. To solve the problem, a system, in which a film in which liquid crystalline compounds are hybrid-aligned is used to compensate optically liquid crystal cells and prevent the light leakage, is put into practical use. However, even when the system is used, it is very difficult to compensate optically liquid crystal cells completely without problem. Consequently, there occurs such problem that graduation reversal in the bottom of a screen can not completely suppressed.

In order to solve such problem, there have been proposed and put into practical use liquid crystal display devices according to a so-called IPS mode or FFS mode in which a lateral electric field is applied to the liquid crystal, and a vertical alignment (VA) mode in which a liquid crystal having negative permittivity anisotropy is alignment-divided by protrusions or slit electrodes formed in a panel. In these years, these panels are being developed not only for monitor application but also for TV application, and, concurrently, the luminance of screens has been significantly improved. Therefore, slight light leakage in a diagonally oblique incident direction at the time of black level and hue change due to the change of viewing angle, which were conventionally not seen as problems in these operation modes, have come to the surface as a cause of the lowering of display quality.

As one of means for improving the viewing angle dependency, it is studied also for the IPS mode and FFS mode to dispose an optical compensatory material having a birefringence property between the liquid crystal layer and the polarizing plate. For example, it is disclosed that, by disposing birefringent media having an action of compensating the increase and decrease of the retardation of an inclined liquid crystal layer and having optical axes perpendicular to each other between a substrate and a polarizing plate, coloring on a screen at white level or gray level when it is viewed straight from an oblique direction can be improved (see JP-A-9-80424). Also, there are proposed such methods that an optical compensatory film formed of styrene-based polymer having negative intrinsic birefringence or a discotic liquid crystalline compound is used (see JP-A-10-54982, JP-A-11-202323, JP-A-9-292522), that a film having a positive birefringence and an optical axis in the plane of the film, and a film having a positive birefringence and an optical axis in the normal direction of the film are combined to be an optical compensatory film (see JP-A-11-133408), that a biaxial optical compensatory sheet having a retardation of half-wavelength is used (see JP-A-11-305217), and that a film having negative retardation is used as a protective film for a polarizing plate and an optical compensatory layer having positive retardation is provided thereon (see JP-A-10-307291).

In addition, proposed is a method for improving the viewing angle dependency by reducing retardation that is owned by a polarizing plate protective film (see JP-A-2006-30937).

However, the above-described methods result in a certain degree of improvement of the contrast when the screen is viewed from an oblique direction, but, at the time of black level or gray level, they have given only an insufficient property for the improvement of hue change due to the change of viewing angle. Therefore, further improvement is expected.

### SUMMARY OF THE INVENTION

The invention was achieved with the view of the above various problems, and aims to provide liquid crystal display devices of the IPS mode or FFS mode that are significantly improved in viewing angle hue change, in addition to viewing angle contrast, with a simple constitution.

As the result of hard works, the present inventors found that the hue change of liquid crystal display devices depending on the viewing angle can be reduced significantly by using, in particular, a polymer film having a low retardation and such property that Rth thereof is greater at a shorter wavelength (hereinafter, occasionally referred to as “forward wavelength dispersion property”) as a polarizing plate protective film, to complete the invention.

That is, the problems were dissolved according to the following manners.

(1) A polymer film having Rth and Re that satisfy the following formulae (1) to (4):

−25 nm≦Rth(548)≦25 nm (1)

0≦Rth(446)−Rth(548)≦50 (2)

0≦Rth(548)−Rth(629)≦20 (3)

0 nm≦Re(548)≦5 nm (4)

wherein Rth(λ) represents the value of Rth that is measured at a wavelength of λ nm.
(2) The polymer film as described in (1) comprising mainly cellulose acylate.
(3) The polymer film as described in (1) or (2) comprising a compound having at least one absorption maximum within a wavelength range of 250 nm to 400 nm in 1% by mass to 30% by mass.
(4) The polymer film as described in any one of (1) to (3) comprising mainly cellulose acylate having an acyl substitution degree of 2.90 to 3.00.
(5) The polymer film as described in any one of (1) to (3) comprising mainly a mixed aliphatic acid ester of cellulose having a total acyl substitution degree of 2.70 to 3.00.
(6) The polymer film as described in any one of (1) to (5) comprising at least one of compounds as shown by the following formula (B):

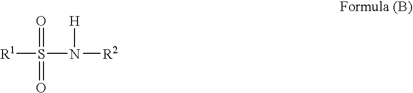

wherein R¹ and R² each independently represents an alkyl group or an aryl group.
(7) The polymer film as described in any one of (1) to (6) comprising acrylic polymer having a weight average molecular weight of 500 to 10,000.
(8) A polarizing plate protective film comprising the polymer film as described in any on of (1) to (7).
(9) A polarizing plate comprising a polarizer and a protective film that is disposed at least on one side of the polarizer, wherein the protective film is the polymer film as described in any one of (1) to (7).
(10) A liquid crystal display device comprising a liquid crystal cell and two polarizing plates that are disposed on both sides thereof, the polarizing plate comprising a polarizer and two protective films that are disposed on both sides thereof, wherein at least one of the protective films on the liquid crystal cell side of the polarizing plate is the polarizing plate protective film as described in any one of (1) to (7).
(11) The liquid crystal display device as described in (10) wherein the liquid crystal cell is of the IPS mode.

According to the invention, it is possible to provide a liquid crystal display device having a small hue viewing angle dependency.

### BRIEF DESCRIPTION OF THE DRAWINGS

FIG. 1 is an outline view illustrating the example of a pixel area of the liquid crystal display device of the invention.

FIG. 2 is an outline view illustrating the example of the liquid crystal display device of the invention.

FIG. 3 is an outline view illustrating the example of the liquid crystal display device of the invention.

FIG. 4 is an outline view illustrating the example of the liquid crystal display device of the invention.

FIG. 5 is an outline view illustrating the example of the liquid crystal display device of the invention.

FIG. 6 is an outline view illustrating the example of the liquid crystal display device of the invention.

FIG. 7 is an outline view illustrating the example of the liquid crystal display device of the invention.

FIG. 8 is an outline view illustrating the example of the liquid crystal display device of the invention.

In the Drawings, 1 is a liquid crystal element pixel area, 2 is a pixel electrode, 3 is a display electrode, 4 is rubbing direction, 5a, 5b are the director of a liquid crystal compound at the time of black level, 6a, 6b are the director of a liquid crystal compound at the time of white level, 7 is a light diffusing layer, 8 and 14 are polarizer, 9 and 15 are the absorption axis direction of the polarizer, 10 is an optically anisotropic layer, 11 is the slow axis direction of an optically anisotropic layer, 12 is a liquid crystal cell, 13 is the slow axis direction of a liquid crystal layer of a liquid crystal cell, 16, 17, 18 and 19 are the protective film of a polarizer, 20 is a second optically anisotropic layer, 21 is a first optically anisotropic layer, 22 is the slow axis direction of the first optically anisotropic layer, 23 is a second optically anisotropic layer, 24 is a first optically anisotropic layer, and 25 is the slow axis direction of the first optically anisotropic layer.

### DETAILED DESCRIPTION OF THE INVENTION

Hereinafter, the content of the invention is described in detail. Incidentally, “to” herein is used in the sense of including numerals that are described before and after it as the lower limit and the upper limit, respectively.

The invention uses the polymer film having Rth of within the range of −25 nm to 25 nm at the wavelength of 548 nm and forward wavelength dispersion property (hereinafter, occasionally referred to as a “forward wavelength dispersion low retardation film”) as a polarizing plate protective film. Firstly, the forward wavelength dispersion low retardation film of the invention is describe in detail.

### <<Forward Wavelength Dispersion Low Retardation Film>>

### [Retardation of Film]

The forward wavelength dispersion low retardation film of the invention satisfies the following formulae (1) to (4):

−25 nm≦Rth(548)≦25 nm (1)

0≦Rth(446)−Rth(548)≦50 (2)

0≦Rth(548)−Rth(629)≦20 (3)

0 nm≦Re(548)≦5 nm (4).

In the formula (1), Rth(548) is preferably −10 nm to 10 nm, more preferably −5 nm to 5 nm.

In the formula (2), Rth(446) to Rth(548) is furthermore preferably 5 nm to 30 nm, most preferably 10 nm to 25 nm.

In the formula (3), Rth(548) to Rth(629) is furthermore preferably 0 nm to 15 nm, most preferably 2 nm to 10 nm.

In the formula (4), Re(548) is furthermore preferably 0 nm to 3 nm.

Re(λ) and Rth(λ) represent, herein, the retardation in the plane and the retardation in the thickness direction, respectively, at a wavelength of B. Re(λ) is measured with KOBRA21ADH or WR (by Oji Scientific Instruments) while allowing light having the wavelength of λ nm to enter in the normal direction of a film.

In case where the film to be measured is a film that is represented by a uniaxial or biaxial indicatrix, Rth(λ) is computed by the following method.

That is, respective Re(λ)s are measured at total six points in the normal direction of the film relative to the film surface and in directions inclined every 10° up to 50° on one side from the normal line around an in-plane slow axis (determined by KOBURA 21AD or WR) as an inclination axis (rotation axis) (in case where no slow axis exists, any direction in the plane of the film is defined as a rotation axis) for an incoming light of a wavelength of λ nm, and KOBRA 21ADH or WR computes the Rth(λ) on the basis of the measured retardation, an assumed value of an average refraction index and an input thickness.

In the above instance, in case where a film has a direction in which the retardation becomes zero at a certain inclination angle from the normal line relative to the film surface around the in-plane slow axis direction (rotation axis), the retardation at an inclination angle greater than the inclination angle is computed by KOBRA 21ADH or WR after changing the sign thereof to negative.

Further, it is also possible to compute Rth according to the following formulae (1) and (2) by measuring the retardation in two arbitrarily inclined directions around the slow axis as the inclination axis (rotation axis) (in case where no slow axis exists, any direction in the plane of the film is defined as a rotation axis), and basing on the measured value, an assumed value on an average refraction index and an input thickness value.

$$Re ( θ ) = [ nx - \frac{ny \times nz}{\sqrt{\begin{matrix}{( ny sin ( {sin}^{- 1} ( \frac{sin ( - θ )}{nx} ) ) )}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} \qquad ( 1 )$$

### Note:

The above Re(θ) represents the retardation in a direction that inclines in the degree of θ from the normal direction. In the formula (1), nx represents the refraction index in the slow axis direction in the plane, ny represents the refraction index in the direction perpendicular to nx in the plane, and nz represents the refraction index in the direction perpendicular to the directions of nx and ny.

Rth=((nx+ny)/2−nz)×d (2)

In case where the film to be measured is a film that can not be expressed by a uniaxial or biaxial indicatrix, that is, a so-called film having no optic axis, Rth(λ) is computed according to the following method.

Rth(λ) is computed from the retardation that is obtained by measuring the Re(λ) at total eleven points in directions inclined every 10° from −50° up to +500 from the normal line relative to the film surface around an in-plane slow axis (determined by KOBURA 21AD or WR) as an inclination axis (rotation axis) for an incoming light of a wavelength of λ nm entering from each of the directions of inclination, an assumed value of an average refraction index and input thickness with KOBRA 21ADH or WR.

In the above measurement, the assumed value of the average refraction index may be obtained from Polymer Handbook (JOHN WILEY & SONS, INC) and catalogs for various optical films. Polymers for which the average refraction index is unknown, the index can be measured with an Abbe refractometer. The average refraction indices of principal optical films are exemplified below: cellulose acylate (1.48), cycloolefin polymer (1.52), polycarbonate (1.59), polymethyl methacrylate (1.49), polystyrene (1.59). By inputting the assumed value of these average refraction indices and thickness, KOBRA 21ADH or WR computes nx, ny, nz. From the computed nx, ny, nz, Nz=(nx−nz)/(nx−ny) is computed further.

For the forward wavelength dispersion polymer film of the invention, various polymer films are usable, and, of these, a cellulose acylate film containing mainly cellulose acylate is especially preferred from the viewpoint of the low cost of raw materials and the processability of a polarizing plate.

The term “contain mainly cellulose acylate” means that cellulose acylate is contained in, for example, 70% by mass or more relative to the total weight of the film, preferably 80% by mass or more. Hereinafter, the term “contain mainly cellulose acylate” herein means the same sense.

### [Cellulose Acylate]

Next, cellulose acylate that can be employed for the invention is described.

The substitution degree of cellulose acylate means the percentage of acylation of three hydroxyl groups existing in the constitutional unit ((β)1,4-glycosidically-bound glucose) of cellulose. The substitution degree (acylation degree) can be obtained from the peak strength of the carbonyl carbon of the acyl group in ¹³C NMR.

The cellulose acylate in the invention has the acyl substitution degree of preferably from 2.90 to 3.00, further preferably from 2.93 to 2.97.

Another preferred cellulose acylate in the invention is mixed aliphatic acid ester having the total acyl substitution degree of from 2.70 to 3.00. Further preferred is mixed aliphatic acid ester having the total acyl substitution degree of from 2.80 to 3.00 and an acyl group having from 3 to 4 carbon atoms. The acyl substitution degree of the mixed aliphatic acid ester is further preferably from 2.85 to 2.97. The substitution degree with an acyl group having from 3 to 4 carbon atoms is preferably from 0.1 to 2.0, further preferably from 0.3 to 1.5.

Further, another preferred cellulose acylate of the invention is a mixed ester having an acetyl group and an acyl group that is different from the acetyl group (hereinafter a substituent B) and wherein the polarizability anisotropy, which is represented by the following formula (1), of the substituent B is 2.5×10⁻²⁴ cm³ or greater.

Δα=αx−(αy+αz)/2 Formula (1)

wherein αx is the largest component among the eigenvalues that are obtained after diagonalizing the polarizability tensor; αy is the second-largest component among the eigenvalues that are obtained after diagonalizing the polarizability tensor; and αz is the smallest component among the eigenvalues that are obtained after diagonalizing the polarizability tensor.

The polarizability anisotropy of a substituent can be computed using Gaussian03 (Revision B.03, a software by Gaussian, U.S.A.). In the invention, the polarizability anisotropy is computed from the diagonal component that is obtained in such a manner that, by using a construction that is optimized at the B3LYP/6-31G* level, a substituent that is linked to a hydroxyl group on a β-glucose ring being the constituent unit of cellulose is grasped as a partial construction including an oxygen atom of a hydroxyl group at the B3LYP/6-311+G** level and then the obtained polarizability tensor is diagonalized.

The polarizability anisotropy of the substituent B of the cellulose acylate of the invention is furthermore preferably 4.0×10⁻²⁴ cm³ to 300×10⁻²⁴ cm³, most preferably 6.0×10⁻²⁴ cm³ to 300×10⁻²⁴ cm³. For the substituent having a large polarizability anisotropy, an aromatic acyl group is especially preferred because it has a large hydrophobizing effect and gives a film whose free volume is hardly expanded.

Further, the substitution degree of the substituent B and an acetyl group preferably satisfies the following formulae:

DS_{B}2+DS_{B}3−DS_{B}6≧−0.1 (A1)

DS_{A}2+DS_{A}3+DS_{A}6>DS_{B}2+DS_{B}3+DS_{B}6 (A2)

1.5≦DS_{A}2+DS_{A}3+DS_{A}6+DS_{B}2+DS_{B}3+DS_{B}6≦3.0 (A3)

wherein DS_{A}β represents the substitution degree of an acetyl group at the β-site, and DS_{B}β represents the substitution degree of the substituent B at the β-site.

The formula (A1) satisfies:

furthermore preferably DS_{B}2+DS_{B}3−DS_{B}6≧0,
most preferably DS_{B}2+DS_{B}3−DS_{B}6≅0.2.

The formula (A2) satisfies:

furthermore preferably DS_{A}2+DS_{A}3+DS_{A}6>DS_{B}2+DS_{B}3+DS_{B}6+0.5,
most preferably DS_{A}2+DS_{A}3+DS_{A}6>DS_{B}2+DS_{B}3+DS_{B}6+1.0.

The formula (A3) satisfies:

furthermore preferably 2.0≦DS_{A}2+DS_{A}3+DS_{A}6+DS_{B}2+DS_{B}3+DS_{B}6≦3.0,
most preferably 2.4≦DS_{A}2+DS_{A}3+DS_{A}6+DS_{B}2+DS_{B}3+DS_{B}6≦3.0.

When the substitution degree satisfies the above-described relation, a cellulose acylate film having a smaller retardation in the thickness direction and a reduced water permeability and water content can be obtained.

For the substituent B of the cellulose acylate of the invention, especially preferred is a group represented by the formula (I).

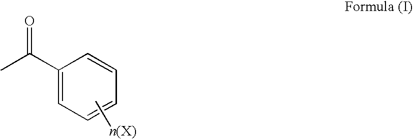

Firstly, the description is given about the formula (I). In the formula (I), X represents a substituent. The example of the substituent includes a halogen atom, a cyano group, an alkyl group, an alkoxy group, an aryl group, an aryloxy group, an acyl group, a carbonamide group, a sulfonamide group, an ureido group, an aralkyl group, a nitro group, an alkoxycarbonyl group, an aryloxycarbonyl group, an aralkyloxycarbonyl group, a carbamoyl group, a sulfamoyl group, an acyloxy group, an alkenyl group, an alkynyl group, an alkylsulfonyl group, an arylsulfonyl group, an alkyloxysulfonyl group, an aryloxysulfonyl group, an alkylsulfonyloxy group and an aryloxysulfonyl group, —S—R, —NH—CO—OR, —PH—R, —P(—R)₂, —PH—O—R, —P(—R)(—O—R), —P(—O—R)₂, —PH(═O)—R—P(═O) (—R)₂, —PH(═O)—O—R, —P(═O) (—R) (—O—R), —P(═O) (—O—R)₂, —O—PH(═O)—R, —O—P(═O) (—R)₂—O—PH(═O)—O—R, —O—P(═O)(—R)(—O—R), —O—P(═O) (—O—R)₂, —NH—PH(═O)—R, —NH—P(═O) (—R) (—O—R), —NH—P(═O) (—O—R)₂, —SiH₂—R, —SiH(—R)₂, —Si (—R)₃, —O—SiH₂—R, —O—SiH(—R)₂ and —O—Si (—R)₃. The R represents an aliphatic group, an aromatic group or a heterocyclic group.

In the formula (1), n is the number of the substituent, and represents 0 or an integer of 1 to 5. The number of the substituent (n) is preferably 1 to 5, more preferably 1 to 4, furthermore preferably 1 to 3, most preferably 1 or 2. The substituent as described above is preferably a halogen atom, a cyano group, an alkyl group, an alkoxy group, an aryl group, an aryloxy group, an acyl group, a carbonamide group, a sulfonamide group or an ureido group, more preferably a halogen atom, a cyano group, an alkyl group, an alkoxy group, an aryloxy group, an acyl group or a carbonamide group, furthermore preferably a halogen atom, a cyano group, an alkyl group, an alkoxy group or an aryloxy group, most preferably a halogen atom, an alkyl group or an alkoxy group.

The halogen atom includes a fluorine atom, a chlorine atom, a bromine atom and an iodine atom. The alkyl group may have a cyclic structure or a branch. The alkyl group has preferably 1 to 20 carbon atoms, more preferably 1 to 12, furthermore preferably 1 to 6, most preferably 1 to 4. The example of the alkyl group includes a methyl group, an ethyl group, a propyl group, an isopropyl group, a butyl group, a tert-butyl group, a hexyl group, a cyclohexyl group, an octyl group and a 2-ethylhexyl group. The alkoxy group may have a cyclic structure or a branch. The alkoxy group has preferably 1 to 20 carbon atoms, more preferably 1 to 12, furthermore preferably 1 to 6, most preferably 1 to 4. The alkoxy group may have been further substituted with another alkoxy group. The example of the alkoxy group includes a methoxy group, an ethoxy group, a 2-methoxyethoxy group, a 2-methoxy-2-ethoxyethoxy group, a butyloxy group, a hexyloxy group and an octyloxy group.

The aryl group has preferably 6 to 20 carbon atoms, furthermore preferably 6 to 12. The example of the aryl group includes a phenyl group and a naphthyl group. The aryloxy group has preferably 6 to 20 carbon atoms, furthermore preferably 6 to 12. The example of the aryloxy group includes a phenoxy group and a naphthoxy group. The acyl group has preferably 1 to 20 carbon atoms, furthermore preferably 1 to 12. The example of the acyl group includes a formyl group, an acetyl group and a benzoyl group. The carbonamide group has preferably 1 to 20 carbon atoms, furthermore preferably 1 to 12. The example of the carbonamide group includes an acetamide group and a benzamide group. The sulfonamide group has preferably 1 to 20 carbon atoms, furthermore preferably 1 to 12. The example of the sulfonamide group includes a methanesulfonamide group, a benzenesulfonamide group and a p-toluenesulfonamide group. The ureido group has preferably 1 to 20 carbon atoms, furthermore preferably 1 to 12. The example of the ureido group includes (unsubstituted) ureido.

The aralkyl group has preferably 7 to 20 carbon atoms, furthermore preferably 7 to 12. The example of the aralkyl group includes a benzyl group, a phenethyl group and a naphthylmethyl group. The alkoxycarbonyl group has preferably 2 to 20 carbon atoms, furthermore preferably 2 to 12. The example of the alkoxycarbonyl group includes a methoxycarbonyl group. The aryloxycarbonyl group has preferably 7 to 20 carbon atoms, furthermore preferably 7 to 12. The example of the aryloxycarbonyl group includes a phenoxycarbonyl group. The aralkyloxycarbonyl group has preferably 8 to 20 carbon atoms, furthermore preferably 8 to 12. The example of the aralkyloxycarbonyl group includes a benzyloxycarbonyl group. The carbamoyl group has preferably 1 to 20 carbon atoms, furthermore preferably 1 to 12. The example of the carbamoyl group includes an (unsubstituted) carbamoyl group and an N-methylcarbamoyl group. The sulfamoyl group has preferably 20 or less carbon atoms, furthermore preferably 12 or less. The example of the sulfamoyl group includes an (unsubstituted) sulfamoyl group and an N-methylsulfamoyl group. The acyloxy group has preferably 1 to 20 carbon atoms, furthermore preferably 2 to 12. The example of the acyloxy group includes an acetoxy group and a benzoyloxy group.

The alkenyl group has preferably 2 to 20 carbon atoms, furthermore preferably 2 to 12. The example of the alkenyl group includes a vinyl group, an aryl group and an isopropenyl group. The alkynyl group has preferably 2 to 20 carbon atoms, furthermore preferably 2 to 12. The example of the alkynyl group includes a thienyl group. The alkylsulfonyl group has preferably 1 to 20 carbon atoms, furthermore preferably 1 to 12. The arylsulfonyl group has preferably 6 to 20 carbon atoms, furthermore preferably 6 to 12. The alkyloxysulfonyl group has preferably 1 to 20 carbon atoms, furthermore preferably 1 to 12. The aryloxysulfonyl group has preferably 6 to 20 carbon atoms, furthermore preferably 6 to 12. The alkylsulfonyloxy group has preferably 1 to 20 carbon atoms, furthermore preferably 1 to 12. The aryloxysulfonyl group has preferably 6 to 20 carbon atoms, furthermore preferably 6 to 12.

When an aromatic ring has two or more substituents, the substituents may be the same with or different from each other, or link with each other to form a condensed polycyclic group (e.g., a naphthalene group, an indene group, an indane group, a phenanthrene group, a quinoline group, an isoquinoline group, a chromane group, a chroman group, a phthalazine group, an acridine group, an indole group, an indoline group). Specific examples of the aromatic acyl group as shown by the formula (1) are shown below. Of these, preferred are Nos. 1, 3, 5, 6, 8, 13, 18, 28, and more preferred are Nos. 1, 3, 6, 13.

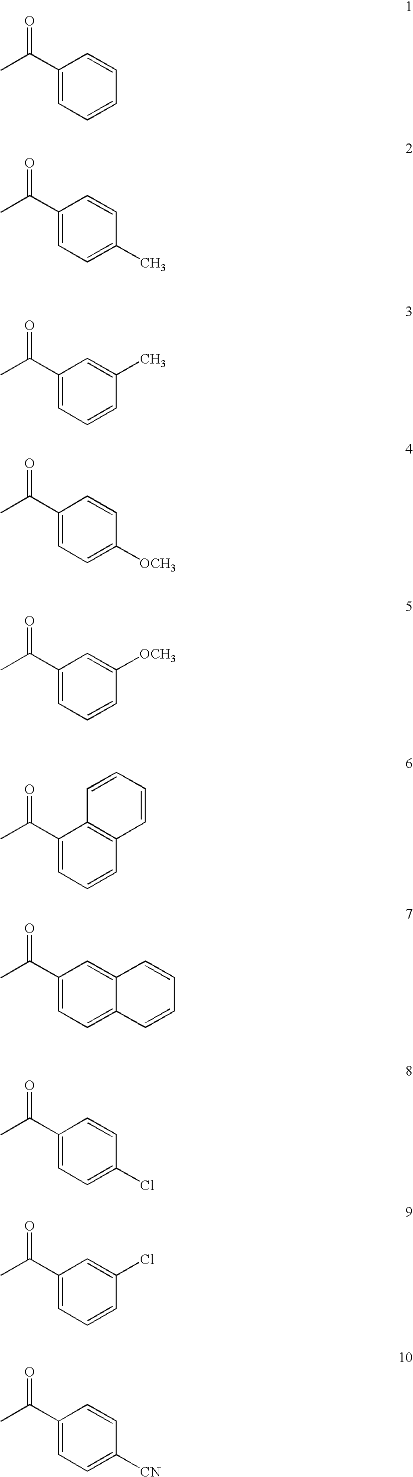

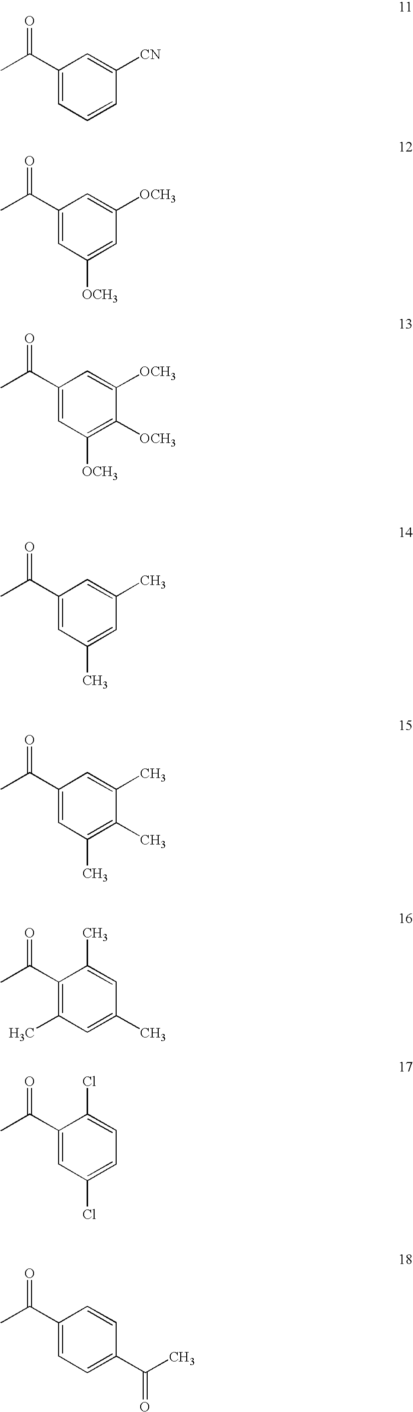

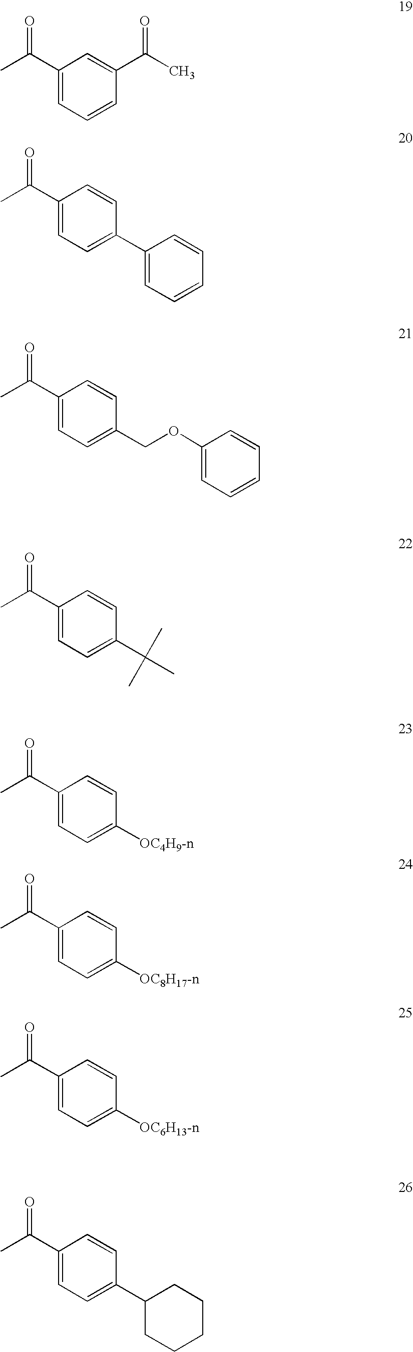

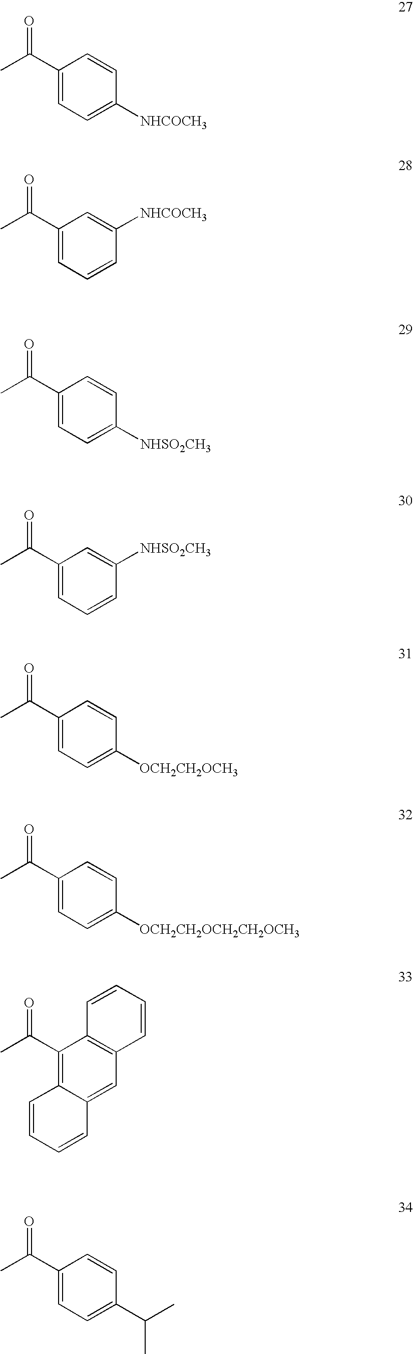

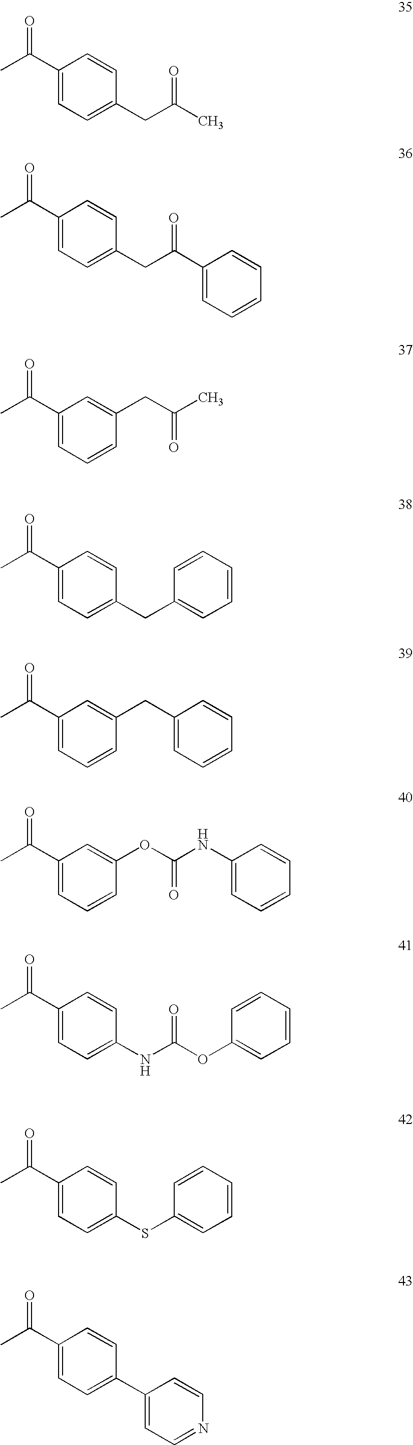

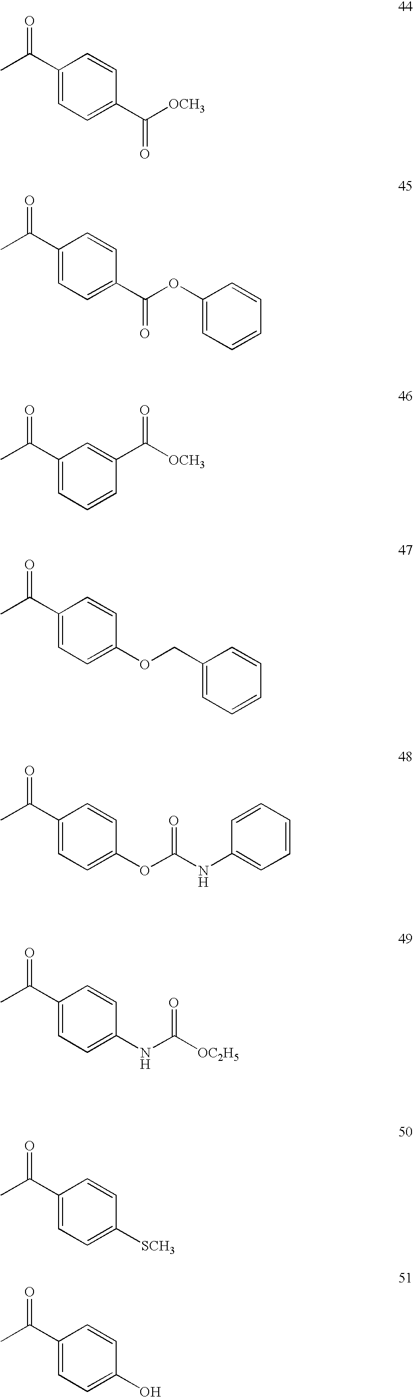

The cellulose acylate for use in the invention has the mass average polymerization degree of preferably from 350 to 800, further preferably from 370 to 600. The cellulose acylate for use in the invention has the number average molecular weight of preferably from 70,000 to 230,000, further preferably from 75,000 to 230,000, most preferably from 78,000 to 120,000.

The cellulose acylate for use in the invention can be synthesized using acid anhydride or acid chloride as an acylating agent. In case where the acylating agent is acid anhydride, as a reaction solvent, organic acid (e.g., acetic acid) or methylene chloride is used. As a catalyst, such a protonic catalyst as sulfuric acid can be used. When the acylating agent is acid chloride, a basic compound can be used as the catalyst. In the most common industrial synthetic method, cellulose is esterified with a mixed organic acid component containing an organic acid (acetic acid, propionic acid, butyric acid) or anhydride thereof (acetic anhydride, propionic anhydride, butyric anhydride) corresponding to an acetyl group or other acyl groups to synthesize cellulose ester.

For a method of obtaining a mixed acylate ester of cellulose, such methods can be employed as reacting two types of carboxylic anhydrides as acylation agents by adding these in a mixture or sequentially, using a mixed acid anhydride of two types of carboxylic acids (e.g., an acetic acid/propionic acid mixed anhydride), synthesizing a mixed acid anhydride (e.g., an acetic acid/propionic acid anhydride) in a reaction system using anhydride of a carboxylic acid and another carboxylic acid (e.g., acetic acid and propionic acid) as starting materials to react the mixed acid anhydride with cellulose, synthesizing once cellulose acylate with a substitution degree of less than 3 and acylating further remaining hydroxyl groups using acid anhydride or acid halide.

In this method, such cellulose as cotton linter and wood pulp is often esterified using a mixed liquid including the above-described organic acid components in the presence of a sulfuric acid catalyst after activation treatment with such organic acid as acetic acid. The organic acid anhydride component is used, generally, in an excess amount relative to the amount of hydroxyl groups existing in cellulose. In the esterification treatment, in addition to the esterification reaction, hydrolysis reaction (depolymerization reaction) of the cellulose main chain ((β)1,4-glycoside bond) proceeds. When the hydrolysis reaction of the main chain proceeds, the polymerization degree of cellulose ester lowers to degrade the physical properties of the cellulose ester film to be produced. Accordingly, such reaction condition as reaction temperature is preferably determined while taking the polymerization degree and molecular weight of cellulose ester to be obtained into consideration.

In order to obtain a cellulose ester having a high polymerization degree (large molecular weight), it is important to adjust the highest temperature during the esterification process at 50° C. or lower. The highest temperature is adjusted at preferably from 35 to 50° C., further preferably from 37 to 47° C. The reaction temperature of 35° C. or higher allows the esterification reaction to proceed smoothly, which is preferred. On the other hand, the reaction temperature of 50° C. or lower does not result in such a disadvantage as the lowering of the polymerization degree of the cellulose ester, which is preferred.

After the esterification reaction, by terminating the reaction while inhibiting the temperature rise, it is possible to inhibit further the lowering of the polymerization degree and to synthesize a cellulose ester having a high polymerization degree. That is, by the addition of a reaction terminating agent (e.g., water, acetic acid) after the end of the reaction, an excess acid anhydride that has not been engaged in the esterification reaction is hydrolyzed to produce the corresponding organic acid as a by-product. This hydrolysis reaction is accompanied with heavy heat generation to raise the temperature in the reaction apparatus. In case where the addition rate of the reaction terminating agent is not too great, there occurs no such problem that heat generates rapidly over the cooling capacity of the reaction apparatus to lead to significant proceeding of the hydrolysis reaction of the cellulose main chain, and that the polymerization degree of the cellulose ester to be obtained is lowered. A part of the catalyst is bonded to the cellulose during the esterification reaction, and most of these are dissociated from the cellulose during the addition of the reaction terminating agent. At this time, when the addition rate of the reaction terminating agent is not too great, a sufficient reaction time is assured for the dissociation of the catalyst, thereby hardly allowing such a problem to occur that a part of the catalyst remains in the bonded state to the cellulose. Cellulose ester to which a catalyst of strong acid is bonded partially has a very low stability, and decomposes easily with heat at drying the product to lower the polymerization degree. From these reasons, after esterification reaction, it is desirable to add a reaction terminating agent over preferably 4 minutes or more, further preferably from 4 to 30 minutes to terminate the reaction. Incidentally, the time of 30 minutes or less for adding the reaction terminating agent does not result in such a problem as the lowering of the industrial productivity, which is preferred.

As the reaction terminating agent, generally, water or alcohol capable that decomposes acid anhydride is employed. But, in the invention, in order not to allow triester having low solubility for various organic solvents to precipitate, a mixture of water and organic acid is employed preferably as a reaction terminating agent. By carrying out esterification reaction under the aforementioned conditions, it is easy to synthesize such a high molecular weight cellulose ester as the mass average polymerization degree of 500 or more.

### [Wavelength Dispersion-controlling Agent]

The cellulose acylate film in the invention contains preferably a wavelength dispersion-controlling agent. A “wavelength dispersion-controlling agent” herein means a compound for adjusting the wavelength dispersion of the retardation of a film.

The wavelength dispersion-controlling agent in the invention has the absorption maximum within the wavelength range of preferably 250 nm to 400 nm, further preferably 270 nm to 380 nm.

In the invention, the absorption maximum of the wavelength dispersion-controlling agent is represented by a value that is obtained by dissolving the agent in methylene chloride, methanol or tetrahydrofuran in a concentration of 0.01 g/L to 0.1 g/L, and by measuring the absorption spectrum with a spectral photometer UV-3500 by SHIMADZU, etc.

Specific examples of the preferred wavelength dispersion-controlling agent for use in the invention are preferably compounds that are represented by formulae (III) to (VI).

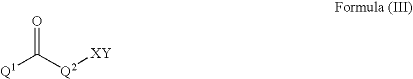

wherein Q¹ and Q² each represents an aromatic ring. X represents a substituent, Y represents an oxygen atom, a sulfur atom or a nitrogen atom. XY may be a hydrogen atom.

Q¹ and Q² each may have a substituent other than the “XY.” Q¹ and Q² each may be a monocyclic or condensed ring.

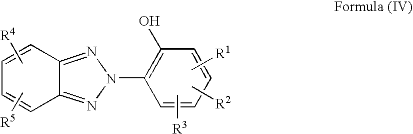

wherein R¹, R², R³, R⁴ and R⁵ each represents a monovalent organic group, and at least one of R¹, R² and R³ is an unsubstituted branched or linear alkyl group having the total carbon atoms of 10 to 20.

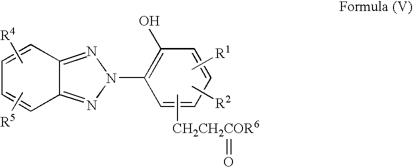

wherein R¹, R², R⁴ and R⁵ each represents a monovalent organic group, and R⁶ represents a branched alkyl group.

In addition, as described in JP-A-2003-315549, compounds that are represented by formula (VI) can be also used preferably.

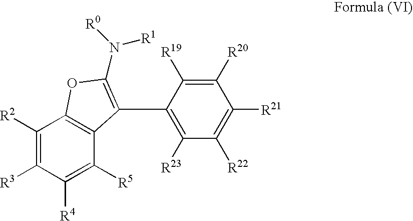

wherein R⁰ and R¹ each independently represents a hydrogen atom, an alkyl group having 1 to 25 carbon atoms, a phenylalkyl group having 7 to 9 carbon atoms, an unsubstituted or an alkyl group having 1 to 4 carbon atoms-substituted phenyl group, a substituted or unsubstituted oxycarbonyl group, or a substituted or unsubstituted aminocarbonyl group. R² to R⁵ and R¹⁹ to R²³ each independently represents a hydrogen atom or a substituted or unsubstituted alkyl group having 2 to 20 carbon atoms.

Furthermore, for example, oxybenzophenone-based compounds, benzotriazole-based compounds, salicylic acid ester-based compounds, cyanoacrylate-based compounds, and nickel complex-based compounds can be exemplified.

Examples of the compounds represented by the formula (III) include benzophenone compounds.

Examples of the preferred benzotriazole-based wavelength dispersion-controlling agent include
2-(2′-hydroxy-5′-methylphenyl)benzotriazole,
2-(2′-hydroxy-3′,5′-di-tert-butylphenyl)benzotriazole,
2-(2′-hydroxy-3′-tert-butyl-5′-methylphenyl)benzotriazole,
2-(2′-hydroxy-3′,5′-di-tert-butylphenyl)-5-chlorobenzotriazole,
2-(2′-hydroxy-3′-(3″,4″,5″,6″-tetrahydrophthalimidomethyl)-5′-methylphenyl)benzotriazole,
2,2-methylenebis(4-(1,1,3,3-tetramethylbutyl)-6-(2H-benzotriazole-2-yl)phenol),
2-(2′-hydroxy-3′-tert-butyl-5′-methylphenyl)-5-chlorobenzotriazole, 2,4-dihydroxy-benzophenone,
2,2′-dihydroxy-4-methoxybenzophenone,
2-hydroxy-4-methoxy-5-sulfobenzophenone,
bis(2-methoxy-4-hydroxy-5-benzoylphenylmethane),
(2,4-bis(n-octylthio)-6-(4-hydroxy-3,5-di-tert-butylanilino)-1,3,5-triazine,
2(2′-hydroxy-3′,5′-di-tert-butylphenyl)-5-chlorobenzotriazole.
(2(2′-hydroxy-3′,5′-di-tert-amylphenyl)-5-chlorobenzotriazole, 2,6-di-tert-butyl-p-cresol,
pentaerythrityl-tetrakis[3-(3,5-di-tert-butyl-4-hydroxyphenyl)propionate], triethylene
glycol-bis[3-(3-tert-butyl-5-methyl-4-hydroxyphenyl)propionate],
1,6-hexanediol-bis[3-(3,5-di-tert-butyl-4-hydroxyphenyl)propionate],
2,4-bis(n-octylthio)-6-(4-hydroxy-3,5-di-tert-butylanilino)-1,3,5-triazine,
2,2-thio-diethylenebis[3-(3,5-di-tert-butyl-4-hydroxyphenyl)propionate],
octadecyl-3-(3,5-di-tert-butyl-4-hydroxyphenyl)propionate,
N,N′-hexamethylenebis(3,5-di-tert-butyl-4-hydroxy-hydrocinnamide),
1,3,5-trimethyl-2,4,6-tris(3,5-di-tert-butyl-4-hydroxybenzyl)benzene, and
tris(3,5-di-tert-butyl-4-hydroxybenzyl)-isocyanurate. In particular, preferred are
(2,4-bis(n-octylthio)-6-(4-hydroxy-3,5-di-tert-butylanilino)-1,3,5-triazine,
2(2′-hydroxy-3′,5′-di-tert-butylphenyl)-5-chlorobenzotriazole,
(2(2′-hydroxy-3′,5′-di-tert-amylphenyl)-5-chlorobenzotriazole, 2,6-di-tert-butyl-p-cresol,
pentaerythrityl-tetrakis[3-(3,5-di-tert-butyl-4-hydroxyphenyl)propionate], and triethylene glycol
bis[3-(3-tert-butyl-5-methyl-4-hydroxyphenyl)propionate].
   Benzotriazole-based wavelength dispersion-controlling agents that can be used in the invention are not limited by the above exemplified compounds.

Further, for example, such a hydrazine-based metal deactivator as N,N′-bis[3-(3,5-di-tert-butyl-4-hydroxyphenyl)propionyl]hydrazine and such a phosphorous-based processing stabilizer as tris(2,4-di-tert-butylphenyl) phosphite may be used in combination. The addition amount of these compounds is preferably 1 ppm to 1.0% by mass relative to cellulose acylate, further preferably 10 to 1000 ppm.

Next, the wavelength dispersion-controlling agent that is represented by the following formula (VII) is described in detail.

Q¹-Q²-OH Formula (VII)

wherein Q¹ represents a 1,3,5-triazine ring, and Q² represents an aromatic ring.

Among these compounds that are represented by the formula (VII), further preferred are compounds that are represented by the following formula (VII-A).

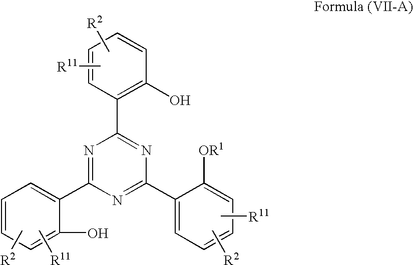

wherein R¹¹ represents a hydrogen atom; an alkyl group having 1 to 18 carbon atoms; a cycloalkyl group having 5 to 12 carbon atoms; an alkenyl group having 3 to 18 carbon atoms; a phenyl group; an alkyl group having 1 to 18 carbon atoms substituted with a phenoxy group, an alkoxy group having 1 to 4 carbon atoms substituted with a phenyl group, a bicycloalkoxy group having 6 to 15 carbon atoms, a bicycloalkylalkoxy group having 6 to 15 carbon atoms, a bicycloalkenylalkoxy group having 6 to 15 carbon atoms, substituted with or a tricycloalkoxy group having 6 to 15 carbon atoms, that are substituted with a substituent selected from the substituent group consisting of a phenyl group, —OH, an alkoxy group having 1 to 18 carbon atoms, a cycloalkoxy group having 5 to 12 carbon atoms, an alkenyloxy group having 3 to 18 carbon atoms, a halogen atom, —COOH, —COOR⁴, —O—CO—R⁵, —O—CO—O—R⁶, —CO—NH₂, —CO—NHR⁷, —CO—N(R⁷)(R⁸), —CN, —NH₂, —NHR⁷, —N(R⁷)(R⁸), —NH—CO—R⁵, a phenoxy group and an alkyl group having 1 to 18 carbon atoms; a cycloalkyl group having 5 to 12 carbon atoms being substituted with a substituent selected from the substituent group consisting of —OH, an alkyl group having 1 to 4 carbon atoms, an alkenyl group having 2 to 6 carbon atoms and —O—CO—R⁵; a glycidyl group; —CO—R⁹; —SO₂—R¹⁰; an alkyl group having 3 to 50 carbon atoms that is intermitted with one or more oxygen atoms and/or substituted with a substituent selected from the substituent group consisting of —OH, a phenoxy group and an alkylphenoxy group having 7 to 18 carbon atoms; -A (wherein A represents —CO—CR¹⁶═CH—R¹⁷); —CH₂—CH(XA)-CH₂—O—R¹²; —CR¹³R′¹³—(CH₂)ₘ—X-A; —CH₂—CH(OA)-R¹⁴; —CH₂—CH(OH)—CH₂—XA;

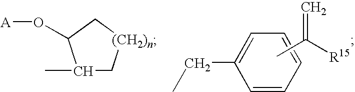

—CR¹⁵R′¹⁵—C(═CH₂)—R″¹⁵; —CR¹³R′¹³—(CH₂)ₘ—CO—X-A; —CR¹³R′¹³—(CH₂)ₘ—CO—O—CR¹⁵R′¹⁵—C(═CH₂)—R″¹⁵; or —CO—O—CR¹⁵R′¹⁵—C(═CH₂)—R″¹⁵.

R² represents an alkyl group having 6 to 18 carbon atoms; an alkenyl group having 2 to 6 carbon atoms; a phenyl group; a phenylalkyl group having 7 to 11 carbon atoms; —COOR⁴; —CN; —NH—CO—R⁵; a halogen atom; a trifluoromethyl group; or —O—R³ (R³ has the same meaning as the above R¹).

R⁴ represents an alkyl group having 1 to 18 carbon atoms; an alkenyl group having 3 to 18 carbon atoms; a phenyl group; a phenylalkyl group having 7 to 11 carbon atoms; a cycloalkyl group having 5 to 12 carbon atoms; or an alkyl group having 3 to 50 carbon atoms that may be substituted with a substituent selected from the substituent group consisting of —OH that is intermitted with one or more of —O—, —NH—, —NR⁷— and —S—, a phenoxy group and an alkylphenoxy group having 7 to 18 carbon atoms.

R⁵ represents a hydrogen atom; an alkyl group having 1 to 18 carbon atoms; an alkenyl group having 2 to 18 carbon atoms; a cycloalkyl group having 5 to 12 carbon atoms; a phenyl group; a phenylalkyl group having 7 to 11 carbon atoms; a bicycloalkyl group having 6 to 15 carbon atoms; a bicycloalkenyl group having 6 to 15 carbon atoms; or a tricycloalkyl group having 6 to 15 carbon atoms.

R⁶ represents a hydrogen atom; an alkyl group having 1 to 18 carbon atoms; an alkenyl group having 3 to 18 carbon atoms; a phenyl group; a phenylalkyl group having 7 to 11 carbon atoms; or a cycloalkyl group having 5 to 12 carbon atoms.

R⁷ and R⁸ each independently represents an alkyl group having 1 to 12 carbon atoms; an alkoxyalkyl group having 3 to 12 carbon atoms; a dialkylaminoalkyl group having 4 to 16 carbon atoms; or a cycloalkyl group having 5 to 12 carbon atoms, or R⁷ and R⁸ join to represent alkylene group having 3 to 9 carbon atoms, an oxaalkylene group having 3 to 9 carbon atoms or an azaalkylene group having 3 to 9 carbon atoms.

R⁹ represents an alkyl group having 1 to 18 carbon atoms; an alkenyl group having 2 to 18 carbon atoms; a phenyl group; a cycloalkyl group having 5 to 12 carbon atoms; a phenylalkyl group having 7 to 11 carbon atoms; a bicycloalkyl group having 6 to 15 carbon atoms; a bicycloalkylalkyl group having 6 to 15 carbon atoms; a bicycloalkenyl group having 6 to 15 carbon atoms; or a tricycloalkyl group having 6 to 15 carbon atoms.

R¹⁰ represents an alkyl group having 1 to 12 carbon atoms; a phenyl group; a naphthyl group; or an alkylphenyl group having 7 to 14 carbon atoms.

R¹² represents an alkyl group having 1 to 18 carbon atoms; an alkenyl group having 3 to 18 carbon atoms; a phenyl group; a phenyl group being substituted with one, two or three substituents selected from the substituent group consisting of an alkyl group having 1 to 8 carbon atoms, an alkoxy group having 1 to 8 carbon atoms, an alkenoxy group having 3 to 8 carbon atoms, a halogen atom and trifluoromethyl group; a phenylalkyl group having 7 to 11 carbon atoms; a cycloalkyl group having 5 to 12 carbon atoms; a tricycloalkyl group having 6 to 15 carbon atoms; a bicycloalkyl group having 6 to 15 carbon atoms; a bicycloalkylalkyl group having 6 to 15 carbon atoms; a bicycloalkenylalkyl group having 6 to 15 carbon atoms; —CO—R⁵; an alkyl group having 3 to 50 carbon atoms that is intermitted with any one or more of —O—, —NH—, —NR⁷— and —S— and may be substituted with —OH, a phenoxy group or an alkylphenoxy group having 7 to 18 carbon atoms.

R¹³ and R′¹³ each independently represents a hydrogen atom; an alkyl group having 1 to 18 carbon atoms; or a phenyl group.

R¹⁴ represents an alkyl group having 1 to 18 carbon atoms; an alkoxyalkyl group having 3 to 12 carbon atoms; a phenyl group; or an alkyl group having 1 to 4 carbon atoms that is substituted with a phenyl group.

R¹⁵, R′¹⁵ and R″¹⁵ each independently represents a hydrogen atom or —CH₃.

R¹⁶ represents a hydrogen atom; —CH₂—COO—R⁴; an alkyl group having 1 to 4 carbon atoms; or —CN.

R¹⁷ represents a hydrogen atom; —COOR⁴; an alkyl group having 1 to 17 carbon atoms; or a phenyl group.

X represents —NH—; —NR⁷—; —O—; —NH—(CH₂)ₚ—NH—; or —O—(CH₂)_{q}—NH—.

m represents 0 or an integer of 1 to 19; n represents an integer of 1 to 8; p represents 0 or an integer of 1 to 4; q represents 2, 3 or 4. But, in the formula (VII-A), at least one of R¹, R² and R¹¹ contains 2 or more carbon atoms.

The compound that is represented by the formula (VII-A) is described further.

Each of groups R¹¹, R² to R¹⁰, R¹² to R¹⁴, R¹⁶ and R¹⁷ as an alkyl group is preferably an unbranched or branched alkyl group, including, for example, a methyl group, ethyl group, propyl group, isopropyl group, n-butyl-group, secondary butyl group, isobutyl group, tertiary butyl group, 2-ethylbutyl group, n-pentyl group, isopentyl group, 1-methylpentyl group, 1,3-dimethylbutyl group, n-hexyl group, 1-methylhexyl group, n-heptyl group, isoheptyl group, 1,1,3,3-tetramethylbutyl group, 1-methylheptyl group, 3-methylheptyl group, n-octyl group, 2-ethylhexyl group, 1,1,3-trimethylhexyl group, 1,1,3,3-tetramethylpentyl group, nonyl group, decyl group, undecyl group, 1-methylundecyl group, dodecyl group, 1,1,3,3,5,5-hexamethylhexyl group, tridecyl group, tetradecyl group, pentadecyl group, hexadecyl group, heptadecyl group or octadecyl group.

Each of R¹¹, R³ to R⁹ and R¹² as a cycloalkyl group having 5 to 12 carbon atoms is, for example, a cyclopentyl group, cyclohexyl group, cycloheptyl group, cyclooctyl group, cyclononyl group, cyclodecyl group, cycloundecyl group, or cyclododecyl group. Preferred are a cyclopentyl group, cyclohexyl group, cyclooctyl group and cyclododecyl group.

As more preferred examples, each of R⁶, R⁹, R¹¹ and R¹² as an alkenyl group include an allyl group, isopropenyl group, 2-butenyl group, 3-butenyl group, isobutenyl group, n-penta-2,4-diethyl group, 3-methyl-bute-2-enyl group, n-octe-2-enyl group, n-dodece-2-enyl group, isododecenyl group, n-dodece-2-enyl group and n-octadece-4-enyl group.

A substituted alkyl group, cycloalkyl group or phenyl group has the number of the substituent of preferably one or more, can have a substituent on a bonded carbon atom (on an α-site) or on another carbon atom, has a substituent preferably on a site other than the α-site when the substituent is bonded with a hetero atom (e.g., an alkoxy group), and the substituted alkyl group has preferably at least two carbon atoms, more preferably at least three or more. Two or more substituents are bonded preferably to different carbon atoms.

An alkyl group that is intermitted with one or more of —O—, —NH—, —NR⁷— and —S— may be intermitted with two or more thereof. In case where it is intermitted with two or more of these groups, there is exemplified such an instance that hetero atom-hetero atom bonds, for example, O—O, S—S and NH—NH do not occur.

In case where an intermitted alkyl group has a substituent, there is exemplified such an embodiment that the substituent does not exist on the α-site relative to the hetero atom. In case where two or more intermitting groups having the type of —O—, —NH—, —NR⁷—, —S— occur in one group, an embodiment in which the groups are the same is exemplified.

The aryl group is preferably an aromatic hydrocarbon group, including, for example, a phenyl group, biphenylyl group and naphthyl group, more preferably a phenyl group and biphenylyl group. The aralkyl group is preferably an alkyl group being substituted with an aryl group, in particular phenyl group. The aralkyl group having 7 to 20 carbon atoms includes, for example, a benzyl group, α-methylbenzyl group, phenylethyl group, phenylpropyl group, phenylbutyl group, phenylpentyl group and phenylhexyl group. The phenylalkyl group having 7 to 11 carbon atoms includes preferably a benzyl group, α-methylbenzyl group and α,α-dimethylbenzyl group.

An alkylphenyl group and an alkylphenoxy group are a phenyl group and a phenoxy group being substituted with an alkyl group, respectively.

The halogen atom to be a halogen substituent is a fluorine atom, chlorine atom, bromine atom, or iodine atom, more preferably a fluorine atom and chlorine atom, especially preferably a chlorine atom.

The alkylene group having 1 to 20 carbon atoms includes, for example, a methylene group, ethylene group, propylene group, butylene group, pentylene group and hexylene group. Here, the alkyl chain may be branched, and is, for example, an isopropylene group.

The cycloalkenyl group having 4 to 12 carbon atoms includes, for example, a 2-cyclobuteny-2-yl group, 2-cyclopenteny-1-yl group, 2,4-cyclopentadieny-1-yl group, 2-cyclohexeny-1-yl group, 2-cyclohepteny-1-yl group and 2-cycloocteny-1-yl group.

The bicycloalkyl group having 6 to 15 carbon atoms includes, for example, a bornyl group, norbornyl group and [2.2.2]bicyclooctyl group. A bornyl group and norbornyl group, especially a bornyl group and norborny-2-yl group are preferred.

The bicycloalkoxy group having 6 to 15 carbon atoms includes, for example, a bornyloxy group and norborny-2-yloxy group.

The bicycloalkylalkyl or -alkoxy group having 6 to 15 carbon atoms is an alkyl group or an alkoxy group having the total carbon atoms of 6 to 15 being substituted with a bicycloalkyl group, wherein preferred are a norbornane-2-methyl group and norbornyl-2-methoxy group.

The bicycloalkenyl group having 6 to 15 carbon atoms includes, for example, a norbornenyl group and norbornadienyl group. Preferred is a norbornenyl group, especially norborne-5-ene group.

The bicycloalkenylalkoxy group having 6 to 15 carbon atoms is an alkoxy group having the total carbon atoms of 6 to 15 being substituted with a bicycloalkenyl group, wherein preferred is a norborne-5-ene-2-methoxy group.

The tricycloalkyl group having 6 to 15 carbon atoms includes, for example, a 1-adamantyl group and 2-adamantyl group. Preferred is a 1-adamantyl group.

The tricycloalkoxy group having 6 to 15 carbon atoms includes, for example, an adamantyloxy group. The heteroaryl group having 3 to 12 carbon atoms is preferably a pyridinyl group, pyrimidinyl group, triazynyl group, pyrrolyl group, furanyl group, thiophenyl group and quinolinyl group.

The compound that is represented by the formula (VII-A) is further preferred in the following instance.

R¹¹ represents one of groups that are defined by an alkyl group having 1 to 18 carbon atoms; a cycloalkyl group having 5 to 12 carbon atoms; an alkenyl group having 3 to 12 carbon atoms; a phenyl group; an alkyl group having 1 to 18 carbon atoms substituted with a phenoxy group, an alkoxy group having 1 to 4 carbon atoms being substituted with a phenyl group, bornyloxy group, norborny-2-yloxy group, norbornyl-2-methoxy group, norborne-5-ene-2-methoxy group, or an adamantyloxy group, that have been substituted with a substituent selected from the substituent group consisting of a phenyl group, —OH, alkoxy group having 1 to 18 carbon atoms, cycloalkoxy group having 5 to 12 carbon atoms, alkenyloxy group having 3 to 18 carbon atoms, halogen atom, —COOH, —COOR⁴, —O—CO—R⁵, —O—CO—O—R⁶, —CO—NH₂, —CO—NHR⁷, —CO—N(R⁷)(R⁸), —CN, —NH₂, —NHR⁷, —N(R⁷)(R⁸), —NH—CO—R⁵, a phenoxy group and an alkyl group having 1 to 18 carbon atoms; a cycloalkyl group having 5 to 12 carbon atoms being substituted with a substituent selected from the substituent group consisting of —OH, an alkyl group having 1 to 4 carbon atoms, alkenyl group having 2 to 6 carbon atoms and —O—CO—R⁵; a glycidyl group; —CO—R⁹ or —SO₂—R¹⁰; an alkyl group having 3 to 50 carbon atoms that is intermitted with one or more oxygen atoms and/or substituted with a substituent selected from the substituent group consisting of —OH, a phenoxy group and alkylphenoxy group having 7 to 18 carbon atoms; -A; —CH₂—CH(XA)-CH₂—O—R¹²; —CR¹³R′¹³—(CH₂)ₘ—X-A; —CH₂—CH(OA)-R¹⁴, —CH₂—CH(OH)—CH₂—XA;

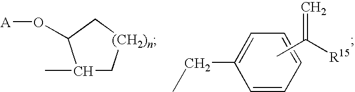

—CR¹⁵R′¹⁵—C(═CH₂)—R″¹⁵; —CR¹³R′¹³—(CH₂)ₘ—CO—X-A; —CR¹³R′¹³—(CH₂)ₘ—CO—CR¹⁵R′¹⁵—C(═CH₂)—R″¹⁵ or —CO—O—CR¹⁵R′¹⁵—C(═CH₂)—R″¹⁵ (wherein A represents —CO—CR¹⁶═CH—R¹⁷).

R² represents an alkyl group having 6 to 18 carbon atoms; an alkenyl group having 2 to 6 carbon atoms; a phenyl group; —O—R³ or —NH—CO—R⁵.

R³ has the same definition as R¹.

R⁴ represents an alkyl group having 1 to 18 carbon atoms; an alkenyl group having 3 to 18 carbon atoms; a phenyl group; a phenylalkyl group having 7 to 11 carbon atoms; a cycloalkyl group having 5 to 12 carbon atoms; or an alkyl group having 3 to 50 carbon atoms that may be intermitted with one or more of —O—, —NH—, —NR⁷— and —S—, and substituted with a substituent selected from the substituent group consisting of —OH, a phenoxy group and alkylphenoxy group having 7 to 18 carbon atoms.

R⁵ represents a hydrogen atom; an alkyl group having 1 to 18 carbon atoms; an alkenyl group having 2 to 18 carbon atoms; a cycloalkyl group having 5 to 12 carbon atoms; a phenyl group; a phenylalkyl group having 7 to 11 carbon atoms; a norborny-2-yl group; a norborne-5-eny-2-yl group; or an adamantyl group.

R⁶ represents a hydrogen atom; an alkyl group having 1 to 18 carbon atoms; an alkenyl group having 3 to 18 carbon atoms; a phenyl group; a phenylalkyl group having 7 to 11 carbon atoms; or a cycloalkyl group having 5 to 12 carbon atoms.

R⁷ and R⁸ each independently represents an alkyl group having 1 to 12 carbon atoms; an alkoxyalkyl group having 3 to 12 carbon atoms; a dialkylaminoalkyl group having 4 to 16 carbon atoms; a cycloalkyl group having 5 to 12 carbon atoms; or an alkylene group having 3 to 9 carbon atoms, an oxaalkylene group having 3 to 9 carbon atoms, an azaalkylene group having 3 to 9 carbon atoms that are formed by bonding R⁷ with R⁸.

R⁹ represents an alkyl group having 1 to 18 carbon atoms; an alkenyl group having 2 to 18 carbon atoms; a phenyl group; a cycloalkyl group having 5 to 12 carbon atoms; a phenylalkyl group having 7 to 11 carbon atoms; a norborny-2-yl group; a norborne-5-eny-2-yl group; or an adamantyl group.

R¹⁰ represents an alkyl group having 1 to 12 carbon atoms; a phenyl group; a naphthyl group; or an alkylphenyl group having 7 to 14 carbon atoms.

R¹¹ represents a hydrogen atom; an alkyl group having 1 to 18 carbon atoms; or a phenylalkyl group having 7 to 11 carbon atoms.

R¹² represents an alkyl group having 1 to 18 carbon atoms; an alkenyl group having 3 to 18 carbon atoms; a phenyl group; a phenyl group that is substituted with one, two or three substituents selected from the substituent group consisting of an alkyl group having 1 to 8 carbon atoms, alkoxy group having 1 to 8 carbon atoms, alkenoxy group having 3 to 8 carbon atoms, halogen atom and trifluoromethyl group; a phenylalkyl group having 7 to 11 carbon atoms; a cycloalkyl group having 5 to 12 carbon atoms; a 1-adamantyl group; a 2-adamantyl group; a norbornyl group; a norbornane-2-methyl-; —CO—R⁵; an alkyl group having 3 to 50 carbon atoms that may be intermitted with one or more of —O—, —NH—, —NR⁷— and —S—, and substituted with a substituent selected from the substituent group consisting of —OH, a phenoxy group and alkylphenoxy group having 7 to 18 carbon atoms.

R¹³ and R′¹³ each independently represents a hydrogen atom; an alkyl group having 1 to 18 carbon atoms; or a phenyl group.

R¹⁴ represents an alkyl group having 1 to 18 carbon atoms; an alkoxyalkyl having 3 to 12 carbon atoms; a phenyl group; or a phenylalkyl wherein the alkyl moiety has 1 to 4 carbon atoms.

R¹⁵, R′¹⁵ and R″¹⁵ each independently represents a hydrogen atom or a methyl group.

R¹⁶ represents a hydrogen atom, —CH₂—COO—R⁴, an alkyl group having 1 to 4 carbon atoms; or a cyano group.

R¹⁷ represents a hydrogen atom; —COOR⁴; an alkyl group having 1 to 17 carbon atoms; or a phenyl group.

X is —NH—; —NR⁷—; —O—; —NH—(CH₂)ₚ—NH—; or —O—(CH₂)_{q}—NH—;

m is an integer of 0 to 19.

n is an integer of 1 to 8.

p is an integer of 0 to 4.

q is an integer of 2 to 4.

The compounds that are represented by formulae (VII) or (VII-A) can be produced by a publicly known method. For example, they can be obtained similar to publicly known compounds, according to such methods that are represented by EP Patent No. 434608 or H. Brunetti and C. E. Luthi, Helv. Chim. Acta 55, 1566 (1972), by Friedel-Kraft addition of halotriazine to the corresponding phenol.

Next, preferred examples of the compounds that are represented by formulae (VII) or (VII-A) are shown below, but compounds that can be used in the invention are not limited to these specific examples.

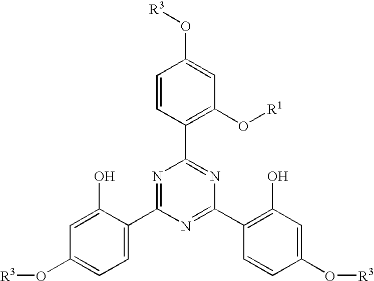

| Compound No. | R³ | R¹ |
|---|---|---|
| UV-1 | —CH₂CH(OH)CH₂OC₄H₉-n | —CH₃ |
| UV-2 | —CH₂CH(OH)CH₂OC₄H₉-n | —C₂H₅ |
| UV-3 | R³ = R¹ = —CH₂CH(OH)CH₂OC₄H₉-n | |
| UV-4 | —CH(CH₃)—CO—O—C₂H₅ | —C₂H₅ |
| UV-5 | R³ = R¹ = —CH(CH₃)—CO—O—C₂H₅ | |
| UV-6 | —C₂H₅ | —C₂H₅ |
| UV-7 | —CH₂CH(OH)CH₂OC₄H₉-n | —CH(CH₃)₂ |
| UV-8 | —CH₂CH(OH)CH₂OC₄H₉-n | —CH(CH₃)—C₂H₅ |
| UV-9 | R³ = R¹ = —CH₂CH(C₂H₅)—C₄H₉-n | |
| UV-10 | —C₈H₁₇-n | —C₈H₁₇-n |
| UV-11 | —C₃H₇-n | —CH₃ |
| UV-12 | —C₃H₇-n | —C₂H₅ |
| UV-13 | —C₃H₇-n | —C₃H₇-n |
| UV-14 | —C₃H₇-iso | —CH₃ |
| UV-15 | —C₃H₇-iso | —C₂H₅ |
| UV-16 | —C₃H₇-iso | —C₃H₇-iso |
| UV-17 | —C₄H₉-n | —CH₃ |
| UV-18 | —C₄H₉-n | —C₂H₅ |
| UV-19 | —C₄H₉-n | —C₄H₉-n |
| UV-20 | —CH₂CH(CH₃)₂ | —CH₃ |
| UV-21 | —CH₂CH(CH₃)₂ | —C₂H₅ |
| UV-22 | —CH₂CH(CH₃)₂ | —CH₂CH(CH₃)₂ |
| UV-23 | n-hexyl | —CH₃ |
| UV-24 | n-hexyl | —C₂H₅ |
| UV-25 | n-hexyl | n-hexyl |
| UV-26 | —C₇H₁₅-n | —CH₃ |
| UV-27 | —C₇H₁₅-n | —C₂H₅ |
| UV-28 | —C₇H₁₅-n | —C₇H₁₅-n |
| UV-29 | —C₈H₁₇-n | —CH₃ |
| UV-30 | —C₈H₁₇-n | —C₂H₅ |
| UV-31 | —CH₂CHCH(CH₃)₂ | —CH₂CHCH(CH₃)₂ |
| UV-32 | —C₅H₁₁-n | —C₅H₁₁-n |
| UV-33 | —C₁₂H₂₅-n | —C₁₂H₂₅-n |
| UV-34 | —C₁₆H₃₃-n | —C₂H₅ |
| UV-35 | —CH₂—CO—O—C₂H₅ | —CH₂—CO—O—C₂H₅ |

In addition, photostabilizers that are shown in the catalog of “Adecastab,” the outline of additives for plastic by Asahi Denka, can be also used. Photostabilizers and UV-absorbers that are described in a guide for TINUVIN products, by Chiba Specialty Chemicals, can be also used. SEESORB, SEENOX and SEETEC that are shown in the catalog of SHIPROKASEI KAISYA can be also used. UV absorbers and oxidation inhibitors from Johoku Chemical can be also used. VIOSORB from Kyodo Yakuhin, and UV-absorbers from Yoshitomi Pharmaceutical Co., Ltd. can be also used.

Further, for the wavelength dispersion-controlling agent of the invention, disk-shaped compounds as described in JP-A-2001-166144 and JP-A-2003-3446556 can be also used preferably.

The compound as shown by the following formula (VIII) can be also used preferably as the wavelength dispersion-controlling agent of the invention. Hereinafter, the compound as shown by the formula (VIII) is described in detail.

Ar¹-L¹Ar²-L²ₙAr³ Formula (VIII)

In the formula (VIII), Ar¹, Ar² and Ar³ each independently represents an aryl group or an aromatic heterocycle, L¹ and L² each independently represents a single bond or a divalent linking group. n represents an integer of 3 or more, and Ar² and L² may be the same with or different from each other.

Ar¹, Ar² and Ar³ each independently represents an aryl group or an aromatic heterocycle. The preferred aryl group that is represented by Ar¹, Ar² or Ar³ is an aryl group having 6 to 30 carbon atoms, which may be a monocycle or form a condensed ring with other ring. When available, it may have a substituent. As the substituent, an after-mentioned substituent T can be applied.

In the formula (VIII), the aryl group represented by Ar¹, Ar² or Ar³ is an aryl group having more preferably 6 to 20 carbon atoms, especially preferably 6 to 12. The example of the aryl group includes a phenyl group, a p-methylphenyl group, and a naphthyl group.

In the formula (VIII), the aromatic heterocycle that is represented by Ar¹, Ar² or Ar³ may be any heterocycle when it is an aromatic heterocycle containing at least one of an oxygen atom, a nitrogen atom and a sulfur atom. Of these, a preferred aromatic heterocycle is a 5- or 6-membered one containing at least one of an oxygen atom, a nitrogen atom and a sulfur atom. When available, it may have further a substituent. As the substituent, an after-mentioned substituent T can be applied.

In the formula (VIII), specific examples of the aromatic heterocycle that is represented by Ar¹, Ar² or Ar³ include a furan ring, a pyrrole ring, a thiophene ring, an imidazole ring, a pyrazole ring, a pyridine ring, a pyrazine ring, a pyridazine ring, a triazole ring, a triazine ring, an indole ring, an indazole ring, a purine ring, a thiazoline ring, a thiazole ring, a thiadiazole ring, an oxazoline ring, an oxazole ring, an oxadiazole ring, a quinoline ring, an iso-quinoline ring, a phthalazine ring, a naphthyridine ring, a quinoxaline ring, a quinazoline ring, a cinnoline ring, a pteridine ring, an acridine ring, a phenanthroline ring, a phenazine ring, a tetrazole ring, a benzimidazole ring, a benzoxazole ring, a benzothiazole ring, a benzotriazole ring, a tetrazaindene ring, a pyrrolotriazole ring, a pyrazolotriazole ring. Preferred aromatic heterocycles are a benzimidazole ring, a benzoxazole ring, a benzothiazole ring and a benzotriazole ring.

In the formula (VIII), L¹ and L² represent a single bond or a divalent linking group. The example of the divalent linking group includes preferably a group that is represented by —NR⁷— (R⁷ represents a hydrogen atom, an alkyl group or an aryl group that may have a substituent), —SO₂—, —CO—, an alkylene group, a substituted alkylene group, an alkenylene group, a substituted alkenylene group, an alkynylene group, —O—, —S—, —SO— and groups that are obtained by combining two or more of these divalent groups. Of these, more preferred are —O—, —CO—, —SO₂NR⁷—, —NR⁷SO₂—, —CONR⁷—, —NR⁷CO—, —COO—, —OCO— and an alkynylene group, and most preferred are —CONR⁷—, —NR⁷CO—, —COO and —OCO— and an alkynylene group.

In the compound that is represented by the formula (VIII), Ar² is bonded to L¹ and L², wherein, when Ar² is a phenylene group, L¹-Ar²-L² and L²-Ar²-L² are most preferably in para-site relationship (1-, 4-site) with each other.

n represents an integer of 3 or more, and is preferably 3 to 7, more preferably 3 to 5.

Preferred compounds among those that are represented by the formula (VIII) are compounds that are represented by the formula (IX). The detailed description is given about the formula (IX).

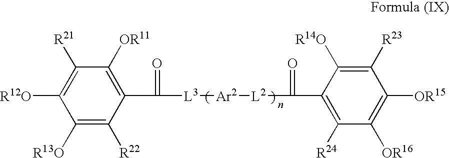

R¹¹, R¹², R¹³, R¹⁴, R¹⁵, R¹⁶, R²¹, R²², R²³ and R²⁴ each independently represents a hydrogen atom or a substituent. Ar² represents an aryl group or an aromatic heterocycle, L² and L³ each independently represents a single bond or a divalent linking group. n represents an integer of 3 or more. The Ar² and L² may be the same with or different from each other.

Examples of the Ar², L² and n are the same as those for the formula (VIII). L³ represents a single bond or a divalent linking group, wherein the preferred examples of the divalent linking group include a group that is represented by —NR⁷—(R⁷ represents a hydrogen atom, an alkyl group or an aryl group that may have a substituent), an alkylene group, a substituted alkylene group, —O— and groups that are obtained by combining two or more of these divalent groups. Of these, more preferred are —O—, —NR⁷—, —NR⁷SO₂— and —NR⁷CO—.

R¹¹, R¹², R¹³, R¹⁴, R¹⁵ and R¹⁶ each independently represents a hydrogen atom or a substituent, wherein these are preferably a hydrogen atom, an alkyl group or an aryl group, more preferably a hydrogen atom, an alkyl group having 1 to 4 carbon atoms (e.g., a methyl group, an ethyl group, a propyl group, an isopropyl group) or an aryl group having 6 to 12 carbon atoms (e.g., a phenyl group, a naphthyl group), furthermore preferably an alkyl group having 1 to 4 carbon atoms.

R²¹, R²², R²³ and R²⁴ each independently represents a hydrogen atom or a substituent, wherein these are preferably a hydrogen atom, an alkyl group, an alkoxy group or a hydroxyl group, more preferably a hydrogen atom or an alkyl group (preferably having 1 to 4 carbon atoms, more preferably a methyl group).

Hereinafter, the above-described substituent T is described.

Preferred examples of the substituent T are a halogen atom (e.g., a fluorine atom, a chlorine atom, a bromine atom, an iodine atom), an alkyl group (preferably an alkyl group having 1 to 30 carbon atoms, such as a methyl group, an ethyl group, a n-propyl group, an isopropyl group, a tert-butyl group, a n-octyl group, a 2-ethylhexyl group), a cycloalkyl group (preferably a substituted or unsubstituted cycloalkyl group having 3 to 30 carbon atoms, such as a cyclohexyl group, a cyclopentyl group, a 4-n-dodecylcyclohexyl group), a bicycloalkyl group (preferably a substituted or unsubstituted bicycloalkyl group having 5 to 30 carbon atoms, that is, a monovalent group that is formed by removing one hydrogen atom from bicycloalkane having 5 to 30 carbon atoms. For example, a bicyclo[1.2.2]heptane-2-yl group, a bicyclo[2.2.2]octane-3-yl group), an alkenyl group (preferably a substituted or unsubstituted alkenyl group having 2 to 30 carbon atoms, such as a vinyl group, an aryl group), a cycloalkenyl group (preferably a substituted or unsubstituted cycloalkenyl group having 3 to 30 carbon atoms, that is, a monovalent group that is formed by removing one hydrogen atom from cycloalkane having 3 to 30 carbon atoms, such as a 2-cyclopentane-1-yl group, a 2-cyclohexane-1-yl group), a bicycloalkenyl group (a substituted or unsubstituted bicycloalkenyl group, preferably a substituted or unsubstituted bicycloalkenyl group having 5 to 30 carbon atoms, that is, a monovalent group that is formed by removing one hydrogen atom from bicycloalkene having one double bond, such as a bicyclo[2.2.1]hepto-2-ene-1-yl group, a bicyclo[2.2.2]octo-2-ene-4-yl group), an alkynyl group (preferably a substituted or unsubstituted alkynyl group having 2 to 30 carbon atoms, such as an ethynyl group, a propargyl group), an aryl group (preferably a substituted or unsubstituted aryl group having 6 to 30 carbon atoms, such as a phenyl group, a P-tolyl group, a naphthyl group), a heterocyclic group (preferably a monovalent group that is formed by removing one hydrogen atom from a 5- or 6-membered substituted or unsubstituted aromatic or nonaromatic heterocyclic compounds, more preferably a 5- or 6-membered aromatic heterocyclic group having 3 to 30 carbon atoms. Examples thereof are a 2-furyl group, a 2-thienyl group, a 2-pyrimidinyl group, a 2-benzothiazolyl group), a cyano group, a hydroxyl group, a nitro group, a carboxyl group, an alkoxy group (preferably a substituted or unsubstituted alkoxy group having 1 to 30 carbon atoms, such as a methoxy group, an ethoxy group, an isopropoxy group, a tert-butoxy group, a n-octyloxy group, a 2-methoxyethoxy group), an aryloxy group (preferably a substituted or unsubstituted aryloxy group having 6 to 30 carbon atoms, such as a phenoxy group, a 2-methylphenoxy group, a 4-tert-butylphenoxy group, a 3-nitrophenoxy group, a 2-tetradecanoylaminophenoxy group), a silyloxy group (preferably a silyloxy group having 3 to 20 carbon atoms, such as a trimethylsilyloxy group, a tert-butyldimethylsilyloxy group), a heterocycloxy group (preferably a substituted or unsubstituted heterocycloxy group having 2 to 30 carbon atoms, a 1-phenyltetrazole-5-oxy group, a 2-tetrahydropyranyloxy group), an acyloxy group (preferably a formyloxy group, a substituted or unsubstituted alkylcarbonyloxy group having 2 to 30 carbon atoms, a substituted or unsubstituted arylcarbonyloxy group having 6 to 30 carbon atoms, such as a formyloxy group, an acetyloxy group, a pivaloyloxy group, a stearoyloxy group, a benzoyloxy group, a p-methoxyphenylcarbonyloxy group), a carbamoyloxy group (preferably a substituted or unsubstituted carbamoyloxy group having 1 to 30 carbon atoms, such as an N,N-dimethylcarbamoyloxy group, an N,N-diethylcarbamoyloxy group, a morpholinocarbonyloxy group, an N,N-di-n-octylaminocarbonyloxy group, an N-n-octylcarbamoyloxy group), an alkoxycarbonyloxy group (preferably a substitute or unsubstituted alkoxycarbonyloxy group having 2 to 30 carbon atoms, such as a methoxycarbonyloxy group, an ethoxycarbonyloxy group, a tert-butoxycarbonyloxy group, a n-octylcarbonyloxy group), an aryloxycarbonyloxy group (preferably a substituted or unsubstituted aryloxycarbonyloxy group having 7 to 30 carbon atoms, such as a phenoxycarbonyloxy group, a p-methoxyphenoxycarbonyloxy group, a p-n-hexadecyloxyphenoxycarbonyloxy group), an amino group (preferably an amino group, a substituted or unsubstituted alkylamino group having 1 to 30 carbon atoms, a substituted or unsubstituted anilino group having 6 to 30 carbon atoms, such as an amino group, a methylamino group, a dimethylamino group, an anilino group, an N-methylanilino group, a diphenylamino group), an acylamino group (preferably a formylamino group, a substituted or unsubstituted alkylcarbonylamino group having 1 to 30 carbon atoms, a substituted or unsubstituted arylcarbonylamino group having 6 to 30 carbon atoms, such as a formylamino group, an acetylamino group, a pivaloylamino group, a lauroylamino group, a benzoylamino group), an aminocarbonylamino group (preferably a substituted or unsubstituted aminocarbonylamino group having 1 to 30 carbon atoms, such as a carbamoylamino group, an N,N-dimethylaminocarbonylamino group, an N,N-diethylaminocarbonylamino group, a morpholinocarbonylamino group), an alkoxycarbonylamino group (preferably a substitute or unsubstituted alkoxycarbonylamino group having 2 to 30 carbon atoms, such as a methoxycarbonylamino group, an ethoxycarbonylamino group, a tert-butoxycarbonylamino group, a n-octadecyloxycarbonylamino group, an N-methyl-methoxycarbonylamino group), an aryloxycarbonylamino group (preferably a substituted or unsubstituted aryloxycarbonylamino group having 7 to 30 carbon atoms, such as a phenoxycarbonylamino group, a p-chlorophenoxycarbonylamino group, a m-n-octyloxyphenoxycarbonylamino group), a sulfamoylamino group (preferably a substituted or unsubstituted sulfamoylamino group having 0 to 30 carbon atoms, such as a sulfamoylamino group, an N,N-dimethylaminosulfonylamino group, an N-n-octylaminosulfonylamino group), an alkyl or arylsulfonylamino group (preferably a substituted or unsubstituted alkylsulfonylamino group having 1 to 30 carbon atoms, a substituted or unsubstituted arylsulfonylamino group having 6 to 30 carbon atoms, such as a methylsulfonylamino group, a butylsulfonylamino group, a phenylsulfonylamino group, a 2,3,5-trichlorophenylsulfonylamino group, a P-methylphenylsulfonylamino group), a mercapto group, an alkylthio group (preferably a substituted or unsubstituted alkylthio group having 1 to 30 carbon atoms, such as a methylthio group, an ethylthio group, a n-hexadecylthio group), an arylthio group (preferably a substituted or unsubstituted arylthio group having 6 to 30 carbon atoms, such as a phenylthio group, a p-chlorophenylthio group, an m-methoxyphenylthio group), a heterocyclic thio group (preferably a substituted or unsubstituted heterocyclic thio group having 2 to 30 carbon atoms, such as a 2-benzothiazolylthio group, a 1-phenyltetrazole-5-ylthio group), a sulfamoyl group (preferably a substituted or unsubstituted sulfamoyl group having 0 to 30 carbon atom, such as an N-ethylsulfamoyl group, an N-(3-dodecyloxypropyl)sulfamoyl group, an N,N-dimethylsulfamoyl group, an N-acetylsulfamoyl group, an N-benzoylsulfamoyl group, an N—(N′-phenylcarbamoyl)sulfamoyl group), a sulfo group, an alkyl or arylsulfinyl group (preferably a substituted or unsubstituted alkylsulfinyl group having 1 to 30 carbon atoms, a substituted or unsubstituted arylsulfinyl group having 6 to 30 carbon atoms, such as a methylsulfinyl group, an ethylsulfinyl group, a phenylsulfinyl group, a p-methylphenylsulfinyl group), an alkyl or arylsulfonyl group (preferably a substituted or unsubstituted alkylsulfonyl group having 1 to 30 carbon atoms, a substituted or unsubstituted arylsulfonyl group having 6 to 30 carbon atoms, such as a methylsulfonyl group, an ethylsulfonyl group, a phenylsulfonyl group, a P-methylphenylsulfonyl group), an acyl group (preferably a formyl group, a substituted or unsubstituted alkylcarbonyl group having 2 to 30 carbon atoms, a substituted or unsubstituted arylcarbonyl group having 7 to 30 carbon atoms, such as an acetyl group, a pivaloylbenzoyl group), an aryloxycarbonyl group (preferably a substituted or unsubstituted aryloxycarbonyl group having 7 to 30 carbon atoms, such as a phenoxycarbonyl group, an o-chlorophenoxycarbonyl group, a m-nitrophenoxycarbonyl group, a p-tert-butylphenoxycarbonyl group), an alkoxycarbonyl group (preferably a substitute or unsubstituted alkoxycarbonyl group having 2 to 30 carbon atoms, such as a methoxycarbonyl group, an ethoxycarbonyl group, a tert-butoxycarbonyl group, a n-octadecyloxycarbonyl group), a carbamoyl group (preferably a substituted or unsubstituted carbamoyl group having 1 to 30 carbon atoms, such as a carbamoyl group, an N-methylcarbamoyl group, an N,N-dimethylcarbamoyl group, an N,N-di-n-octylcarbamoyl group, an N-(methylsulfonyl)carbamoyl group), an aryl or heterocyclic azo group (preferably a substituted or unsubstituted arylazo group having 6 to 30 carbon atoms, a substituted or unsubstituted heterocyclic azo group having 3 to 30 carbon atoms, such as a phenylazo group, a p-chlorophenylazo group, a 5-ethylthio-1,3,4-thiadiazole-2-ylazo group), an imide group (preferably an N-succinimide group, an N-phthalimide group), a phosphino group (preferably a substituted or unsubstituted phosphino group having 2 to 30 carbon atoms, such as a dimethylphosphino group, a diphenylphosphino group, a methylphenoxyphosphino group), a phosphinyl group (preferably a substituted or unsubstituted phosphinyl group having 2 to 30 carbon atoms, such as a phosphinyl group, a dioctyloxyphosphinyl group, a diethoxyphosphinyl group), a phosphinyloxy group (preferably a substituted or unsubstituted phosphinyloxy group having 2 to 30 carbon atoms, such as a diphenoxyphosphinyloxy group, a dioctyloxyphosphinyloxy group), a phosphinylamino group (preferably a substituted or unsubstituted phosphinylamino group having 2 to 30 carbon atoms, such as a dimethoxyphosphinylamino group, a dimethylaminophosphinylamino group), a silyl group (preferably a substituted or unsubstituted silyl group having 3 to 30 carbon atoms, such as a trimethylsilyl group, a tert-butyldimethylsilyl group, a phenyldimethylsilyl group). Among the above-described substituents, in the case of those having a hydrogen atom, it may be removed to be substituted with the above-described group. Examples of such functional groups include an alkylcarbonylaminosulfonyl group, an arylcarbonylaminosulfonyl group, an alkylsulfonylaminocarbonyl group and an arylsulfonylaminocarbonyl group. Specific examples thereof include a methylsulfonylaminocarbonyl group, a p-methylphenylsulfonylaminocarbonyl group, an acetylaminosulfonyl group and a benzoylaminosulfonyl group.

When two or more substituents are included, these may be the same with or different from each other. When available, these may be linked with each other to form a ring.

Hereinafter, the compounds that are represented by the formulae (VIII) and (IX) are described in detail while citing specific examples thereof, but the invention is not limited in any sense to the following examples.

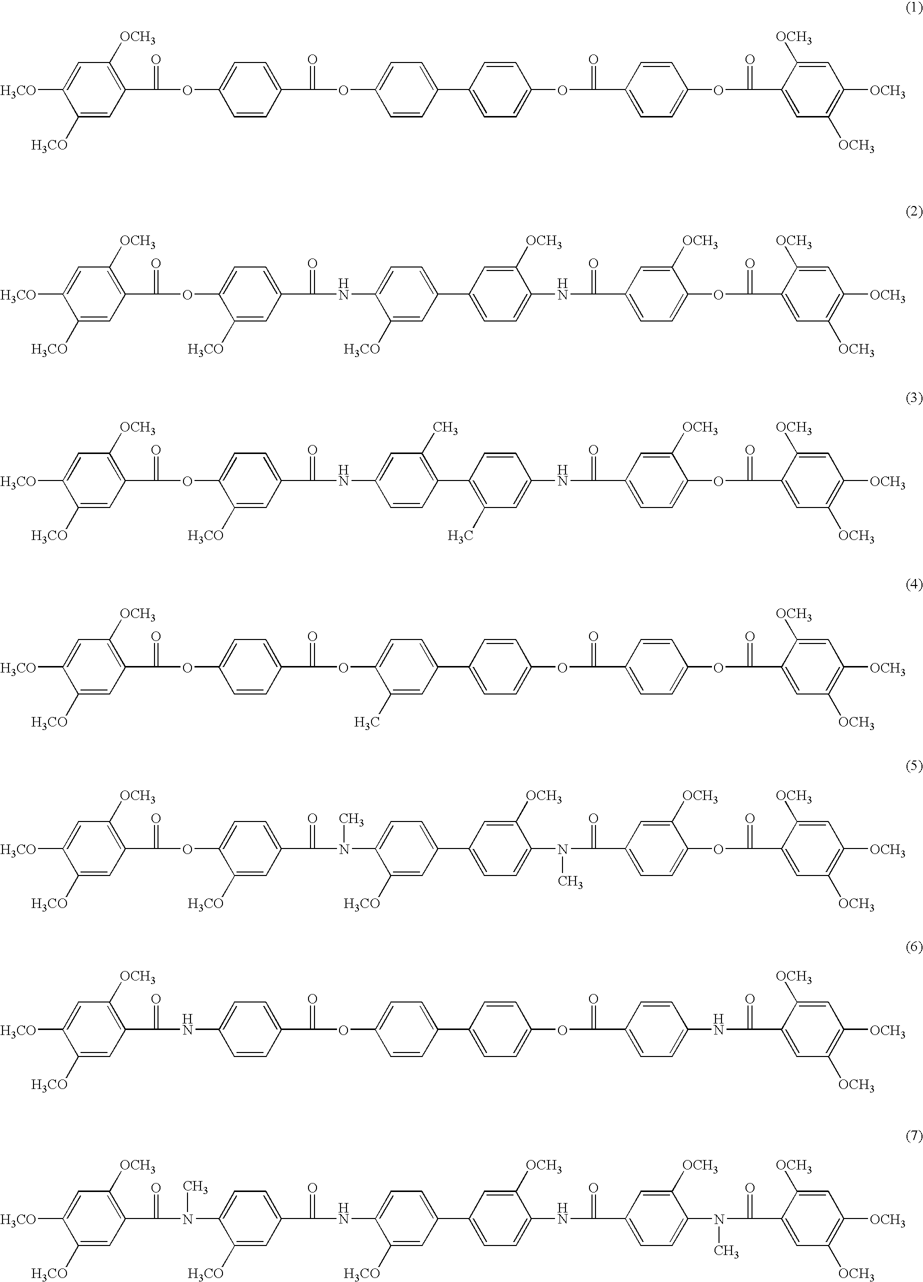

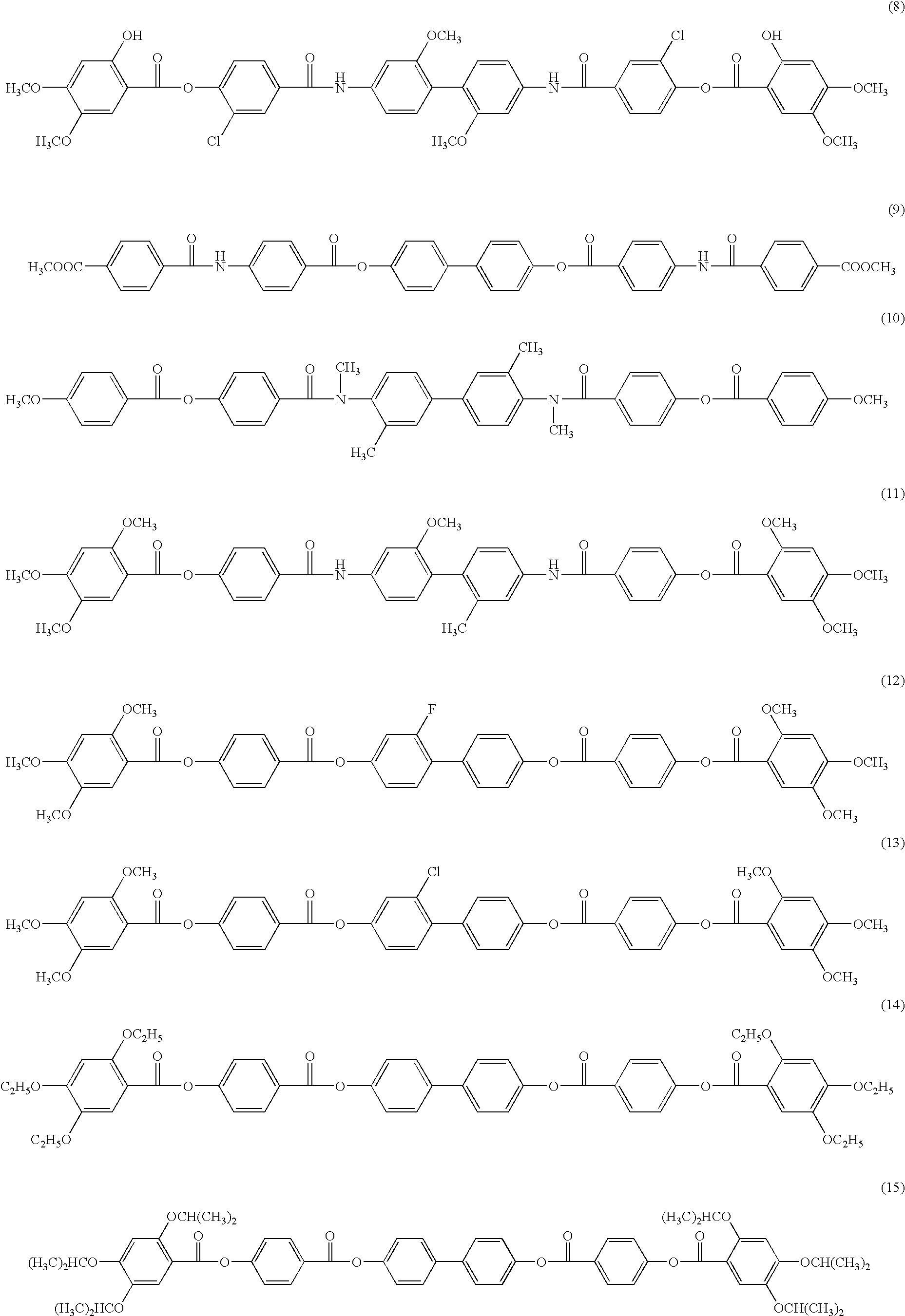

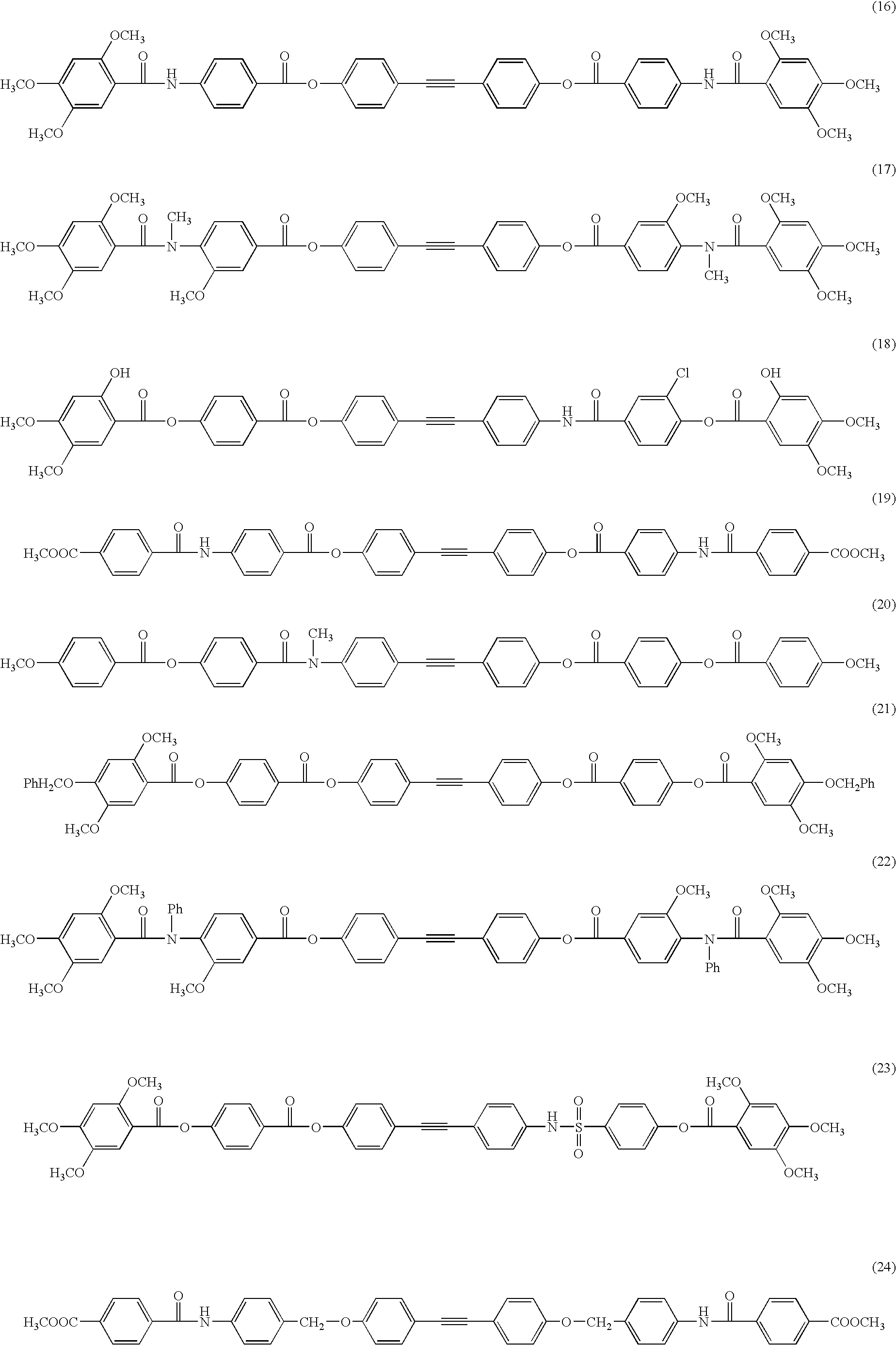

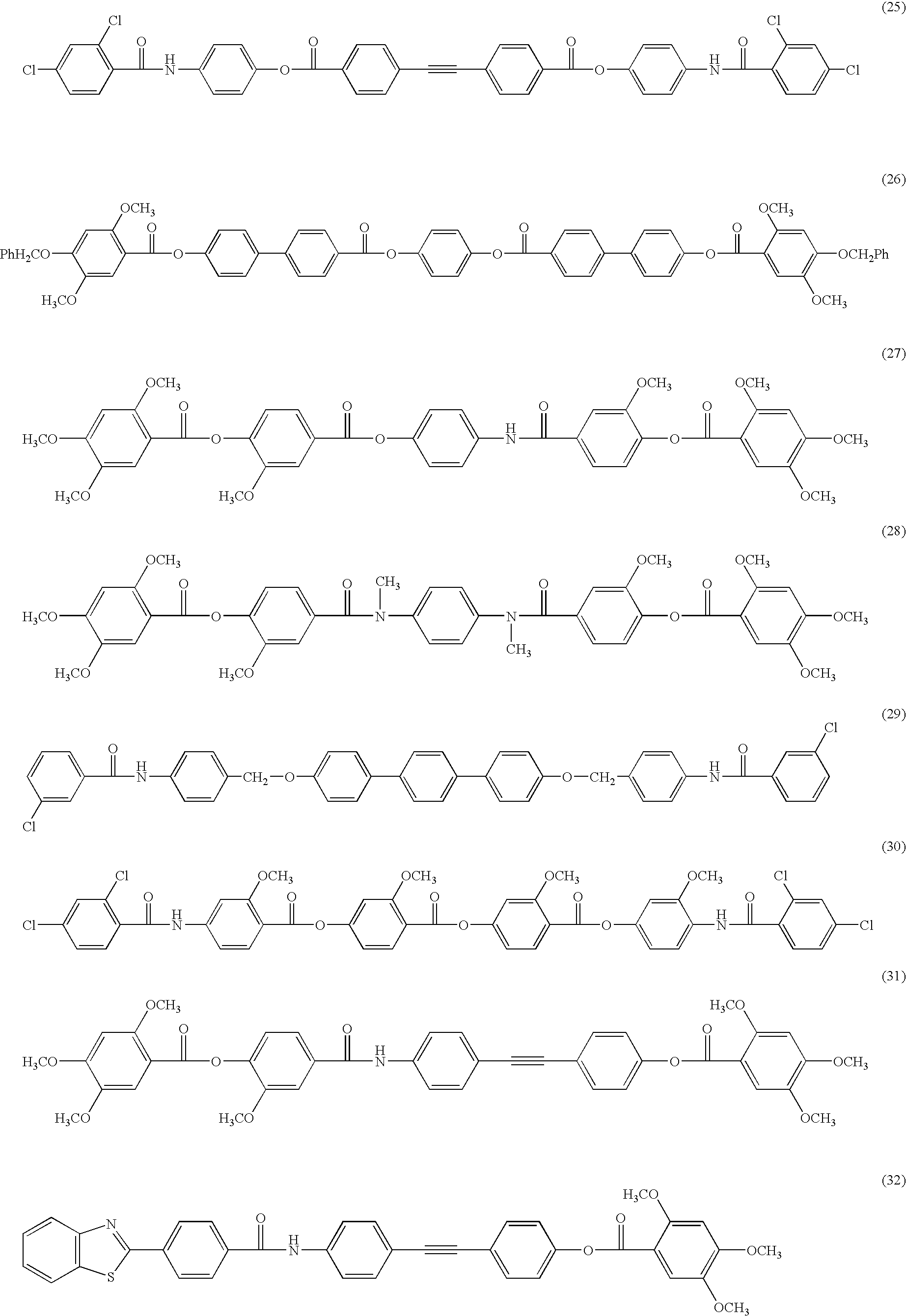

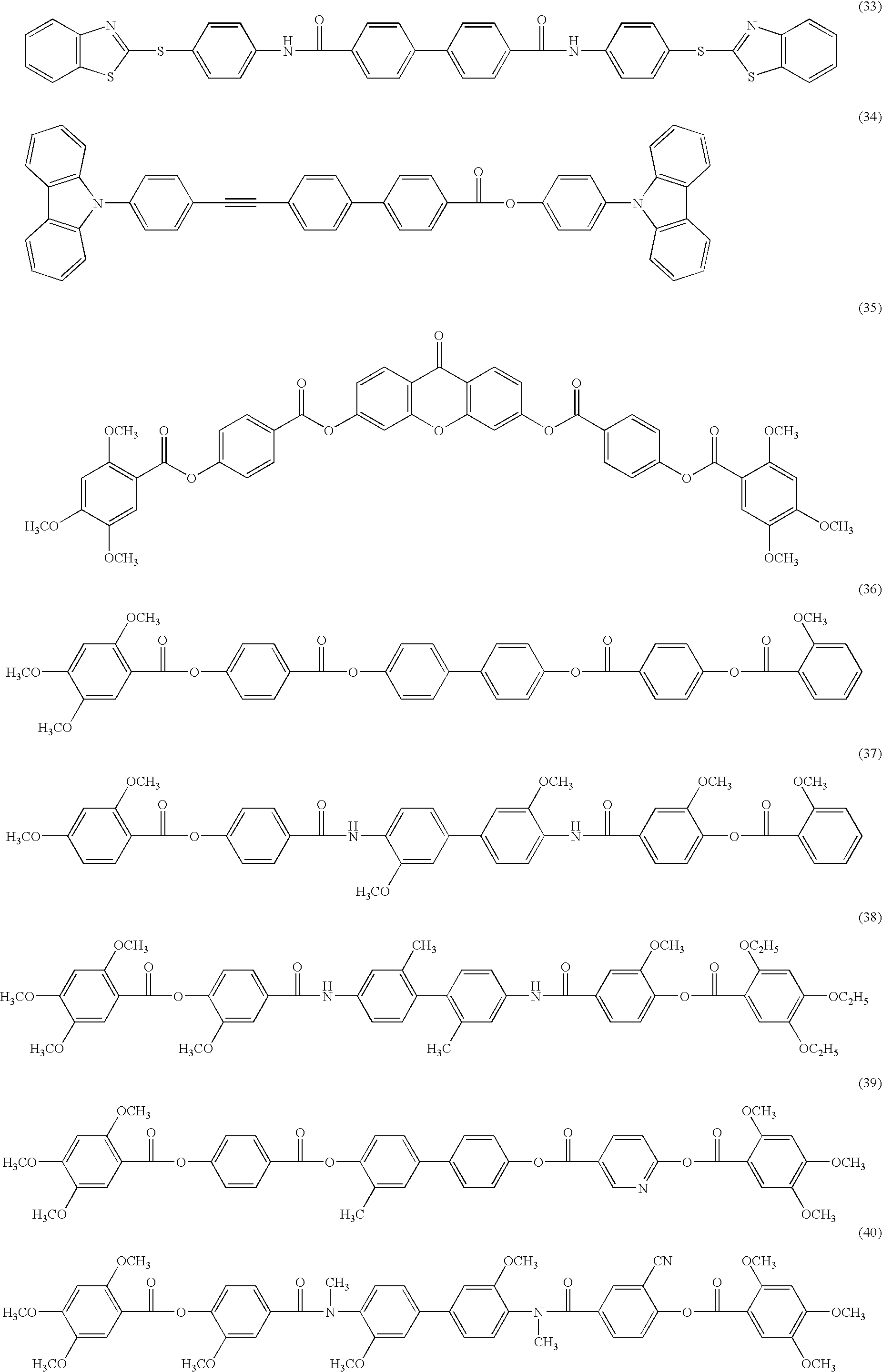

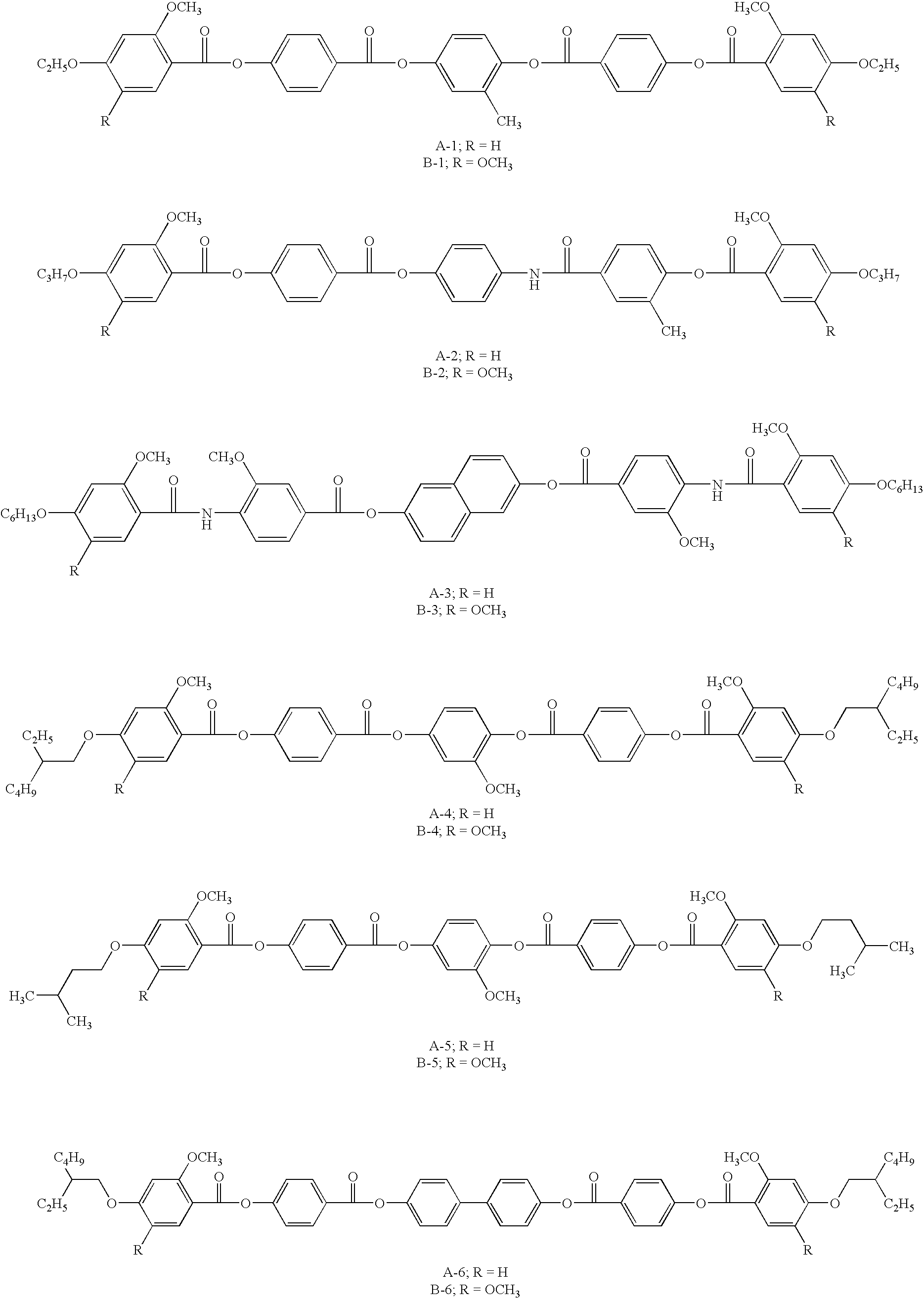

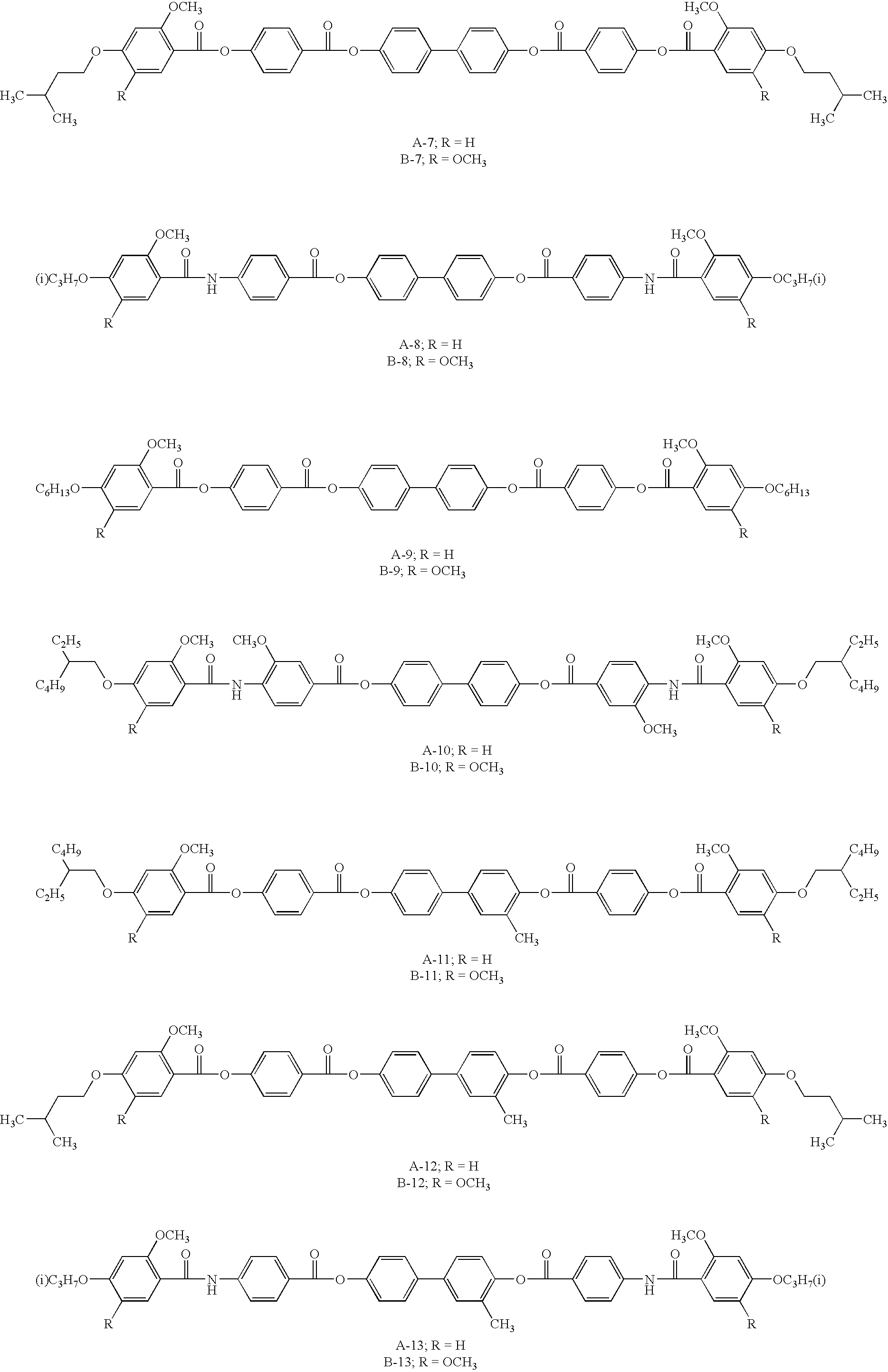

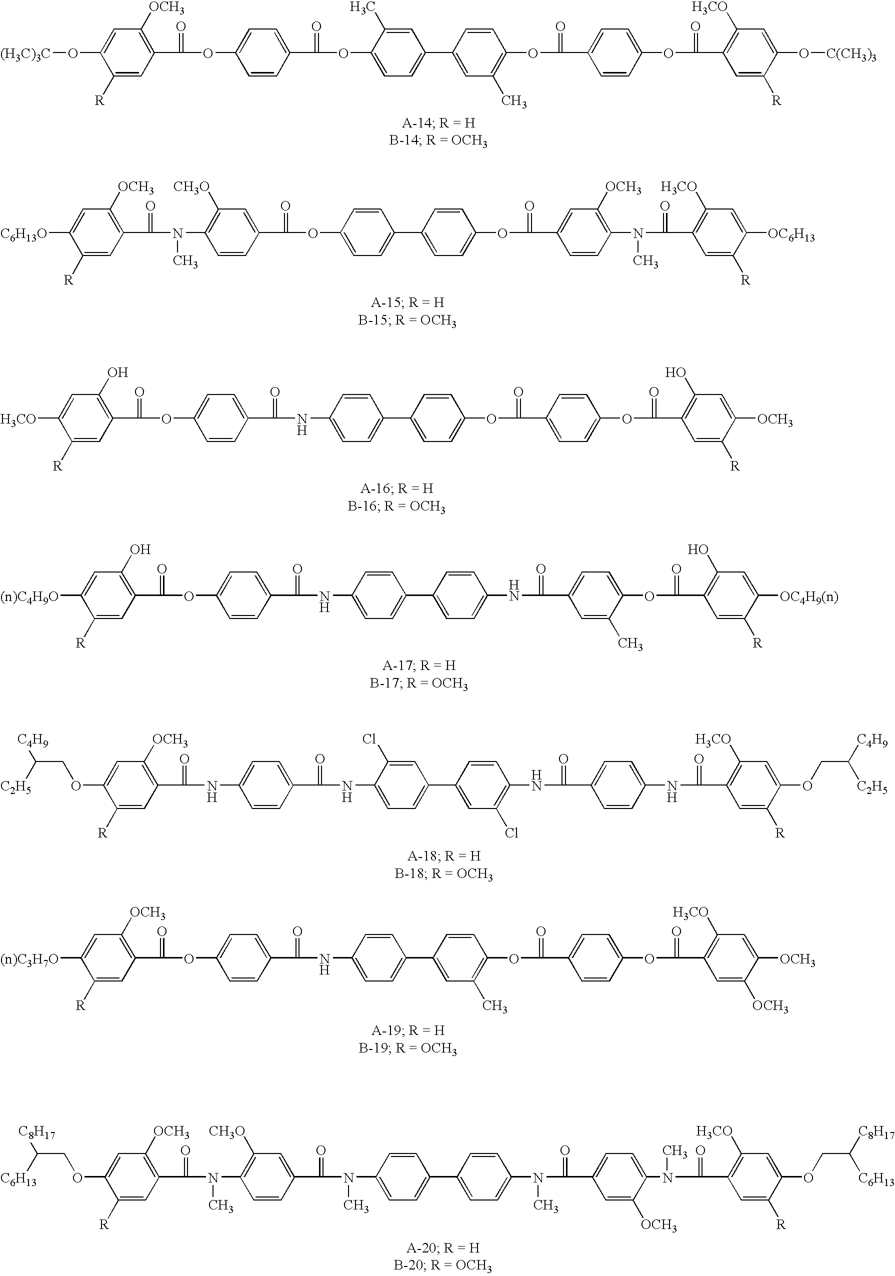

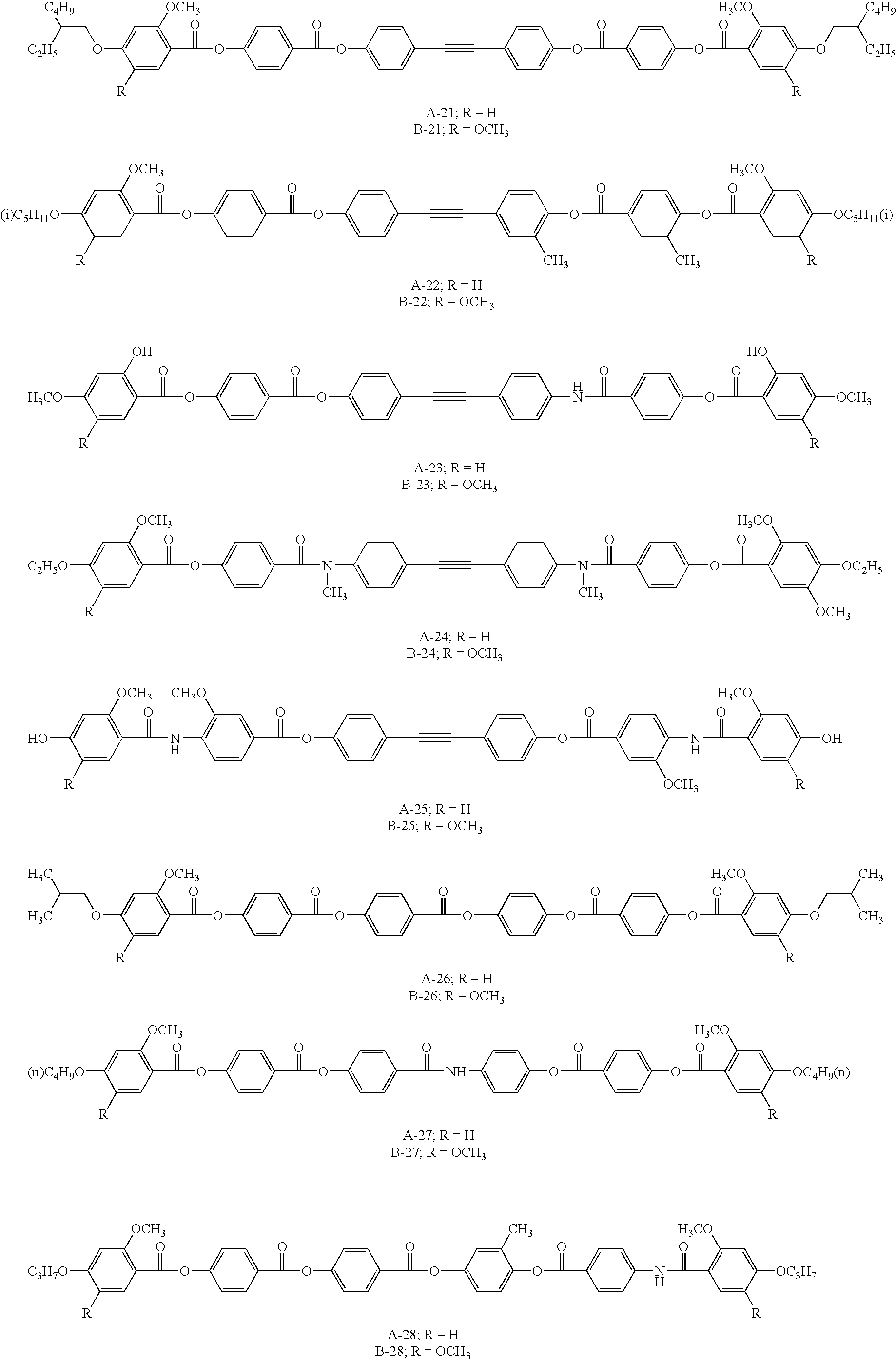

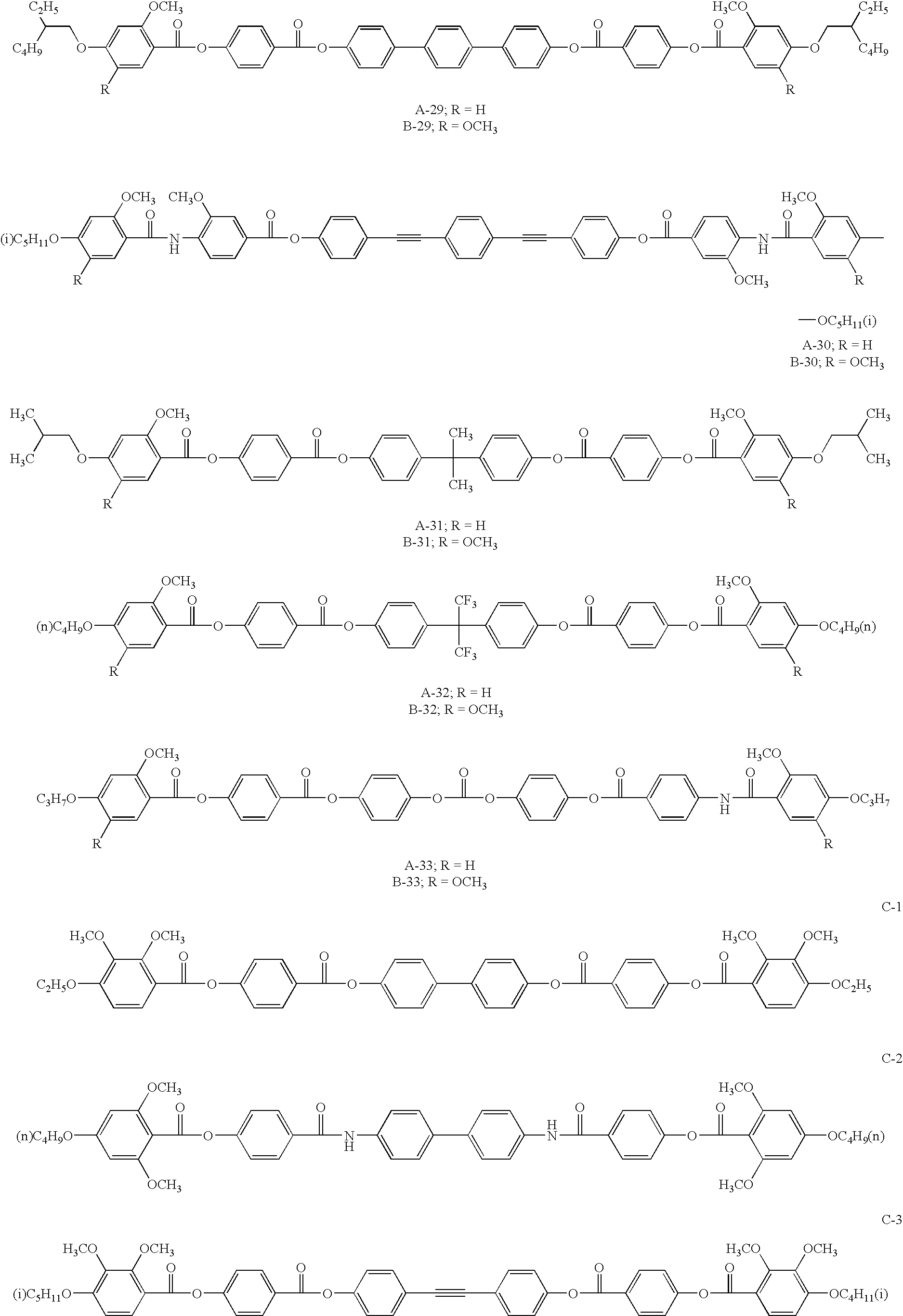

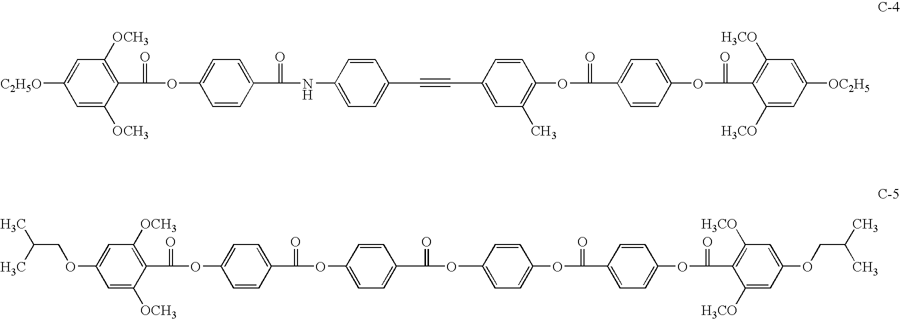

The wavelength dispersion-controlling agent of the invention may be added previously when a mixed solution of cellulose acylate is formed, or may be added to a dope of cellulose acylate that has been formed previously at any time until the casting. In the latter case, in order to carry out an in-line addition and mixing of a dope solution that is formed by dissolving cellulose acylate in a solvent and a solution that is formed by dissolving the wavelength dispersion-controlling agent and a small amount of cellulose acylate, for example, preferably used is such an in-line mixer as a static mixer (by Toray Engineering) and SWJ (Hi-Mixer, a static intratubular mixer by Toray). To the wavelength dispersion-controlling agent that is added subsequently, a matting agent may be mixed at the same time, or such an additive as a retardation controlling agent, a plasticizer, a degradation inhibiter or a peeling enhancer may be mixed. In case where an in-line mixer is used, concentrating dissolution under a high pressure is preferred, wherein the type of a pressurizable vessel is not particularly limited, but a vessel capable of enduring a predetermined pressure and carrying out heating and stirring under pressure suffices for the purpose. The pressurizable vessel is arranged arbitrarily with such measuring meters as a pressure gauge and thermometer. The pressurization may be carried out by such a method as injecting an inert gas such as nitrogen gas or heating to raise the vapor pressure of a solvent. The heating is carried out preferably from the outside. For example, the use of a heater of a jacket type is preferred because the temperature control is easy. When a solvent is added, the heating temperature is preferably within such a range that is at least the boiling point of the solvent to be used and does not allow the solvent to boil. It is suitable to preset the temperature, for example, within a range of 30 to 150° C. The pressure is so controlled that the solvent does not boil at the preset temperature. After the dissolution, the resultant is taken out of the vessel with cooling, or extracted from the vessel with a pump etc. to be cooled with a heat exchanger, which is provided for film forming. At this time, the resultant may be cooled down to ordinary temperature, but, more preferably, it is cooled down to a temperature lower than the boiling point of the solvent by 5 to 10° C. to be provided directly for casting at the temperature, because the dope viscosity can be reduced.

The wavelength dispersion-controlling agent in the invention may be used either singly or in a mixture of two or more types. The addition amount of the wavelength dispersion-controlling agent in the invention is preferably 1.0 to 20% by mass relative to 100 parts by mass of cellulose acylate, further preferably 1.5 to 15% by mass, most preferably 2.0 to 10% by mass.

Regarding the method for adding the wavelength dispersion-controlling agent in the invention, the wavelength dispersion-controlling agent may be dissolved in such an organic solvent as alcohol, methylene chloride or dioxolan and then added to the cellulose acylate solution (dope), or may be added directly to the dope composition.

### (Retardation Reducing Agent)

In case where the polymer film that is adopted in the invention is a low retardation cellulose acylate film, the incorporation of a compound having a high compatibility with a cellulose acylate film is preferred as a retardation reducing agent.

For the retardation reducing agent in the invention, compounds that are represented by the following formula (A) or (λ) are preferred, because they exert a large retardation-reducing effect.

Hereinafter, the compounds that are represented by formula (X) is described in detail.

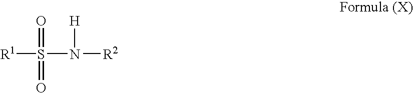

wherein R¹ and R² each independently represents an alkyl group or an aryl group.

Especially preferably the total carbon atoms of R¹ and R² is 10 or more. As a substituent thereof, a fluorine atom, alkyl group, aryl group, alkoxy group, sulfon group and sulfonamide group are preferred, and an alkyl group, aryl group, alkoxy group, sulfon group and a sulfonamide group are especially preferred. The alkyl group may be linear, branched or cyclic, and has carbon atoms of preferably 1 to 25, more preferably 6 to 25, especially preferably 6 to 20 (e.g., a methyl group, ethyl group, propyl group, isopropyl group, butyl group, isobutyl group, tert-butyl group, amyl group, isoamyl group, tert-amyl group, hexyl group, cyclohexyl group, heptyl group, octyl group, bicyclooctyl group, nonyl group, adamantyl group, decyl group, tert-octyl group, undecyl group, dodecyl group, tridecyl group, tetradecyl group, pentadecyl group, hexadecyl group, heptadecyl group, octadecyl group, nonadecyl group, didecyl group).

The aryl group has carbon atoms of preferably 6 to 30, especially preferably 6 to 24 (e.g., a phenyl group, biphenyl group, terphenyl group, naphthyl group, binaphthyl group, triphenylphenyl group).

Preferred examples of the compound that is represented by the formula (X) are shown below, but the invention is not limited to these specific examples. Here, Prⁱ represents an isopropyl group.

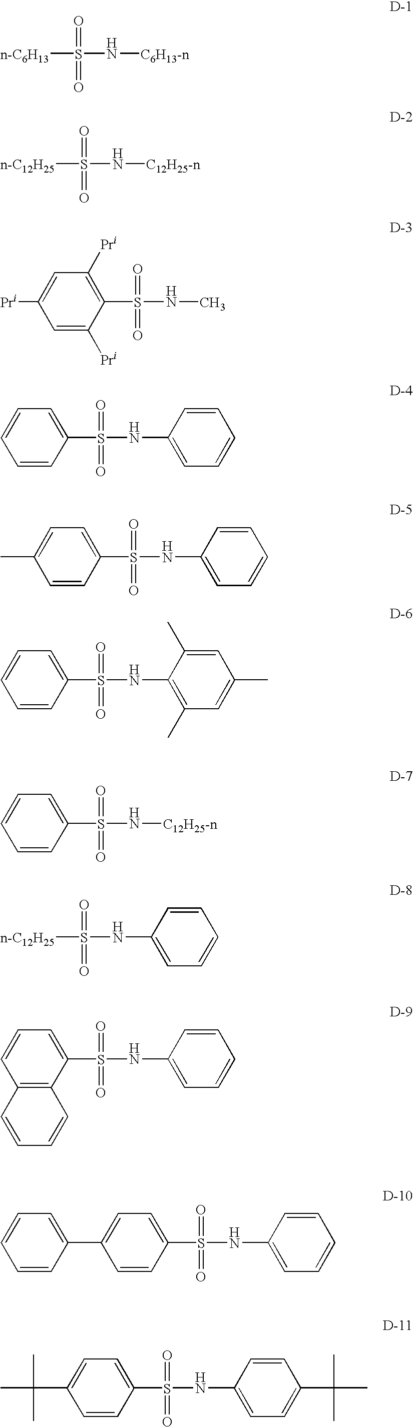

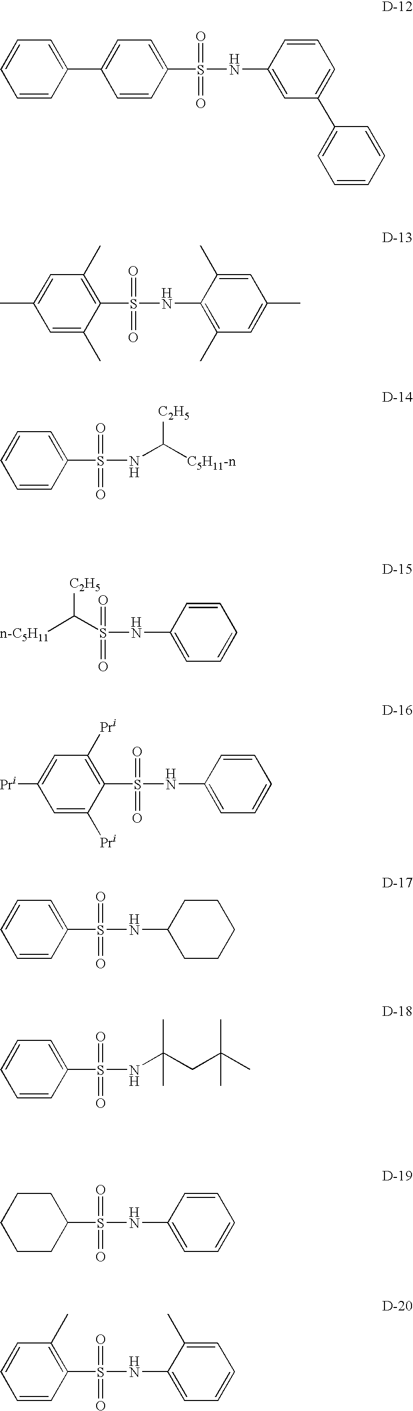

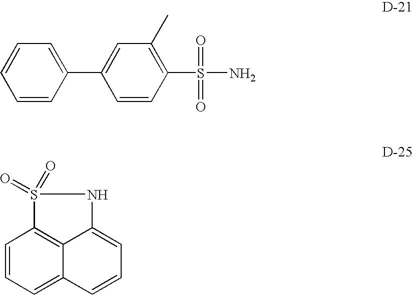

An acrylic polymer having a weight average molecular weight of 500 to 10,000 can be also used preferably as the retardation-reducing agent for the invention. A polymer having a weight average molecular weight of 500 to 10,000 has a good compatibility with cellulose acylate, and does neither evaporate nor volatile even during the film forming. In particular, an acrylic polymer having an aromatic ring in a side branch thereof or an acrylic polymer having a cyclohexyl group in a side branch thereof with a weight average molecular weight of preferably 500 to 5,000 gives, in addition to the above-described property, an excellent transparency and a very low moisture permeability to an cellulose acylate film after the film forming, to exerts an excellent performance as a protective film for a polarizing plate.

The acrylic polymer that is usable in the invention has a weight average molecular weight of 500 to 10,000, therefore it is a polymer that is considered to lie between an oligomer and a low molecular weight polymer. For synthesizing such polymer, the control of the molecular weight is difficult by ordinary polymerization methods, and it is desirable to use a method that gives a polymer not having a too large molecular weight, and that can make the molecular weight as uniform as possible. Examples of such polymerization methods include a method that uses such a peroxide polymerization initiator as cumene peroxide or tert-butylhydroperoxide, a method that uses a polymerization initiator in a larger amount compared with ordinary polymerizations, a method that uses such a chain transfer agent as a mercapto compound or a carbon tetrachloride in addition to a polymerization initiator, a method that uses such a polymerization terminator as benzoquinone or dinitrobenzene in addition to a polymerization initiator, a method of carrying out a bulk polymerization using, as a polymerization catalyst, a compound having one thiol group and secondary hydroxyl group, or the compound and an organic metal compound in combination, as described in JP-A-2000-128911 or JP-A-2000-344823. Each of the methods can be used preferably in the invention, and, in particular, the methods described in these gazettes are preferred.

A polymer that is referred to as an acrylic polymer (simply referred to as an acrylic polymer) in the invention denotes homopolymer or copolymer of acrylic acid or methacrylic acid alkyl ester having no monomer unit having an aromatic ring or a cyclohexyl group. An acrylic polymer having an aromatic ring in a side branch thereof means an acrylic polymer containing an acrylic acid or methacrylic acid ester monomer unit having indispensably an aromatic ring. An acrylic polymer having a cyclohexyl group in a side branch thereof means an acrylic polymer containing an acrylic acid or methacrylic acid ester monomer unit having a cyclohexyl group.

Examples of the acrylic acid ester monomer having neither aromatic ring nor cyclohexyl group include methyl acrylate, ethyl acrylate, (i-, n-)propyl acrylate, (n-, i-, s-, t-)butyl acrylate, (n-, i-, s-)pentyl acrylate, (n-, i-)hexyl acrylate, (n-, i-)heptyl acrylate, (n-, i-)octyl acrylate, (n-, i-)nonyl acrylate, (n-, i-)myristyl acrylate, (2-ethylhexyl)acrylate, (∈-caprolactone) acrylate, (2-hydroxyethyl)acrylate, (2-hydroxypropyl)acrylate, (3-hydroxypropyl)acrylate, (4-hydroxybutyl)acrylate, (2-hydroxybutyl)acrylate, (2-methoxyethyl)acrylate, (2-ethoxyethyl)acrylate; and those that are formed by replacing the acrylic acid ester with the corresponding methacrylic acid ester.

The acrylic polymer is homopolymer or copolymer of the above-described monomer, wherein it contains preferably 30% by mass or more of an acrylic acid methyl ester monomer unit, and preferably 40% by mass or more of a methacrylic acid methyl ester monomer unit. In particular, homopolymer of methyl acrylate or methyl methacrylate is preferred.

Examples of the acrylic or methacrylic acid ester monomer having an aromatic ring include phenyl acrylate, phenyl methacrylate, (2- or 4-chlorophenyl)acrylate, (2- or 4-chlorophenyl)methacrylate, (2- or 3- or 4-ethoxycarbonylphenyl)acrylate, (2- or 3-4-ethoxycarbonylphenyl)methacrylate, (o- or m- or p-tolyl)acrylate, (o- or m- or p-tolyl)methacrylate, benzyl acrylate, benzyl methacrylate, phenethyl acrylate, phenethyl methacrylate and (2-naphthyl)acrylate. Of these, preferably used are benzyl acrylate, benzyl methacrylate, phenethyl acrylate and phenethyl methacrylate.

Among acrylic polymers having an aromatic ring in the side branch thereof, preferred are those having 20 to 40% by mass of an acrylic acid or methacrylic acid ester monomer unit having an aromatic ring, and 50 to 80% by mass of an acrylic acid or methacrylic acid methyl ester monomer unit. These polymers have preferably 2 to 20% by mass of an acrylic acid or methacrylic acid ester monomer unit having a hydroxyl group.

Examples of the (meth)acrylic acid ester monomer having a cyclohexyl group include cyclohexyl acrylate, cyclohexyl methacrylate, (4-methylcyclohexyl)acrylate, (4-methylcyclohexyl)methacrylate, (4-ethylcyclohexyl)acrylate, (4-ethylcyclohexyl)methacrylate, wherein cyclohexyl acrylate and cyclohexyl methacrylate can be used preferably.

Among acrylic polymers having a cyclohexyl group in a side branch thereof, preferred are those having 20 to 40% by mass of an acrylic acid or methacrylic acid ester monomer unit having a cyclohexyl group, and 50 to 80% by mass of an acrylic acid or methacrylic acid methyl ester monomer unit. These polymers have preferably 2 to 20% by mass of an acrylic acid or methacrylic acid ester monomer unit having a hydroxyl group.

Each of the above-described polymer that is obtained by polymerizing an ethylenic unsaturated monomer, acrylic polymer, acrylic polymer having an aromatic ring in a side branch thereof, and acrylic polymer having a cyclohexyl group in a side branch thereof is excellent in compatibility with cellulose acylate, exerts excellent productivity with neither evaporation nor vaporization, has good retention as a protective film for a polarizing plate, a small moisture permeability, an excellent dimension stability, and a large effect on reducing the retardation.

The acrylic acid or methacrylic acid ester monomer having a hydroxyl group in the invention is a constituent unit of copolymer, instead of homopolymer. In this case, the acrylic acid or methacrylic acid ester monomer unit having a hydroxyl group is preferably contained in 2 to 20% by mass in the acrylic polymer.

In the invention, a polymer having a hydroxyl group in a side branch thereof can be also used preferably. The monomer unit having a hydroxyl group is the same as monomers as described above. Of these, acrylic acid or methacrylic acid esters are preferred, including, for example, (2-hydroxyethyl)acrylate, (2-hydroxypropyl)acrylate, (3-hydroxypropyl)acrylate, (4-hydroxybutyl)acrylate, (2-hydroxybutyl)acrylate, p-hydroxymethylphenyl acrylate, p-(2-hydroxyethyl)phenyl acrylate, and those obtained by replacing the acrylic acid with methacrylic acid. Preferred are 2-hydroxyethyl acrylate and 2-hydroxyethyl methacrylate. The acrylic acid ester or methacrylic acid ester monomer unit having a hydroxyl group in a side branch is contained preferably 2 to 20% by mass in the polymer, more preferably 2 to 10% by mass.

A polymer that is formed by incorporating the monomer unit having a hydroxyl group to the above-described polymer in 2 to 20% by mass not only has, of course, excellent compatibility with cellulose acylate, retention, dimension stability and small moisture permeability, but also is especially excellent in adhesiveness with a polarizer as a protective film for a polarizing plate, to exerts such effect as improving the durability of the polarizing plate.

In the invention, preferably the polymer has a hydroxyl group at least one end of the polymer main chain. A method of introducing a hydroxyl group at the end of the main chain is not particularly limited when the method makes it possible to introduce a hydroxyl group into the end of the main chain. It can be attained by such a method as using a radical polymerization initiator having a hydroxyl group such as azobis(2-hydroxyethylbutyrate), using a chain transfer agent having a hydroxyl group such as 2-mercaptoethanol, using a polymerization terminator having a hydroxyl group, using living ion polymerization to incorporate a hydroxyl group at the end, carrying out bulk polymerization using a compound having one thiol group and secondary hydroxyl group, or the compound and an organic metal compound in combination as a polymerization catalyst as described in JP-A-2000-128911 or JP-A-2000-344823, wherein the method as described in the gazettes is especially preferred. Polymers that have been formed by a method that is relevant to the description of the gazette is marketed as Actoflow Series by Souken Kagaku and can be used favorably.

The above-described polymer that has a hydroxyl group at the end and/or polymer that has a hydroxyl group in a side branch has such effect as improving significantly the compatibility and transparency of the polymer and reducing the retardation of the film, in the invention.

In the invention, the addition amount of the retardation reducing agent is preferably 1 to 30% by mass relative to cellulose acylate, more preferably 2 to 30% by mass, further preferably 3 to 25% by mass, most preferably 5% to 20% by mass.

The retardation reducing agent to be adopted in the invention can be used, for example, by dissolving it in such an organic solvent as alcohol, methylene chloride or dioxolan and adding the solution to a cellulose acetate solution (dope), or by adding the agent directly to a dope composition.

### [Production of Forward Wavelength Dispersion Low Retardation Film]

The cellulose acylate film in the invention can be produced by a solvent casting method. In a solvent casting method, a solution of cellulose acylate dissolved in an organic solvent (dope) is used for producing a film.

The organic solvent includes preferably a solvent that is selected from ether having 3 to 12 carbon atoms, ketone having 3 to 12 carbon atoms, ester having 3 to 12 carbon atoms and halogenated hydrocarbon having 1 to 6 carbon atoms.

The ether, ketone and ester may have a cyclic structure. Also usable are such compounds that have two or more of any of the functional groups of ether, ketone and ester (that is, —O—, —CO— and —COO—) as the organic solvent. The organic solvent may have another functional group such as an alcoholic hydroxyl group. In the case of an organic solvent having two types or more functional groups, preferably it has carbon atoms within a range of the above-described preferred carbon atoms of the solvent having any one of the functional groups.

Examples of the ether having 3 to 12 carbon atoms include diisopropyl ether, dimethoxymethane, dimethoxyethane, 1,4-dioxane, 1,3-dioxolan, tetrahydrofuran, anisole and phenetole.

Examples of the ketone having 3 to 12 carbon atoms include acetone, methyl ethyl ketone, diethyl ketone, diisobutyl ketone, cyclohexanone and methylcyclohexanone.

Examples of the ester having 3 to 12 carbon atoms include ethyl formate, propyl formate, pentyl formate, methyl acetate, ethyl acetate and pentyl acetate.

Examples of the organic solvent having two types or more functional groups include 2-ethoxyethyl acetate, 2-methoxyethanol and 2-butoxy ethanol.

Among the halogenated hydrocarbon having 1 to 6 carbon atoms, the number of carbon atoms is preferably 1 or 2, most preferably 1. The halogen of the halogenated hydrocarbon is preferably chlorine. In the halogenated hydrocarbon, the ratio of substituted hydrogen atoms with a halogen is preferably 25 to 75% by mol, more preferably 30 to 70% by mol, further preferably 35 to 65% by mol, most preferably 40 to 60% by mol. Methylene chloride is the representative halogenated hydrocarbon.

Two types or more organic solvents may be used in a mixture.

The cellulose acylate solution (dope) can be prepared by such a common method including treatment at a temperature of 0° C. or higher (ordinary temperature or high temperatures). The preparation of the cellulose acylate solution can be carried out using a method and apparatus for preparing a dope in a usual solvent casting method. In a common method, the use of halogenated hydrocarbon (especially methylene chloride) is preferred as an organic solvent.

The amount of cellulose acylate in the cellulose acylate solution is adjusted so as to be contained in 10 to 40% by mass in the solution to be obtained. The amount of cellulose acylate is further preferably 10 to 30% by mass. In the organic solvent (main solvent), any of after-mentioned additives may have been added.

The cellulose acylate solution can be prepared, for example, by stirring cellulose acylate and an organic solvent at ordinary temperature (0 to 40° C.). A solution having a high concentration may be stirred under pressurized and heated conditions. Specifically, cellulose acylate and an organic solvent are put and sealed in a pressurizable vessel, which are stirred under pressure with heating within a temperature range from the boiling point of the solvent under ordinary pressure to a temperature that does not boil the solvent. The heating temperature is usually 40° C. or higher, preferably 60 to 200° C., more preferably 80 to 110° C.

Respective components may be put in the vessel after having been roughly mixed. Or, they may be put in the vessel sequentially. The vessel must be constituted so that the components can be stirred. The vessel can be pressurized by injecting an inert gas such as nitrogen gas. Further, vapor pressure rising of the solvent caused by heating may be utilized. Or, after sealing the vessel, respective components may be added under pressure.

When carrying out heating, heating from the outside of the vessel is preferred. For example, a heating apparatus of a jacket type can be used. Or, by arranging a plate heater outside the vessel and arranging a pipe to circulate liquid, the heating of the whole vessel is also possible.

The stirring is preferably carried out by arranging stirring blades inside the vessel and use the same to stir. The stirring blades preferably have a length that reaches near the wall of the vessel. It is preferable to arrange a scraping blade at the end of the stirring blades in order to renew a liquid film on the wall of the vessel.

The vessel may be provided with gauges such as a pressure gauge and a thermometer. In the vessel, respective components are dissolved in the solvent. The prepared dope is taken out of the vessel after cooling, or is cooled using a heat exchanger or the like after being taken out of the vessel.

The cellulose acylate solution can be also prepared by a cooling dissolution method. In a cooling dissolution method, cellulose acylate can be also dissolved in an organic solvent in which dissolving the cellulose acylate is difficult by an ordinary dissolution method. In this connection, there is such an advantage that even a solvent capable of dissolving cellulose acylate by an ordinary dissolution method can give a homogeneous solution rapidly by a cooling dissolution method.

In a cooling dissolution method, first, cellulose acylate is gradually added into an organic solvent with stirring at room temperature. The amount of the cellulose acylate is adjusted preferably to give a concentration of 10 to 40% by mass in the mixture. The amount of the cellulose acylate is more preferably 10 to 30% by mass. Further, to the mixture, after-mentioned any additives may have been added.

Next, the mixture is cooled to, for example, −100 to 10° C. (preferably −80 to −10° C., further preferably −50 to −20° C., most preferably −50 to −30° C.). The cooling can be carried out in, for example, a dry ice/methanol bath (−75° C.) or a cooled diethylene glycol solution (−30 to −20° C.). By cooling, the mixture of the cellulose acylate and the organic solvent solidifies.

The cooling rate is preferably 4° C./min or greater, more preferably 8° C./min or greater, further preferably 12° C./min or greater. A greater cooling rate is more preferred, but 10000° C./sec is the theoretical upper limit, 1000° C./sec is the technical upper limit, and 100° C./sec is the practical upper limit. The cooling rate is a value obtained by dividing the difference between a temperature at the beginning of the cooling and a finally cooled temperature by the time period from the beginning of the cooling up to the achievement of a finally cooled temperature.

Further, when the cooled mixture is heated to, for example, 0 to 200° C. (preferably 0 to 150° C., further preferably 0 to 120° C., most preferably 0 to 50° C.), the cellulose acylate dissolves in the organic solvent. The mixture may be only left at room temperature or heated in a warm bath, to rise the temperature. The rate of temperature rise is preferably 4° C./min or greater, further preferably 8° C./min or greater, and most preferably 12° C./min or greater. A greater rate of temperature rise is more preferred, but 10000° C./sec is the theoretical upper limit, 1000° C./sec is the technical upper limit, and 100° C./sec is the practical upper limit. The rate of temperature rise is a value obtained by dividing the difference between a temperature at the beginning of the temperature rise and a finally risen temperature by the time period from the beginning of temperature rise up to achievement of a finally risen temperature.

In the above-described way, a homogeneous cellulose acylate solution is obtained. When dissolution is insufficient, the operation of the cooling and the heating may be repeated. Whether or not the dissolution is sufficient can be determined only by observing visually the appearance of the solution.

In the cooling dissolution method, in order to avoid the interfusion of water that is caused by dew formation at cooling, the use of a sealable vessel is desirable. Moreover, such a cooling/heating operation as cooling while adding the pressure and heating while reducing the pressure can shorten the dissolution time. In order to practice adding/reducing the pressure, the use of a pressure-resistant vessel is desirable.

Incidentally, a solution of 20% by mass that is prepared by dissolving cellulose acetate (acetylation degree: 60.9%, viscosity average molecular weight: 299) in methyl acetate by a cooling dissolution method has a pseudo-phase transition point for a sol state and a gel state at around 33° C., according to measurement with a differential scanning calorimeter (DSC), and shows a homogeneous gel state at the temperature or lower. Accordingly, it is preferred to store the solution at the pseudo-phase transition point or higher, more preferably a temperature around a gel phase transition temperature+10° C. In this connection, the pseudo-phase transition point varies depending on the acetylation degree or the viscosity average polymerization degree of cellulose acylate, the concentration of the solution, and an organic solvent to be used.

From the prepared cellulose acylate solution (dope), a cellulose acylate film is produced by a solvent casting method. The dope is cast on a drum or a band, from which the solvent is evaporated to form a film. The concentration of the dope before casting is preferably adjusted to give a solid content of 18 to 35%. The surface of the drum or the band has been preferably finished in a mirror-like condition. The dope is preferably cast on a drum or a band having a surface temperature of 10° C. or lower.

For the drying method in a solvent casting method, there are descriptions in U.S. Pat. Nos. 2,336,310, 2,367,603, 2,492,078, 2,492,977, 2,492,978, 2,607,704, 2,739,069 and 2,739,070, GB Patent Nos. 640731 and 736892, JP-B-45-4554, JP-B-49-5614, JP-A-60-176834, JP-A-60-203430 and JP-A-62-115035. The drying on a band or a drum can be carried out by blowing air or such an inert gas as nitrogen.

The obtained film can be peeled off from the drum or band and dried further by a high temperature air whose temperature is gradually altered from 100 to 160° C. to evaporate the residual solvent. The method is described in JP-B-5-17844. According to the method, it is possible to shorten the time from the casting to the peeling off. In order to practice the method, the gelation of the dope at the surface temperature of the drum or band at casting is necessary.

Prepared cellulose acylate solution (dope) may be used for casting two or more layers to form a film. In this case, it is preferred to form a cellulose acylate film by a solvent casting method. The dope is cast on a drum or a band, from which the solvent is evaporated to form a film. The concentration of the dope before the casting is adjusted preferably to have a solid content within the range of 10 to 40% by mass. The surface of the drum or the band has been preferably finished in a mirror-like condition.

When casting plural cellulose acylate liquids for two or more layers, casting of plural cellulose acylate solutions is possible. A film may be formed by casting and laminating respective solutions including cellulose acylate from plural casting openings that are disposed in the traveling direction of a support with intervals. Methods described in, for example, JP-A-61-158414, JP-A-1-122419 and JP-A-11-198285 can be employed. A film may be also formed by casting cellulose acylate solutions from two casting openings. This can be practiced according to methods described in, for example, JP-B-60-27562, JP-A-61-94724, JP-A-61-947245, JP-A-61-104813, JP-A-61-158413 and JP-A-6-134933. Further, a casting method of cellulose acylate film described in JP-A-56-162617, in which flow of a cellulose acylate solution with a high viscosity is encompassed by a cellulose acylate solution with a low viscosity and the cellulose acylate solutions with a high/low viscosity are extruded at the same time, may be employed.

Further, a film may be formed using two casting openings, wherein a film is formed on a support by a first casting opening and peeled off, followed by carrying out a second casting on the side of the film having contacted with the support face. This is the method described in, for example, JP-B-44-20235.

For the cellulose acylate solutions to be cast, the same type solutions may be used, or two or more different types of cellulose acylate solutions may be used. In order to give respective functions to plural cellulose acylate layers, each of cellulose acylate solutions corresponding to the functions may be extruded from respective casting openings. Furthermore, the cellulose acylate solution in the invention can be simultaneously cast with other functional layers (e.g., an adhesive layer, dye layer, antistatic layer, antihalation layer, UV absorbing layer, polarizer).

In the case of a conventional liquid for a single layer, it was necessary to extrude a cellulose acylate solution with a high concentration and a high viscosity in order to give a necessary film thickness, which often resulted in such problem that the cellulose acylate solution had a poor stability to generate a solid material, thereby leading to fisheye failure or bad flat surface property. In order to solve the problem, by casting plural cellulose acylate solutions from casting openings, solutions with a high viscosity can be simultaneously extruded on a support, thereby making it possible to form a film having an improved flat surface property and excellent surface conditions, as well as to achieve lowering in drying load by the use of concentrated cellulose acylate solutions, and to increase production speed of the film.

To the cellulose acylate film, a degradation inhibitor (e.g., an oxidation inhibitor, peroxide decomposition agent, radical inhibitor, metal inactivator, acid trapping agent, amine) may be added. About the degradation inhibitor, there are descriptions in JP-A-3-199201, JP-A-5-1907073, JP-A-5-194789, JP-A-5-271471, JP-A-6-107854. The addition amount of the degradation inhibitor is preferably 0.01 to 1% by mass of the solution (dope) to be prepared, further preferably 0.01 to 0.2% by mass. The addition amount of 0.01% by mass or more allows the degradation inhibitor to exert the effect sufficiently, which is preferred. The addition amount of 1% by mass or less hardly allows the degradation inhibitor to bleed out (weep) to the film surface, which is preferred. Examples of the especially preferred degradation inhibitor include butylated hydroxytoluene (BHT) and tribenzylamine (TBA).

These steps of from the casting to the post-drying may be carried out under either air atmosphere or inert gas atmosphere such as of nitrogen gas. A winding machine used for producing the cellulose acylate film in the invention may be one that is used commonly. The film can be wound by such a winding method as a constant tension method, a constant torque method, a tapered tension method, or a programmed tension controlling method of constant internal stress.

### [Thickness of Forward Wavelength Dispersion Cellulose Acylate Film]

The thickness of the forward wavelength dispersion cellulose acylate film of the invention is preferably 10 μm to 200 μm, more preferably 20 μm to 150 μm, further preferably 30 μm to 100 μm.

### [Saponification]

The forward wavelength dispersion cellulose acylate film of the invention may be subjected to an alkali saponification treatment, thereby improving the adhesion to a polarizer material such as a polyvinyl alcohol, to be uses as the polarizing plate protective films.

The alkali saponification treatment of the polymer films is preferably such that a film surface is soaked in an alkali solution, neutralized by an acidic solution, washed with water, and dried. The alkali solution may be a potassium hydroxide solution or a sodium hydroxide solution, and the hydroxide ion concentration thereof is preferably 0.1 to 5.0 mol/L, more preferably 0.5 to 4.0 mol/L. The temperature of the alkali solution is preferably within a range of room temperature to 90° C., more preferably within a range of 40 to 70° C.

### <Production of Polarizing Plate>

### (Polarizer)

A polarizer used in a polarizing plate in the invention is described below.

In the invention, the polarizer is preferably composed of a polyvinyl alcohol (PVA) and a dichroic molecule, and may be a polyvinylene polarizer prepared by subjecting a PVA or polyvinyl chloride to dehydration or dechlorination and by aligning the generated polyene structure as described in JP-A-11-248937.

The PVA is preferably a polymer material obtained by saponifying a polyvinyl acetate, and may contain a component capable of copolymerizing with vinyl acetate, such as an unsaturated carboxylic acid, an unsaturated sulfonic acid, an olefin, or a vinyl ether. Further, modified PVAs having an acetoacetyl group, sulfonic acid group, carboxyl group, oxyalkylene group, etc. may be used in the invention.

The saponification degree of the PVA is not particularly limited, and is preferably 80 to 100 mol %, particularly preferably 90 to 100 mol %, from the viewpoint of solubility, etc. The polymerization degree of the PVA is not particularly limited, preferably 1,000 to 10,000, particularly preferably 1,500 to 5,000.

It is preferred that the syndiotacticity of the PVA is 55% or more in view of improving the durability as described in Japanese Patent No. 2978219. It is also preferred that the syndiotacticity is 45 to 52.5% as described in Japanese Patent No. 3317494.

It is preferred that the PVA is formed into a film and then a dichroic molecule is introduced to prepare the polarizer. Generally the PVA film is preferably produced by casting a liquid prepared by dissolving a PVA-based resin in water or an organic solvent. The polyvinyl alcohol-based resin concentration of the liquid is generally 5 to 20% by mass, and a 10 to 200-μm-thick PVA film may be formed by casting the liquid. The PVA film can be produced with reference to Japanese Patent No. 3342516, JP-A-09-328593, JP-A-2001-302817, JP-A-2002-144401, etc.

The crystallinity degree of the PVA film is not particularly limited. The average crystallinity degree (Xc) may be 50 to 75% by mass as described in Japanese Patent No. 3251073, and the crystallinity degree may be 38% or less to reduce the in-plane hue unevenness as described in JP-A-2002-236214.

The PVA film preferably has a small birefringence (Δn), and the birefringence is preferably 1.0×10⁻³ or less as described in Japanese Patent No. 3342516. The birefringence of the PVA film may be 0.002 to 0.01 to obtain a high polarization degree while preventing breakage of the PVA film in the stretching step as described in JP-A-2002-228835. Further, the value of (nx+ny)/2−nz may be 0.0003 to 0.01 as described in JP-A-2002-060505. The Re(1090) of the PVA film is preferably 0 to 100 nm, further preferably 0 to 50 nm. Further, the Rth(1090) of the PVA film is preferably 0 to 500 nm, further preferably 0 to 300 nm.

Additionally, a PVA film having a bonding 1,2-glycol amount of 1.5 mol % or less described in Japanese Patent No. 3021494, a PVA film having 500 or less optically foreign substances of 5 μm or more in size per 100 cm² described in JP-A-2001-316492, a PVA film having a hot water breaking temperature of 1.5° C. or lower in the TD direction described in JP-A-2002-030163, and a PVA film prepared from a solution containing 1 to 100 parts by mass of 3 to 6-polyvalent alcohol such as glycerin or 15% by mass or more of a plasticizer described in JP-A-06-289225 can be preferably used for the polarizing plate in the invention.

The film thickness of the unstretched PVA film is not particularly limited, preferably 1 μm to 1 mm, particularly preferably 20 to 200 μm from the viewpoint of the film stability and uniform stretching. Such a thin PVA film that 10 N or less of stress is generated in the stretching in water at a ratio of 4 to 6 times may be used as described in JP-A-2002-236212.

The dichroic molecule may be a higher iodine ion such as I₃⁻ or I₅⁻, or a dichroic dye. The higher iodine ion is particularly preferably used in the invention. The higher iodine ion can be generated such that the PVA is soaked in a liquid prepared by dissolving iodine in an aqueous potassium iodide solution and/or an aqueous boric acid solution to adsorb the iodine to the PVA as described in Henkoban no Oyo, Ryo Nagata, CMC and Kogyo Zairyo, Vol. 28, No. 7, Page 39 to 45.

In the case of using the dichroic dye as the dichroic molecule, the dichroic dye is preferably an azo dye, particularly preferably a bisazo or trisazo dye. The dichroic dye is preferably water-soluble, and thus a hydrophilic substituent such as a sulfonic acid group, an amino group, or a hydroxyl group is preferably introduced to a dichroic molecule, to generate a free acid, an alkaline metal salt, an ammonium salt, or an amine salt.

Specific examples of the dichroic dyes include benzidine dyes such as C.I. Direct Red 37, Congo Red (C.I. Direct Red 28), C.I. Direct Violet 12, C.I. Direct Blue 90, C.I. Direct Blue 22, C.I. Direct Blue 1, C.I. Direct Blue 151, and C.I. Direct Green 1; diphenylurea dyes such as C.I. Direct Yellow 44, C.I. Direct Red 23, and C.I. Direct Red 79; stilbene dyes such as C.I. Direct Yellow 12; dinaphtylamine dyes such as C.I. Direct Red 31; Jaciddyes such as C.I. Direct Red 81, C.I. Direct Violet 9, and C.I. Direct Blue 78.

In addition, the dichroic dyes preferably used in the invention include C.I. Direct Yellow 8, C.I. Direct Yellow 28, C.I. Direct Yellow 86, C.I. Direct Yellow 87, C.I. Direct Yellow 142, C.I. Direct Orange 26, C.I. Direct Orange 39, C.I. Direct Orange 72, C.I. Direct Orange 106, C.I. Direct Orange 107, C.I. Direct Red 2, C.I. Direct Red 39, C.I. Direct Red 83, C.I. Direct Red 89, C.I. Direct Red 240, C.I. Direct Red 242, C.I. Direct Red 247, C.I. Direct Violet 48, C.I. Direct Violet 51, C.I. Direct Violet 98, C.I. Direct Blue 15, C.I. Direct Blue 67, C.I. Direct Blue 71, C.I. Direct Blue 98, C.I. Direct Blue 168, C.I. Direct Blue 202, C.I. Direct Blue 236, C.I. Direct Blue 249, C.I. Direct Blue 270, C.I. Direct Green 59, C.I. Direct Green 85, C.I. Direct Brown 44, C.I. Direct Brown 106, C.I. Direct Brown 195, C.I. Direct Brown 210, C.I. Direct Brown 223, C.I. Direct Brown 224, C.I. Direct Black 1, C.I. Direct Black 17, C.I. Direct Black 19, C.I. Direct Black 54, and dyes described in JP-A-62-70802, JP-A-1-161202, JP-A-1-172906, JP-A-1-172907, JP-A-1-183602, JP-A-1-248105, JP-A-1-265205, and JP-A-7-261024. Two or more dichroic dyes may be used in combination to obtain various hues. In the case of using the dichroic dye, the adsorption thickness may be 4 μm or more as described in JP-A-2002-082222.

The ratio of the dichroic molecule to the film matrix of the polyvinyl alcohol-based polymer is generally controlled within a range of 0.01 to 5% by mass. Too low dichroic molecule content results in reduction of polarization degree, and excessively high dichroic molecule content results in reduction of the single-plate transmittance.

The thickness of the polarizer is preferably 5 to 40 μm, more preferably 10 to 30 Mm. Further, it is preferred that the thickness ratio of the polarizer to the protective film satisfies the condition of 0.01≦A (Polarizer thickness)/B (Protective film thickness)≦0.16 as described in JP-A-2002-174727.

Further, the crossing angle between the slow axis of the protective film and the absorption axis of the polarizer may be any one, and it is preferred that the axes are parallel or the crossing angle is an azimuthal angle of 45±20°.

### <Production of Polarizing Plate>

Processes for producing the polarizing plate in the invention are described below.

In the invention, the polarizing plate is preferably produced by a method having a swelling step, dyeing step, hardening step, stretching step, drying step, protective film attaching step, and attached film drying step. The order of the dyeing, hardening, and stretching steps may be changed, and some steps may be combined and simultaneously carried out. It is preferred that the film is water-washed after the hardening step as described in Japanese Patent No. 3331615.

In the invention, the swelling, dyeing, hardening, stretching, drying, protective film attaching, and attached film drying steps are particularly preferably carried out in this order. On-line surface evaluation may be carried out in or after the steps.

Though the swelling step is preferably carried out using only water, a polarizing plate matrix may be swelled by an aqueous boric acid solution, thereby controlling the swelling degree to improve the optical performance stability and prevent wrinkling of the matrix in the production line as described in JP-A-10-153709.

The temperature and time of the swelling may be any one, and are preferably 10 to 60° C. and 5 to 2,000 seconds.

The dyeing step may be carried out using a method described in JP-A-2002-86554. The dyeing may be achieved by soaking, application or spraying of an iodine or dye solution, etc. Further, the dyeing may be carried out while controlling the iodine concentration, dyeing bath temperature, and stretch ratio in the bath and while stirring the solution in the bath as described in JP-A-2002-290025.

In the case of using the higher iodine ion as the dichroic molecule, in the dyeing step, a solution prepared by dissolving iodine in an aqueous potassium iodide solution is preferably used to obtain a high-contrast polarizing plate. It is preferred that, in the aqueous iodine-potassium iodide solution, the iodine concentration is 0.05 to 20 g/l, the potassium iodide concentration is 3 to 200 g/l, and the mass ratio of iodine and potassium iodide is 1 to 2,000. The dyeing time is preferably 10 to 1,200 seconds, and the solution temperature is preferably 10 to 60° C. It is more preferred that the iodine concentration is 0.5 to 2 g/l, the potassium iodide concentration is 30 to 120 g/l, the mass ratio of iodine and potassium iodide is 30 to 120, the dyeing time is 30 to 600 seconds, and the solution temperature is 20 to 50° C.

A boron compound such as boric acid or borax may be added to the dyeing solution as described in Japanese Patent No. 3145747.

In the hardening step, the intermediate film is preferably soaked in a crosslinking agent solution or coated with the solution, thereby adding a crosslinking agent to the film. The hardening step may be carried out in several batches as described in JP-A-11-52130.

The crosslinking agent may be an agent described in U.S. Reissue Pat. No. 232897. Also a boron compound such as boric acid or borax may be used as the crosslinking agent. The crosslinking agent is most preferably a boric acid compound though it may be a polyvalent aldehyde for increasing the dimension stability as described in Japanese Patent No. 3357109. In the case of using boric acid as the crosslinking agent in the hardening step, a metal ion may be added to an aqueous boric acid-potassium iodide solution. A compound containing the metal ion is preferably zinc chloride, and zinc salts including zinc halides such as zinc iodide, zinc sulfate, and zinc acetate may be used instead of zinc chloride as described in JP-A-2000-35512.

In the invention, the PVA film is preferably hardened by soaking the film in an aqueous boric acid-potassium iodide solution containing zinc chloride. It is preferred that the boric acid concentration is 1 to 100 g/l, the potassium iodide concentration is 1 to 120 g/l, the zinc chloride concentration is 0.01 to 10 g/l, the hardening time is 10 to 1,200 seconds, and the solution temperature is 10 to 60° C. It is more preferred that the boric acid concentration is 10 to 80 g/l, the potassium iodide concentration is 5 to 100 g/l, the zinc chloride concentration is 0.02 to 8 g/l, the hardening time is 30 to 600 seconds, and the solution temperature is 20 to 50° C.

In the stretching step, a vertical monoaxial stretching method described in U.S. Pat. No. 2,454,515, etc. and a tentering method described in JP-A-2002-86554 can be preferably used. The stretch ratio is preferably 2 to 12 times, more preferably 3 to 10 times. It is preferred that the stretch ratio, the film thickness, and the polarizer thickness satisfies the condition of (Thickness of protective film-attached polarizer/Thickness of film)×(Total stretch ratio)>0.17 as described in JP-A-2002-040256, and that the width of the polarizer taken from final bath and the width of the polarizer at the time of attaching the protective film satisfies the condition of 0.80≦(Width of polarizer at attaching protective film/Width of polarizer taken from final bath)≦0.95, as described in JP-A-2002-040247.

In the drying step, a known method described in JP-A-2002-86554 may be used, and the drying temperature is preferably 30 to 100° C., and the drying time is preferably 30 seconds to 60 minutes. It is also preferred that a heat treatment for controlling an in-water discoloring temperature at 50° C. or higher is carried out as described in Japanese Patent No. 3148513, and that an aging treatment under controlled temperature and humidity is carried out as described in JP-A-07-325215 and JP-A-07-325218.

In the protective film attaching step, 2 protective films are bonded to both sides of the polarizer after the drying step. It is preferred that an adhesive liquid is applied immediately before the bonding, and the polarizer is sandwiched between and bonded to the protective films by a couple of rollers. It is preferred that the water content of the polarizer is controlled at the time of the bonding, to prevent concavity and convexity like grooves in a record due to the stretching as described in JP-A-2001-296426 and JP-A-2002-86554. In the invention, the water content is preferably 0.1 to 30%.

The adhesive for bonding the polarizer and the protective films is not particularly limited, and examples thereof include PVA-based resins (including PVAs modified with an acetoacetyl group, a sulfonic acid group, a carboxyl group, an oxyalkylene group, etc.) and aqueous boron compound solutions. The adhesive is preferably the PVA-based resin. The thickness of the dried adhesive layer is preferably 0.01 to 5 μm, particularly preferably 0.05 to 3 μm.

It is preferred that, to increase the adhesive strength between the polarizer and the protective films, the protective films are surface-treated to be hydrophilic, and then bonded to the polarizer. The surface treatment is not particularly restricted and may be a known treatment such as a saponification treatment using an alkali solution or a corona treatment. Further, a highly adhesive layer such as a gelatin undercoat layer may be formed after the surface treatment. It is preferred that the contact angle of the protective film surface against water is 50° or less as described in JP-A-2002-267839.

The conditions of drying after the bonding may be those described in JP-A-2002-86554, and the drying temperature is preferably 30 to 100° C. and the drying time is preferably 30 seconds to 60 minutes. Further, it is preferred that an aging treatment under controlled temperature and humidity is carried out as described in JP-A-07-325220.

Each element content of the polarizer is preferably such that the iodine content is 0.1 to 3.0 g/m², the boron content is 0.1 to 5.0 g/m², the potassium content is 0.1 to 2.00 g/m², and the zinc content is 0 to 2.00 g/m². The potassium content may be 0.2% by mass or less as described in JP-A-2001-166143, and the zinc content may be 0.04% to 0.5% by mass as described in JP-A-2000-035512.

An organic titanium compound and/or an organic zirconium compound may be added to the film in any of the dyeing, stretching, and hardening steps, to increase the dimension stability of the polarizing plate, as described in Japanese Patent No. 3323255. Further, a dichroic dye may be added to control the hue of the polarizing plate.

### <Properties of Polarizing Plate>

### (1) Transmittance and Polarization Degree

In the invention, the single-plate transmittance of the polarizing plate is preferably 42.5% to 49.5%, more preferably 42.8% to 49.0%. The polarization degree defined by the following Equation 4 is preferably 99.900% to 99.999%, more preferably 99.940% to 99.995%. The parallel transmittance is preferably 36% to 42%, and the perpendicular transmittance is preferably 0.001% to 0.05%.

Polarization degree (%)=√{(Pa−Pe)/(Pa+Pe)} Equation 1

Pa: Parallel transmittance
Pe: Perpendicular transmittance

The transmittance is defined by the following equation in accordance with JIS Z8701.

T=K∫S(λ)y(λ)τ(λ)dλ

In the equation, K, S(λ), y(λ), and τ(λ) are as follows.

$$K = \frac{100}{\int S ( λ ) y ( λ ) d λ} \qquad Equation 3$$

S(λ): Spectral distribution of standard light for color display
y(λ): Color matching function in XYZ system
τ(λ): Spectral transmittance

The dichroic ratio defined by the following Equation 5 is preferably 48 to 1215, more preferably 53 to 525.

$$Dichroic ratio ( Rd ) = \frac{log [ \frac{\begin{matrix}Single \text{-} plate \\ transmittance\end{matrix}}{100} ( 1 - \frac{\begin{matrix}Polarization \\ degree\end{matrix}}{100} ) ]}{log [ \frac{\begin{matrix}Single \text{-} plate \\ transmittance\end{matrix}}{100} ( 1 + \frac{\begin{matrix}Polarization \\ degree\end{matrix}}{100} ) ]} \qquad Equation 5$$

The iodine concentration and the single-plate transmittance may be in ranges described in JP-A-2002-258051, Paragraph 0017.

The wavelength dependency of the parallel transmittance may be lower as described in JP-A-2001-083328 and JP-A-2002-022950. In the case of placing the polarizing plate in the crossed nicols state, the optical property may be in a range described in JP-A-2001-091736, Paragraph 0007, and the relation between the parallel transmittance and the perpendicular transmittance may be in a range described in JP-A-2002-174728, Paragraph 0006.

As described in JP-A-2002-221618, in a light wavelength range of 420 to 700 nm, the standard deviation of parallel transmittance of every 10 nm may be 3 or less, and the minimum values of (Parallel transmittance/Perpendicular transmittance) of every 10 nm may be 300 or more.

Also it is preferred that the parallel transmittance and the perpendicular transmittance of the polarizing plate at a wavelength of 440 nm, those at a wavelength of 550 nm, and those at a wavelength of 610 nm are within ranges described in JP-A-2002-258042, Paragraph 0012 or JP-A-2002-258043, Paragraph 0012.

### (2) Hue

The hue of the polarizing plate in the invention is preferably evaluated by using a lightness index L* and chromaticness indexes a* and b* of the L*a*b* calorimetric system with a CIE uniform color space.

Definitions of L*, a*, and b* are described in Shikisai Kogaku, Tokyo Denki University Press, etc.

The a* of one polarizing plate is preferably −2.5 to 0.2, more preferably −2.0 to 0. The b* of one polarizing plate is preferably 1.5 to 5, more preferably 2 to 4.5. The a* of a parallel transmitted light in two polarizing plates is preferably −4.0 to 0, more preferably −3.5 to −0.5. The b* of a parallel transmitted light in two polarizing plates is preferably 2.0 to 8, more preferably 2.5 to 7. The a* of a perpendicular transmitted light in two polarizing plates is preferably −0.5 to 1.0, more preferably 0 to 2. The b* of a perpendicular transmitted light in two polarizing plates is preferably −2.0 to 2, more preferably −1.5 to 0.5.

The hue may be evaluated by chromaticity coordinates (x, y) calculated from the above X, Y, and Z. For example, it is preferred that the parallel transmitted light chromaticity (xₚ, yₚ) and the perpendicular transmitted light chromaticity (x_{c}, y_{c}) of two polarizing plates are within ranges described in JP-A-2002-214436, Paragraph 0017, JP-A-2001-166136, Paragraph 0007, or JP-A-2002-169024, Paragraph 0005 to 0008, and that the relation between the hue and absorbance is within a range described in JP-A-2001-311827, Paragraph 0005 to 0006.

### (3) Viewing Angle Properties

It is preferred that, when the polarizing plate is disposed in the crossed nicols state and a light having a wavelength of 550 nm is injected thereinto, the transmittance ratio and the xy chromaticity differences between a vertically light injection and a light injected from an angle of 45° against the polarizing axis at an angle of 40° against the normal line are within ranges described in JP-A-2001-166135 or JP-A-2001-166137. It is preferred that the ratio T₆₀/T₀, in which T₀ is a light transmittance of a polarizing plate stack placed in the crossed nicols state in the vertically direction and T₆₀ is a light transmittance in the direction at an angle of 60° against the normal line of the stack, is 10,000 or less as described in JP-A-10-068817. It is preferred also that, in a case where a natural light is injected to the polarizing plate from the normal line direction or at an elevation angle of 80° or less, the transmittance difference of transmitted lights is 6% or less in 20 nm within a transmission spectrum wavelength range of 520 to 640 nm as described in JP-A-2002-139625. Further, it is preferred that the brightness difference of the transmitted lights between regions 1 cm away from each other is 30% or less as described in JP-A-08-248201.

### (4) Durability

### (4-1) Temperature and Humidity Durability

When the light transmittance and polarization degree are measured before and after the polarizing plate is left under a temperature of 60° C. and a relative humidity of 95% for 500 hours, the change of the light transmittance and polarization degree are preferably 3% or less based on the absolute values. The change of the light transmittance is particularly preferably 2% or less, and the change of the polarization degree is particularly preferably 1.0% or less, based on the absolute values. Further, it is preferred that the polarizing plate has a polarization degree of 95% or more and a single transmittance of 38% or more after the polarizing plate is left under a temperature of 80° C. and a relative humidity of 90% for 500 hours as described in JP-A-07-077608.

### (4-2) Dry Durability

When the light transmittance and polarization degree are measured before and after the polarizing plate is left under a dry condition at 80° C. for 500 hours, the change of the light transmittance and polarization degree are preferably 3% or less based on the absolute values. The change of the light transmittance is particularly preferably 2% or less, and the change of the polarization degree is particularly preferably 1.0% or less, furthermore preferably 0.1% or less, based on the absolute values.

### (4-3) Other Durability

Further, it is preferred that the shrinkage ratio of the polarizing plate by leaving the polarizing plate at 80° C. for 2 hours is 0.5% or less as described in JP-A-06-167611. Also it is preferred that, when a stack is prepared by disposing the polarizing plates on the both sides of a glass plate in the crossed nicols state and left at 69° C. for 750 hours, x and y values of the stack are within ranges described in JP-A-10-068818 after the leaving. Furthermore, it is preferred that, when the polarizing plate is left at 80° C. under a relative humidity of 90% for 200 hours, the change of spectral intensity ratio between 105 cm⁻¹ and 157 cm⁻¹ obtained by Raman spectroscopy is within a range described in JP-A-08-094834 or JP-A-09-197127.

### (5) Alignment Degree

More excellent polarization performance is achieved as the alignment degree of the PVA is increased. The alignment degree calculated as order parameter values by polarized Raman scattering or polarized FT-IR, etc. is preferably 0.2 to 1.0. Also it is preferred that difference between an alignment coefficient of a high-molecular segment in the entire amorphous region of the polarizer and an alignment coefficient of occupying molecules (0.75 or more) is at least 0.15 as described in JP-A-59-133509. Further, it is preferred that the alignment coefficient of the amorphous region in the polarizer is 0.65 to 0.85 or that the alignment degree of the higher iodine ion such as 13- and 15 is 0.8 to 1.0 as an order parameter value as described in JP-A-04-204907.

### (6) Other Properties

It is preferred that the shrinkage force per unit width in the absorption axis direction is 4.0 N/cm or less when the polarizing plate is heated at 80° C. for 30 minutes as described in JP-A-2002-006133, that the dimension changes of the polarizing plate in the absorption axis direction and the polarizing axis direction are both within ±0.6% when the polarizing plate is heated at 70° C. for 120 hours as described in JP-A-2002-236213, and that the water content of the polarizing plate is 3% by mass or less as described in JP-A-2002-090546. Further, it is preferred that the surface roughness in a direction vertically to the stretching axis is 0.04 μm or less based on the center line average roughness as described in JP-A-2000-249832, that the refractive index no in the transmission axis direction is 1.6 or more as described in JP-A-10-268294, and that the relation between the polarizing plate thickness and the protective film thickness is within a range described in JP-A-10-111411, Paragraph 0004.

### <Functionalization of Polarizing Plate>

The polarizing plate used in the invention may be preferably used as a functionalized polarizing plate by combining with an antireflection film for increasing visibility of the display, a brightness increasing film, or an optical film having a functional layer such as a hard coating layer, a forward scattering layer, or an antiglare (antidazzle) layer.

### (Antireflection Film)

The polarizing plate used in the invention may be used in combination with an antireflection film. The antireflection film may be a film with a reflectivity of about 1.5% composed of a single layer of a low refractive material such as a fluorine polymer, or a film with a reflectivity of about 1% utilizing interference of thin layers. In the invention, it is preferred that a low refractive layer and at least one layer having a refractive index higher than that of the low refractive layer (a high refractive layer or an middle refractive layer) are stacked on a transparent support. Further, also antireflection films described in Nitto Giho, Vol. 38, No. 1, May 2000, Page 26 to 28, JP-A-2002-301783, etc. may be preferably used in the invention.

The refractive indexes of the layers satisfy the following relations.

Refractive index of high refractive layer>Refractive index of middle refractive layer>Refractive index of transparent support>Refractive index of low refractive layer

The transparent support used for the antireflection film may be preferably the above mentioned transparent polymer film for the protective film of the polarizer.

The refractive index of the low refractive layer is preferably 1.20 to 1.55, more preferably 1.30 to 1.50. It is preferred that the low refractive layer is used as the outermost layer having an excoriation resistance and antifouling property. It is also preferred that a silicone-containing compound or a fluorine-containing compound, etc. is used for improving the slipping property of the surface to increase the excoriation resistance.

For example, compounds described in JP-A-9-222503, Paragraph 0018 to 0026, JP-A-11-38202, Paragraph 0019 to 0030, JP-A-2001-40284, Paragraph 0027 to 0028, JP-A-2000-284102, etc. can be preferably used as the fluorine-containing compound.

The silicone-containing compound preferably has a polysiloxane structure. Reactive silicones such as SILAPLANE available from Chisso Corporation and polysiloxanes having silanol end groups described in JP-A-11-258403, etc. can be used as the compound. An organic metal compound such as a silane coupling agent and a silane coupling agent having a particular fluorine-containing hydrocarbon group may be hardened by a condensation reaction in the presence of a catalyst, as described in JP-A-58-142958, JP-A-58-147483, JP-A-58-147484, JP-A-9-157582, JP-A-11-106704, JP-A-2000-117902, JP-A-2001-48590, JP-A-2002-53804, etc.

The low refractive layer may preferably contain another additive such as a filler (e.g. low refractive inorganic compound having an average primary particle size of 1 to 150 nm composed of silicon dioxide (silica) or a fluorine-containing compound (magnesium fluoride, calcium fluoride, barium fluoride, etc.), a fine organic particle described in JP-A-11-3820, Paragraph 0020 to 0038), a silane coupling agent, a slipping agent, or a surfactant.

The low refractive layer may be formed by a gas phase method such as a vacuum deposition method, a sputtering method, an ion plating method, or a plasma CVD method, and is preferably formed by a coating method advantageous in low costs. Preferred examples of the coating methods include dip coating methods, air-knife coating methods, curtain coating methods, roller coating methods, wire bar coating methods, gravure coating methods, and microgravure coating methods.

The thickness of the low refractive layer is preferably 30 to 200 nm, more preferably 50 to 150 nm, most preferably 60 to 120 nm.

The middle refractive layer and the high refractive layer are preferably such that high refractive inorganic compound ultrafine particles with an average particle size of 100 nm or less are dispersed in a matrix material. The high refractive inorganic compound fine particles are preferably composed of an inorganic compound having a refractive index of 1.65 or more such as an oxide of Ti, Zn, Sb, Sn, Zr, Ce, Ta, La, In, etc. or a multiple oxide containing the metal atom.

The ultrafine particles may be used such that the particle surfaces are treated with a surface treatment agent such as a silane coupling agent described in JP-A-11-295503, JP-A-11-153703, JP-A-2000-9908, etc., or an anionic compound or organic metal coupling agent described in JP-A-2001-310432, etc., such that a core-shell structure is formed by using high refractive particles as cores as described in JP-A-2001-166104, or such that a particular dispersant is used in combination as described in JP-A-11-153703, U.S. Pat. No. 6,210,858B1, JP-A-2002-2776069, etc.

The matrix material may be a known thermoplastic resin or hardening resin coating, etc., and may be a polyfunctional material described in JP-A-2000-47004, JP-A-2001-315242, JP-A-2001-31871, JP-A-2001-296401, etc. or a hardening film derived from a metal alkoxide composition described in JP-A-2001-293818, etc.

The refractive index of the high refractive layer is preferably 1.70 to 2.20. The thickness of the high refractive layer is preferably 5 nm to 101m, more preferably 10 nm to 1 μm.

The refractive index of the middle refractive layer is controlled at a value between those of the low refractive layer and the high refractive layer. The refractive index of the middle refractive layer is preferably 1.50 to 1.70.

The haze of the antireflection film is preferably 5% or less, more preferably 3% or less. The strength of the film is preferably H or more, more preferably 2H or more, most preferably 3H or more, in a pencil hardness test in accordance with JIS K5400.

### (Brightness Increasing Film)

In the invention, the polarizing plate may be used in combination with a brightness increasing film. The brightness increasing film has a function of separating a circular polarized light or a linearly polarized light, is placed between the polarizing plate and a backlight, and reflects or scatters a circular polarized light or linearly polarized light backward to the backlight. The light reflected by the backlight is in a partly changed polarization state, and is injected again to the brightness increasing film and the polarizing plate. In this case, a part of the light is transmitted therethrough, whereby the light utilization ratio is increased by repeating the processes to improve the front brightness about 1.4 times. In the invention, the polarizing plate may be used in combination with a known brightness increasing film such as an anisotropy reflection type film or an anisotropy scattering type film.

A known anisotropy reflection type brightness increasing film is such that uniaxially stretched films and unstretched films are stacked to enlarge the refractive index difference in the stretch direction, thereby showing a reflectivity and a transmittance anisotropy. Such brightness increasing films include multilayer films using dielectric mirror described in WO 95/17691, WO 95/17692, and WO 95/17699, and cholesteric liquid crystal films described in EP No. 606940A2 and JP-A-8-271731. In the invention, DBEF-E, DBEF-D, and DBEF-M available from 3M is preferably used as the multilayer brightness increasing film using the dielectric mirror principle, and NIPOCS available from Nitto Denko Corporation is preferably used as the cholesteric liquid crystal brightness increasing film. NIPOCS is described in Nitto Giho, Vol. 38, No. 1, May 2000, Page 19 to 21, etc.

In the invention, also an anisotropy scattering type brightness increasing film prepared by blending a positive intrinsic birefringence polymer and a negative intrinsic birefringence polymer and by uniaxial stretching, described in WO 97/32223, WO 97/32224, WO 97/32225, WO 97/32226, JP-A-9-274108, and JP-A-11-174231, is preferably used in combination. DRPF-H available from 3M is preferably used as the anisotropy scattering type brightness increasing film.

### (Other Functional Optical Film)

In the invention, the polarizing plate is preferably used in combination with a functional optical film having a hard coating layer, a forward scattering layer, an antiglare (antidazzle) layer, a gas barrier layer, a slipping layer, an antistatic layer, an undercoat layer, a protective layer, etc. Further, it is preferred that these functional layers are combined with the antireflection layer of the antireflection film or the optically anisotropic layer in one layer. These functional layers may be formed on one or both of the polarizer side and the opposite side near the air interface.

### [Hard Coating Layer]

The polarizing plate is preferably combined with a functional optical film prepared by forming a hard coating layer on a transparent support to improve the mechanical strength such as excoriation resistance. Particularly in the case of forming the hard coating layer in the above antireflection film, the hard coating layer is preferably formed between the transparent support and the high refractive layer.

The hard coating layer is preferably formed by a crosslinking reaction of a hardening compound by light and/or heat, or a polymerization reaction. A hardening functional group of the compound is preferably a photopolymerizable group, and an organic alkoxysilyl compound is preferably used as a hydrolyzable functional group-containing, organic metal compound. A hard coating layer composition described in JP-A-2002-144913, JP-A-2000-9908, and WO 00/46617, etc. is preferably used in the invention.

The thickness of the hard coating layer is preferably 0.2 to 100 μm.

The strength of the hard coating layer is preferably H or more, more preferably 2H or more, most preferably 3H or more, by a pencil hardness test in accordance with JIS K5400. Further, in a taber test according to JIS K5400, the hard coating layer more preferably has a smaller abrasion.

Compounds having an unsaturated ethylenic group and compounds having a ring opening polymerizable group can be used as materials for the hard coating layer, and the compounds may be used singly or in combination. Preferred examples of the compounds having the unsaturated ethylenic groups include polyol polyacrylates such as ethyleneglycol diacrylate, trimethylolpropane triacrylate, ditrimethylolpropane tetraacrylate, pentaerythritol triacrylate, pentaerythritol tetraacrylate, dipentaerythritol pentaacrylate, and dipentaerythritol hexaacrylate; epoxy acrylates such as diacrylate of bisphenol A diglycidyl ether and diacrylate of hexanediol diglycidyl ether; and urethane acrylates prepared by a reaction of a polyisocyanate and a hydroxyl-containing acrylate such as hydroxyethyl acrylate. Examples of commercially available compounds include EB-600, EB-40, EB-140, EB-1150, EB-1290K, IRR214, EB-2220, TMPTA, and TMPTMA available from Daicel ucb, and UV-6300 and UV-1700B available from Nippon Synthetic Chemical Industry Co., Ltd.

Preferred examples of the compounds having a ring opening polymerizable group include glycidyl ethers such as ethylene glycol diglycidyl ether, bisphenol A diglycidyl ether, trimethylolethane triglycidyl ether, trimethylolpropane triglycidyl ether, glycerol triglycidyl ether, triglycidyl trishydroxyethyl isocyanurate, sorbitol tetraglycidyl ether, pentaerythritol tetraglycidyl ether, polyglycidyl ethers of cresol novolac resins, and polyglycidyl ethers of phenol novolac resins; alicyclic epoxys such as CELOXIDE 2021P, CELOXIDE 2081, EPOLEAD GT-301, EPOLEAD GT-401, and EHPE3150CE available from Daicel Chemical Industries, Ltd., and polycyclohexyl epoxymethyl ether of phenol novolac resins; oxetanes such as OXT-121, OXT-221, OX-SQ, and PNOX-1009 available from Toagosei Co., Ltd. Further, polymers of glycidyl(meth)acrylate, and copolymers of glycidyl (meth)acrylate and a monomer copolymerizable therewith may be used for the hard coating layer.

It is preferred that fine particles of oxides of silicon, titanium, zirconium, aluminum, etc., crosslinked particles of polyethylenes, polystyrenes, poly(meth)acrylic esters, polydimethylsiloxanes, etc., and organic crosslinked fine particles such as crosslinked rubber particles of SBR, NBR, etc. are added to the hard coating layer to reduce hardening shrinkage of the hard coating layer, increase the adhesion to the substrate, and reduce curling of the hard coating product. The average particle size of these crosslinked fine particles is preferably 1 to 20,000 nm. The shape of the crosslinked fine particles is not particularly limited, and may be a spherical shape, rod-like shape, needle-like shape, tabular shape, etc. The amount of the fine particles is preferably such that the fine particle content of the hardened hard coating layer is 60% or less by volume. The fine particle content is more preferably 40% or less by volume.

In the case of adding the above described inorganic fine particles, which are poor in affinity for binder polymers generally, a surface treatment is preferably carried out using a surface treatment agent having a metal such as silicon, aluminum, or titanium, and a functional group such as an alkoxide group, a carboxylic acid group, a sulfonic acid group, or a phosphonic acid group.

The hard coating layer is hardened preferably by heat or an activation energy ray, and more preferably by an activation energy ray such as a radioactive ray, a gamma ray, an alpha ray, an electron ray, or a ultraviolet ray, and particularly preferably by an electron ray or a ultraviolet ray in view of safeness and productivity. In the case of the heat hardening, the heating temperature is preferably 140° C. or lower, more preferably 100° C. or lower, in view of the heat resistance of the plastic.

### [Forward Scattering Layer]

The forward scattering layer is used for improving the viewing angle properties (the hue and brightness distribution) in the directions of up, down, left, and right, of the liquid crystal display device containing the polarizing plate according to the invention. In the invention, the forward scattering layer is preferably composed of fine particles with different refractive indexes dispersed in a binder. For example, the forward scattering layer may have such a structure that the forward scattering coefficient is particularly controlled as described in JP-A-11-38208, that relative refractive indexes of a transparent resin and fine particles are particularly controlled as described in JP-A-2000-199809, or that the haze is controlled at 40% or more as described in JP-A-2002-107512. Further, it is preferred that the polarizing plate is used in combination with LIJMISTY described in Sumitomo Chemical Co., Ltd., Technical Report, Optical functional film, page 31 to 39 to control the haze viewing angle properties.

### [Antiglare Layer]

The antiglare (antidazzle) layer is used for scattering a reflected light to prevent glare. The antiglare function is obtained by forming concavity and convexity on the outermost surface of the liquid crystal display device. The haze of the optical film having the antiglare function is preferably 3 to 30%, more preferably 5 to 20%, most preferably 7 to 20%.

The concavity and convexity is preferably formed on the film surface by a method of adding fine particles (JP-A-2000-271878, etc.), a method of adding a small amount (0.1 to 50% by mass) of relatively large particles having a size of 0.05 to 2 μm (JP-A-2000-281410, JP-A-2000-95893, JP-A-2001-100004, JP-A-2001-281407, etc.), or a method of physically transferring the concavity and convexity to the film surface (such as a embossing method described in JP-A-63-278839, JP-A-11-183710, JP-A-2000-275401, etc.)

### <Liquid Crystal Display Device>

The liquid crystal display device of the invention is described below.

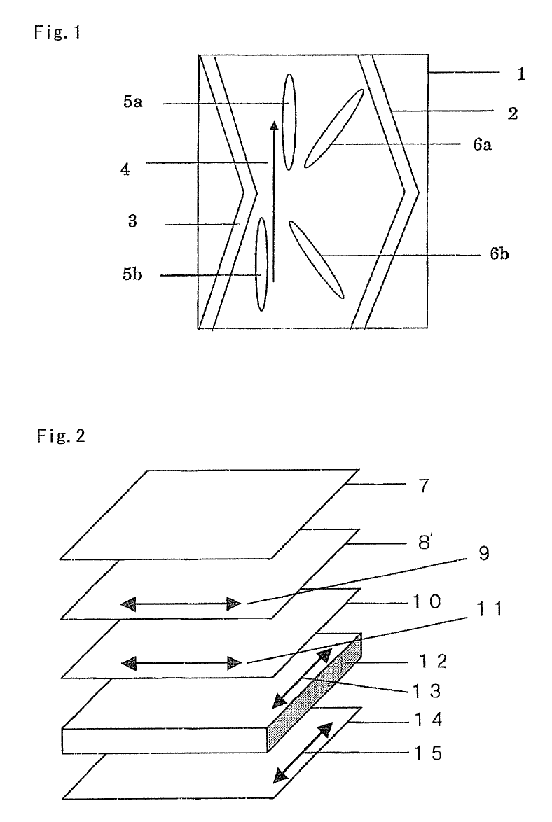

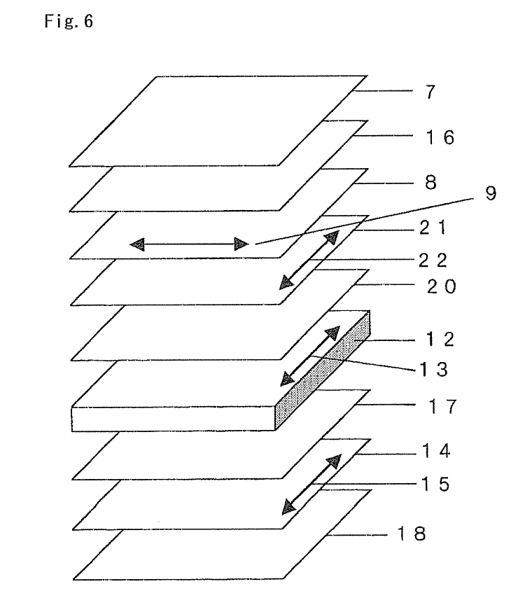

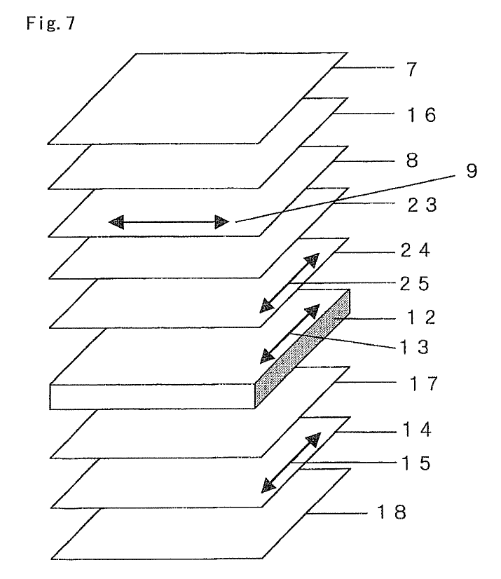

Hereinafter, the embodiment of the invention is described in detail with reference to the drawings. FIG. 1 is a schematic view showing an example of a pixel area of the liquid crystal display device of the invention. FIGS. 2 to 8 are schematic views of embodiments of the liquid crystal display device of the invention.

### [Liquid Crystal Display Device]

The liquid crystal display device as shown in FIG. 2 is constituted of a polarizer 8 and a polarizer 14, an optically anisotropic layer 10, and a light diffusing layer 7 that is disposed on the further viewer side, and a liquid crystal cell 12 composed of a liquid crystal layer that is held between two substrates.

In the liquid crystal display device in FIG. 2, the optimal value of the product Δn·d, in a transmission mode, of the thickness d (μm) and the refraction anisotropy Δn of the liquid crystal layer of the liquid crystal cell is within a range of 0.2 to 0.4 μm for an IPS type that has no twist structure. Since the product within this range results in a high white level brightness and a low black level brightness, a display device that is bright and has a high contrast can be obtained. On the surface of two substrates that contacts to the liquid crystal layer, the substrates constituting the liquid crystal cell, an alignment film may have been formed to align the liquid crystalline compound so as to be approximately parallel to the surface of two substrates, and to control the alignment direction of the liquid crystalline compound (slow axis direction 13 of the liquid crystal layer) in a state of no or low voltage application by rubbing treatment etc. that has been provided onto the alignment film. On the inner face of either of two substrates, electrodes capable of applying voltage to the liquid crystalline compound is formed.

In FIG. 1, schematically shown is the alignment of the liquid crystalline compound in one pixel area of the liquid crystal layer. In FIG. 1, 1 represents a pixel area of a liquid crystal element. FIG. 1 is a schematic view that shows the alignment of the liquid crystalline compound in an area having such a very small area as corresponding to one pixel of the liquid crystal layer, with a rubbing direction 4 of the alignment film that is formed on the inner face of the substrate and a pixel electrode 2 and a display electrode 3 that are formed on the inner face of the substrate and can apply voltage to the liquid crystalline compound. In case where an active drive is carried out using a nematic liquid crystal having a positive dielectric anisotropy as a field-effect type liquid crystal, the alignment direction of the liquid crystalline compound in a state of no or low voltage application (the director of the liquid crystal compound at the time of black level) is 5a and 5b to give the black level at this time. When voltage is applied between the electrodes 2 and 3, the liquid crystalline compound changes the alignment direction thereof in the 6a, 6b direction (the director of the liquid crystal compound at the time of white level) in accordance with the voltage. Usually, bright level (white level) is displayed in this state.

In FIG. 2 again, a polarized light absorption axis 9 of the polarizer 8 and a polarized light absorption axis 15 of the polarizer 14 are disposed perpendicular to each other, and a slow axis 13 of the liquid crystal layer of the liquid crystal cell is disposed perpendicular to the polarized light absorption axis 9 of the polarizer 8. The slow axis of the liquid crystal layer of the liquid crystal cell may be disposed perpendicular to the polarized light absorption axis 15 of the polarizer 14. An optically anisotropic layer 10 is disposed between the polarizer 8 and the liquid crystal cell 12, or between the polarizer 14 and the liquid crystal cell, or to the both positions. FIG. 2 illustrates such an instance that it is disposed between the polarizer 8 and the liquid crystal cell 12. A slow axis direction 11 of the optically anisotropic layer 10 may be perpendicular or parallel to the slow axis 13 of the liquid crystal layer. The light diffusing layer 7 is disposed on further viewer side compared with the polarizer 8.

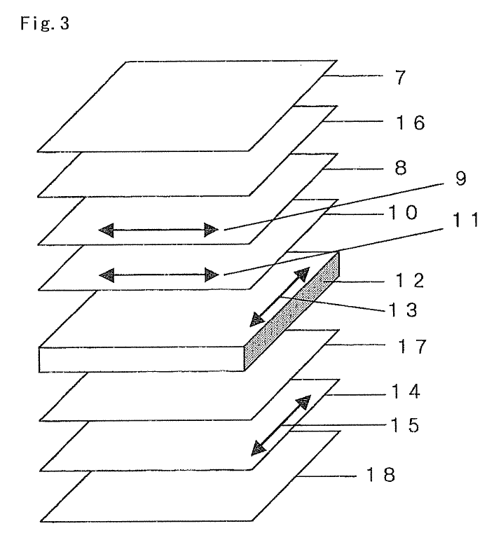

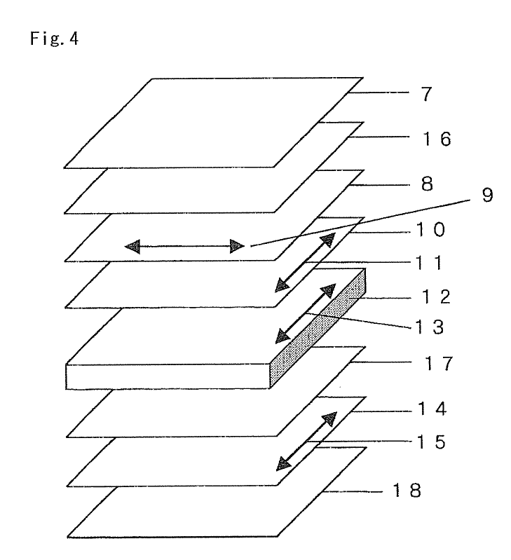

Other embodiment of the invention are shown in FIGS. 3 and 4. The polarizer 8 is held between a protective film 16 and the optically anisotropic layer 10, and the polarizer 14 is held between a protective film 17 and a protective film 18.

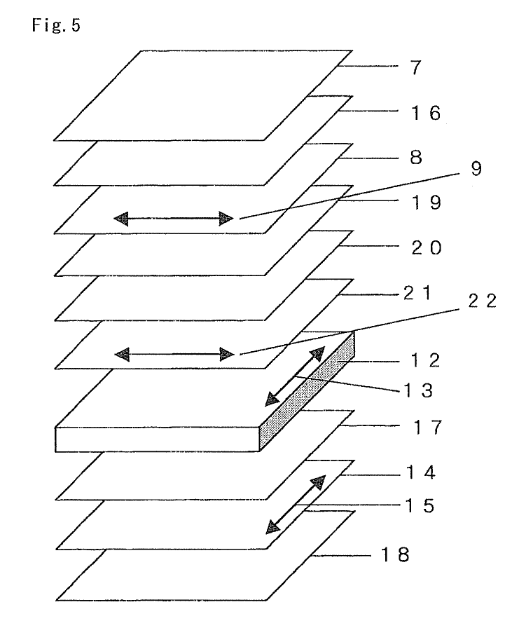

Further embodiments of the invention are shown in FIGS. 5, 6 and 7. Between the polarizer 8 and the liquid crystal cell 12, two layers of optically anisotropic layers 20 and 21, or 23 and 24 are disposed. In this case, the optically anisotropic layers 21 and 24 are optically anisotropic layer having refraction anisotropy at least in the plane, and the optically anisotropic layers 20 and 23 are a uniaxial optically anisotropic layer having refraction anisotropy in the thickness direction. They are used preferably as the combination thereof. Here, 22 and 25 indicate the slow axis direction of the respective optically anisotropic layers.

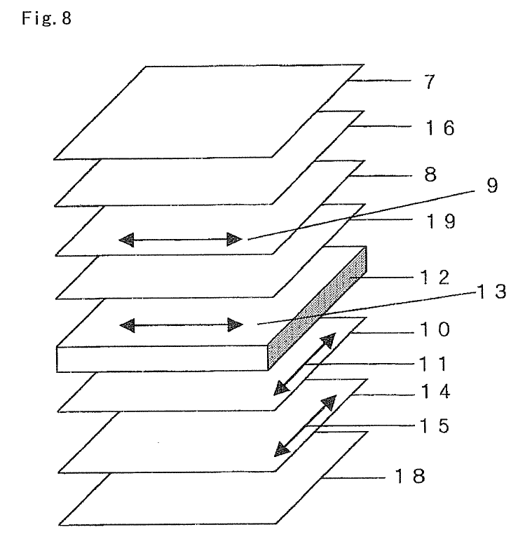

A further embodiment of the invention is illustrated in FIG. 8. The optically anisotropic layer 10 is disposed between the liquid crystal cell 12 and the polarizer 14.

As above, the liquid crystal display devices of the invention are described on the basis of the schematic views, but these are not limited to the constitutions as illustrated in FIGS. 2 to 8, but are used in arbitrarily combined constitutions thereof.

In the above-described embodiments, the forward wavelength dispersion low retardation film of the invention is used for at least one of protective films.

In FIGS. 2 to 8, there are shown such embodiments of a transparent mode display device that are provided with an upper polarizer and a lower polarizer. But the invention may be in a reflection mode embodiment that is provided with only one polarizing plate. In such a case, since the optical pass within the liquid crystal cell is doubled, the optimal Δn·d value becomes around ½ of the above-described value.

Furthermore, the liquid crystal display device of the invention is not limited to the constitution as shown in FIGS. 2 to 8, but it may contain other members. For example, a color filter may be disposed between the liquid crystal layer and the polarizer. The surface of the light diffusing layer may be subjected to a antireflection treatment or provided with a hard coat. Constitutional members having been provided with an electroconductive property may be employed. When the device is used as a transmissive type, such a backlight that has a cold cathode or hot cathode fluorescent lamp, a light-emitting diode, a field emission element, or an electroluminescent element as a light source may be provided on the backside. In this case, the backlight is disposed on the lower side in FIGS. 2 to 8. Between the liquid crystal layer and the backlight, there can be also disposed a polarizing plate and a diffusion plate of a reflection type, a prism sheet, and a light guide plate. As described above, the liquid crystal display device of the invention may be of a reflection type. In this case, only one polarizing plate may be disposed on the observing side, and a reflection film is disposed on the back face of the liquid crystal cell or on the inner face of the lower substrate of the liquid crystal cell. Of course it is also possible to provide a front light using the aforementioned light source on the observing side of the liquid crystal cell.

The liquid crystal display device of the invention includes an image direct-view type, an image projection type and a light modulation type. The invention can be applied especially effectively to an active matrix liquid crystal display device using such a 3-terminal or 2-terminal semiconductor element as a thin film transistor (TFT) or Metal Insulator Metal (MIM). Of course, an embodiment that is applied to such a passive matrix liquid crystal display device as called time division driving is also effective.

Hereinafter, the invention is described more specifically on the basis of Examples. Material, use quantity, percentage, treatment content, treatment procedure and the like that are shown in the following Examples can be arbitrarily changed within a range that does not result in deviation from the purpose of the invention. Accordingly, the scope of the invention should not be construed restrictively by undermentioned specific examples.

### EXAMPLE 1

### Formation of Forward Wavelength Dispersion Low Retardation Film 101

### <Preparation of Cellulose Acylate Solution>

The following composition was thrown into a mixing tank and stirred to dissolve respective ingredients, to prepare a cellulose acylate solution A.

Composition of Cellulose Acylate Solution A

| | |
|---|---|
| Cellulose acetate; acetyl substitution | 100.0 parts by mass |
| degree: 2.94, average polymerization | |
| degree: 310 | |
| Additive D-5 | 18.0 parts by mass |
| Methylene chloride (first solvent) | 402.0 parts by mass |
| Methanol (second solvent) | 60.0 parts by mass |

### <Preparation of Matting Agent Liquid>

The following composition was thrown into a dispersing machine and stirred to dissolve respective soluble ingredients, to prepare a matting agent liquid.

Composition of Matting Agent Liquid

| | |
|---|---|
| Silica particles having an average | 2.0 parts by mass |
| particulate size of 20 nm (AEROSIL | |
| R972, by AEROSIL) | |
| Methylene chloride (first solvent) | 75.0 parts by mass |
| Methanol (second solvent) | 12.7 parts by mass |
| Cellulose acylate solution A | 10.3 parts by mass |

### <Preparation of Wavelength Dispersion-Controlling Agent Solution>

The following composition was thrown into a mixing tank and stirred with heating to dissolve respective ingredients, to prepare a wavelength dispersion-controlling agent solution.

Composition of Wavelength Dispersion-Controlling Agent Solution

| | |
|---|---|
| Wavelength dispersion-controlling agent G | 20.0 parts by mass |
| Methylene chloride (first solvent) | 58.4 parts by mass |
| Methanol (second solvent) | 8.7 parts by mass |
| Cellulose acylate solution A | 12.8 parts by mass |

### Wavelength Dispersion-Controlling Agent G

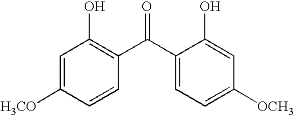

97.3 parts by mass of the cellulose acylate solution A, 1.3 parts by mass of the matting agent liquid, and 2.0 parts by mass of an ultraviolet absorber solution were mixed after filtration, then the mixture was cast with the width of 1600 mm using a band casting machine. The film was peeled off from the band at the residual solvent content of 50% by mass. The film was held with tenter clips and laterally stretched at the stretching ratio of 6% under the condition of 100° C., and dried till the residual solvent content became 5% by mass (drying 1). Further, the film was held at 100° C. for 30 seconds while keeping the width after the stretching. Then, the film was released from the tenter clips. After cutting off each 5% of the film from both ends in the width direction, the film was passed through a drying zone at 130° C. over 20 minutes in a free state (not held) in the width direction (drying 2). Then the film was wound in a roll. The obtained cellulose acylate film had a residual solvent content of 0.1% by mass and a thickness of 79 μm.

### EXAMPLE 2

### Formation of Forward Wavelength Dispersion Low Retardation Films 102 to 106

Forward wavelength dispersion films 102 to 106 were prepared in the same way as described above except for changing the type of cellulose acylate, the type and addition amount of the additive, and the film thickness to the content as listed in Table 1.

### COMPARATIVE EXAMPLE 1

### Formation of Polarizing Plate Protective Films 201 to 202

Polarizing plate protective films 201 to 202 were prepared in the same way as described above except for changing the type of cellulose acylate, the type and addition amount of the additive, and the film thickness to the content as listed in Table 1.

TABLE 1

| | | | | | | | | | Wavelength | | | |
|---|---|---|---|---|---|---|---|---|---|---|---|---|
| | Substitution degree of cellulose | | | | | | | | dispersion- | | | |
| | acylate | | | | Additive 1 | | Additive 2 | | controlling agent | | | |
| Film | Acetyl | Propionyl | Benzoyl | | | Addition | | Addition | | Addition | | |
| No. | group | group | group | Total | Type | amount^{a)} | Type | amount^{a)} | Type | amount^{a)} | Thickness | Remarks |
| 101 | 2.94 | 0.00 | 0.00 | 2.94 | D-5 | 18 | — | — | G | 2.4 | 79 | Invention |
| 102 | 1.95 | 0.95 | 0.00 | 2.90 | D-5 | 6 | — | — | G | 3.6 | 80 | Invention |
| 103 | 2.41 | 0.00 | 0.58^{b)} | 2.97 | D-5 | 8 | — | — | B-21 | 4.8 | 53 | Invention |
| 104 | 2.45 | 0.85 | 0.50^{c)} | 2.95 | triphenyl | 6 | biphenyl | 3 | H | 10 | 81 | Invention |
| | | | | | phosphate | | phosphate | | | | | |
| 105 | 2.45 | 0.00 | 0.50^{d)} | 2.95 | triphenyl | 5 | biphenyl | 4 | H | 8 | 81 | Invention |
| | | | | | phosphate | | phosphate | | | | | |
| 201 | 2.94 | 0.00 | 0.00 | 2.94 | D-5 | 12 | — | — | I | 1.2 | 80 | Comp. Ex. |
| 202 | 2.94 | 0.00 | 0.00 | 2.94 | D-5 | 12 | — | — | A | 3.6 | 82 | Comp. Ex. |

^{a)}% by mass relative to cellulose acylate
^{b)}substitution degree: 0.23 at 2-position, 0.06 at 3-position, 0.11 at 6-position
^{c)}substitution degree: 0.20 at 2-position, 0.17 at 3-position, 0.13 at 6-position
^{d)}substitution degree: 0.20 at 2-position, 0.17 at 3-position, 0.13 at 6-position

### Wavelength Dispersion-Controlling Agent H

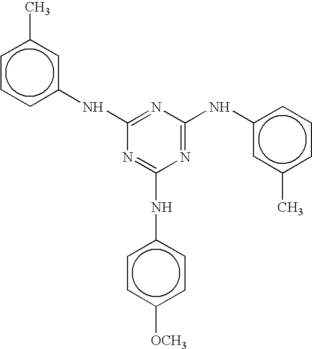

### Wavelength Dispersion-Controlling Agent I

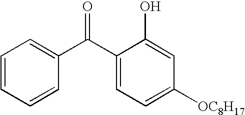

### (Measurement of Optical Properties)

For the forward wavelength dispersion films 102 to 105 of the invention and polarizing plate protective films 201 to 202 of the Comparative Example, measured were respective Re and Rth at 446 nm, 548 nm and 628 nm with “KOBRA-WR” by Oji Scientific Instruments under a circumstance of 25° C. and 60% relative humidity. The results are listed in Table 2.

TABLE 2

| | Re (nm) | | | Rth (nm) | | | |
|---|---|---|---|---|---|---|---|
| Film No. | Re (446) | Re (548) | Re (629) | Rth (446) | Rth (548) | Rth (629) | Remarks |
| 101 | 2 | 1 | 1 | 18 | 11 | 11 | Invention |
| 102 | 3 | 1 | 1 | 19 | 7 | 6 | Invention |
| 103 | 1 | 0 | 0 | 7 | 3 | 1 | Invention |
| 104 | 2 | 1 | 1 | 10 | 4 | 2 | Invention |
| 105 | 2 | 1 | 1 | −8 | −4 | −2 | Invention |
| 201 | 1 | 1 | 1 | −11 | −2 | 0 | Comp. Ex. |
| 202 | 5 | 3 | 3 | 51 | 37 | 36 | Comp. Ex. |

### EXAMPLE 3

### Saponification Treatment of Forward Wavelength Dispersion Low Retardation Film 101

The formed forward wavelength dispersion film 101 was dipped in a 2.3 mol/L aqueous solution of sodium hydroxide at 55° C. for 3 minutes, which was washed in a water washing bath at room temperature and then neutralized with 0.05 mol/L sulfuric acid at 30° C. It was washed again in a water washing bath at room temperature and dried with hot air at 100° C. Thus, the surface of the forward wavelength dispersion film 101 was saponified.

### (Saponification Treatment of Forward Wavelength Dispersion Low Retardation Films 102 to 105

In the same was as described for the forward wavelength dispersion low retardation film 101, each of the surface of cellulose acylate of forward wavelength dispersion low retardation films 102 to 105.

### EXAMPLE 4

### Formation of Polarizing Plate 101

### (Saponification Treatment of Polarizing Plate Protective Film)

A commercially available cellulose acetate film (FUJITAC TD80, by Fuji Film) was dipped in a 1.5 mol/L aqueous solution of sodium hydroxide at 55° C. for 1 minute, which was washed in a water washing bath at room temperature and then neutralized with 0.05 mol/L sulfuric acid at 30° C. It was washed again in a water washing bath at room temperature and dried with hot air at 100° C.

### (Formation of Polarizer)

To a stretched polyvinyl alcohol film, iodine was adsorbed to form a polarizer. On one side of the polarizer, the forward wavelength dispersion film 101 that had been saponified as described above was adhered with a polyvinyl alcohol-based adhesive. The absorption axis of the polarizer and the slow axis of the cellulose acylate film were so arranged that they were parallel to each other.

Further, the commercially available cellulose triacetate film that had been saponified as described above was adhered on the other side with a polyvinyl alcohol-based adhesive to form a polarizing plate 101.

### EXAMPLE 5

### Formation of Polarizing Plates 102 to 105

Forward wavelength dispersion films 102 to 105 were treated in the same way as in Example 4 to form polarizing plates 102 to 105.

### COMPARATIVE EXAMPLE 2

### Formation of Polarizing Plates 201 and 202

Polarizing plate protective films 201 and 202 having been formed in Comparative Example 1 were treated in the same was as in Example 4 to form polarizing plates 201 and 202.

### EXAMPLE 6

### Formation of Optically Anisotropic Layer

### [Optically Anisotropic Film R-01]

On both sides of a uniaxially stretched polycarbonate film having a thickness of 80 μm and Re of 230 nm, adhered were heat-shrinkable films made of a uniaxially stretched polyester film so that the slow axes thereof crossed perpendicularly to each other via an acrylic adhesive layer, which was heated and subjected to stretching treatment at 160° C. while allowing the heat-shrinkable films to shrink, and then the heat-shrinkable films were peeled off to form an optically anisotropic film R-01.

For the optically anisotropic film R-01, the light incident angle dependency of Re was measured using an auto-birefringence index meter (KOBRA-WR, by Oji Scientific Instruments) to calculate the optical properties. As the result, it was confirmed that Re is 270 nm and Rth is 0 nm.

### EXAMPLE 7

### Optically Anisotropic Film R-02

Respective ingredients of the following cellulose acetate solution composition were put in a mixing tank, which were stirred with heating to dissolve each ingredient, thereby preparing a cellulose acetate solution A.

### (Composition of Cellulose Acetate Solution A)

| | |
|---|---|
| Cellulose acetate having an acetylation | 100 parts by mass |
| degree of 60.9% | |
| Triphenyl phosphate (plasticizer) | 7.8 parts by mass |
| Biphenyldiphenyl phosphate (plasticizer) | 3.9 parts by mass |
| Methylene chloride (first solvent) | 318 parts by mass |
| Methanol (second solvent) | 47 parts by mass |

In a mixing tank, 16 parts by mass of the following retardation enhancing agent, 87 parts by mass of methylene chloride and 13 parts by mass of methanol were put, which were stirred with heating to prepare a retardation enhancing agent solution.

To 474 parts by mass of the cellulose acetate solution A composition, 43 parts by mass of the retardation enhancing agent solution were added, which were stirred sufficiently to prepare a dope. The addition amount of the retardation enhancing agent was 6.0 parts by mass relative to 100 parts by mass of cellulose acetate.

### Retardation Enhancing Agent

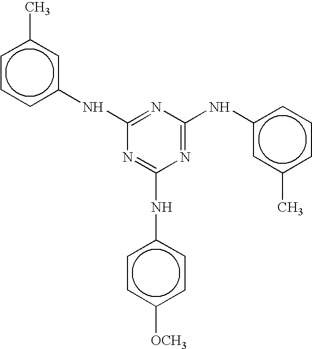

The dope was cast onto a band and peeled off at a residual solvent ratio of 32%, which was then transversely stretched with a tenter stretching machine. The stretching ratio was 25%, and the stretching temperature was 140° C. After that, it was dried with a hot air at 130° C. to form a cellulose acetate film. The dry thickness of the film was 85 μm. The optical propertied of the obtained cellulose acetate film was evaluated to confirm that Re is 65 nm and Rth is 200 nm.

After subjecting the surface of the formed cellulose acetate film to saponification treatment, on the film, coated was a coating liquid for an alignment film having the following composition with a wire bar coater in a volume of 20 ml/m². The coated product was dried with a hot air at 60° C. for 60 seconds, and further with a hot air at 100° C. for 120 seconds to form a film. Thus, an alignment film was obtained.

Composition of the coating liquid for an alignment film

| | |
|---|---|
| Undermentioned modified polyvinyl alcohol | 10 parts by mass |
| Water | 371 parts by mass |
| Methanol | 119 parts by mass |
| Glutaric aldehyde | 0.5 part by mass |

### Modified Polyvinyl Alcohol

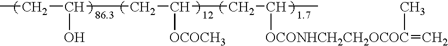

Next, a solution was prepared by dissolving 2.0 g of the following rod-shaped liquid crystal compound, 0.06 g of a photo polymerization initiator (IRGACURE 907, by Ciba Specialty Chemicals), 0.02 g of a sensitizer (Kayacure DETX, by NIPPON KAYAKIJ), 0.02 g of the following onium salt, 0.004 g of the following air interface side vertical alignment agent and 0.1 g of a UV-curable resin (KAYARAD DPHA, by NIPPON KAYAKU) in 3.9 g of methyl ethyl ketone. The coating solution was coated on the surface of the alignment film with a wire bar, which was attached to a metal frame and heated in a constant-temperature bath at 70° C. for 1 minute and 30 seconds to align the rod-shaped liquid crystal compound. Next, while keeping the temperature at 70° C., ultraviolet rays having an illuminance of 400 mW/cm² and irradiance level of 600 mJ/cm² were irradiated with an air cooling metal halide lamp of 160 W/cm (by EYEGRAPHICS) under nitrogen purge to cross-link the rod-shaped liquid crystal compounds. After that, it was cooled down to room temperature to form an optically anisotropic film R-02. The optical properties of the coated layer that was formed by cross-linking the rod-shaped liquid crystal compounds were examined to confirm that Re is 0 nm and Rth is to 256 nm, and that the rod-shaped liquid crystal compound was aligned vertical to the film surface and fixed.

### Rod-Shaped Liquid Crystal Compound

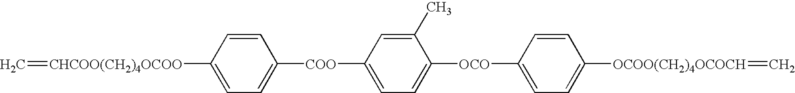

### Onium Salt

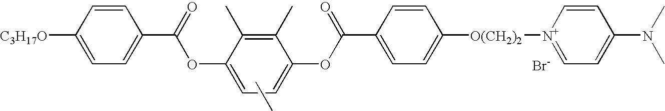

### Air Interface Side Vertical Alignment Agent

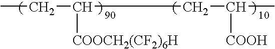

### EXAMPLE 8

### Optically Anisotropic Film R-03

A norbornen-based film having a thickness of 100 μm (ZEONOR, by ZEON) was uniaxially stretched (at 180° C., continuous stretching). The optical properties of the obtained norbornen-based film were evaluated to confirm that Re is 140 nm and Rth is 70 nm.

The surface of thus formed norbornen-based film in a roll shape was subjected continuously to corona discharge treatment. On it, an alignment film was formed in the same way as that for forming a vertical alignment film of the liquid crystal compound in the optically anisotropic film R-02, and further a coating thickness of the rod-shaped liquid crystal compound was adjusted, to form an optically anisotropic layer composed of the rod-shaped liquid crystal. The optical properties of a coated layer that was formed by cross-linking the rod-shaped liquid crystal compound was examined, and it was confirmed that Re is 0 nm and Rth is −100 nm, and that rod-shaped liquid crystal compound is aligned vertically to the film surface and fixed.

### EXAMPLE 9

### Optically Anisotropic Film R-04

The surface of a commercially available cellulose acetate film (FUJITAC TD80UF, by Fuji Film; Re=3 nm, Rth=45 nm) was saponified, on which a coating liquid for an alignment film having the following composition was coated in a volume of 20 ml/m² with a wire bar coater. Then, it was dried with a hot air at 60° C. for 60 seconds, and further with a hot air at 100° C. for 120 seconds to form a film. Next, the formed film was subjected to rubbing treatment in the direction parallel to the slow axis direction of the film to form an alignment film.

Composition of the coating liquid for an alignment film

| | |
|---|---|
| Undermentioned Modified polyvinyl alcohol | 10 parts by mass |
| Water | 371 parts by mass |
| Methanol | 119 parts by mass |
| Glutaric aldehyde | 0.5 part by mass |
| Compound B | 0.2 part by mass |
| Compound B | |

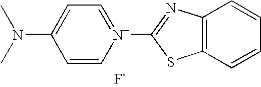

### Modified Polyvinyl Alcohol

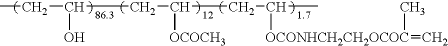

Next, on the alignment film having been subjected to rubbing treatment, a coating liquid having the undermentioned composition was coated with a wire bar.

| | |
|---|---|
| Discotic liquid crystalline compound | 1.8 g |
| Ethylene oxide-modified trimethylolpropane | 0.2 g |
| triacrylate (V#360, by OSAKA ORGANIC CHEMICAL) | |
| Photopolymerization initiator (IRGACURE 907, by | 0.06 g |
| Ciba-Geigy) | |
| Sensitizer (Kayacure DETX, by NIPPON KAYAKU) | 0.02 g |
| Air interface side vertical alignment agent | 0.01 g |
| (undermentioned compound A) | |
| Methyl ethyl ketone | 3.9 g |

The coated film was attached to a metal frame and heated in a constant-temperature bath at 125° C. for 3 minutes to align the discotic liquid crystal compound. Next, it was exposed to ultraviolet rays from a high-pressure mercury lamp of 120 W/cm for 30 seconds to cross-link the discotic liquid crystal compound. The UV-curing was carried out at 80° C. to give a retardation film. After that, it was cooled down to room temperature to give an optically anisotropic film R-04.

### Discotic Liquid Crystal Compound

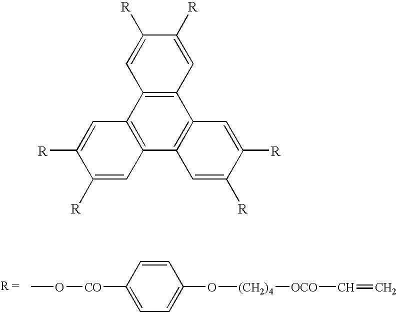

### Compound A

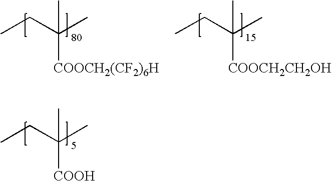

Optical properties of the discotic liquid crystalline retardation layer alone was evaluated to confirm that Re is 120 nm and Rth is −60 nm, and that the discotic crystalline compound is aligned in such a manner that the optical axis is parallel to the substrate relative to the film face. The slow axis direction was parallel to the rubbing direction of the alignment film.

### EXAMPLE 10

### Formation of Light Diffusing Layer

### [Light Diffusing Film HC-01]

A translucent resin for constituting the light diffusing layer was obtained by mixing and stirring 100 parts of a hard coat coating liquid containing a zirconium oxide ultrafine particle dispersion (DeSolite Z7404, by JSR), and 57 parts by mass of translucent resin DPHA (by NIPPON KAYAKU; a mixture of dipentaerythritol hexaacrylate and dipentaerythritol pentaacylate) in a methyl ethyl ketone/methyl isobutyl ketone (20/80 mass ratio) to dissolve. A coated film that was obtained by coating the liquid and curing the same with the ultraviolet ray irradiation had a refraction index of 1.61. To the liquid, 17 parts by mass of cross-linked polymethyl methacrylate-based beads (MX150, by Soken Chemical & Engineering, particle size: 1.5 μm, refraction index: 1.49) and 7 parts by mass of cross-linked polymethyl methacrylate-based beads (MX300, by Soken Chemical & Engineering, particle size: 3.0 μm, refraction index: 1.49) were added as translucent fine particles, which was adjusted with methyl ethyl ketone/methyl isobutyl ketone (20/80 mass ratio) to give a solid content of 50%. The dispersion was coated on a triacetyl cellulose film (TD-80U, by Fuji Film) to give a coating amount of 0.42 g/m² of the 1.5 μm polymethyl methacrylate-based beads. The coated layer was dried at 30° C. for 15 seconds, at 90° C. for 20 seconds, and then exposed to ultraviolet rays from a air cooling metal halide lamp of 160 W/cm (by EYEGRAPHICS) at an irradiance level of 50 mJ/cm² under nitrogen purge (oxygen concentration: 100 ppm) to be cured to form a light diffusing film HC-01. The dry thickness of the light diffusing layer of the film was 3.0 μm.

### EXAMPLE 11

### IPS Mode Liquid Crystal Cell for Implementation Evaluation

A liquid crystal cell was taken out from a commercially available IPS mode liquid crystal TV (CR-L26WA, by LG ELECTRONICS), and polarizing plates that were stuck to the viewer side and the backlight side were peeled off. In the liquid crystal cell, liquid crystal molecules were substantially in parallel alignment between glass substrates in the absence of an applied voltage and at the time of black level and the slow axis direction thereof was in a horizontal direction relative to the screen.

The light diffusion film HC-01C having been formed as described above was subjected to saponification treatment, which was adhered on one face of a polarizer having been formed by allowing a stretched polyvinyl alcohol film to adsorb iodine, with a polyvinyl alcohol-based adhesive. Further, the commercially available cellulose acetate film (FUJI TAC TD80, by Fuji Film) having been subjected to saponification treatment in Example 4 was stuck in the same way to the other face of the polarizer to form a viewer side polarizing plate.

On the viewer side of the IPS mode liquid crystal cell having been formed above, the optically anisotropic film R-01 was stuck so that the slow axis thereof was perpendicular to the liquid crystal layer slow axis direction of the liquid crystal cell. Further, on the optically anisotropic film R-01, the viewer side polarizing plate was stuck so that the absorption axis thereof was perpendicular to the liquid crystal layer slow axis direction of the liquid crystal cell. On the backlight side of the liquid crystal cell, a polarizing plate 101 was stuck so that the forward wavelength dispersion low retardation film 101 lay on the cell side and the absorption axis of the polarizing plate was parallel to the liquid crystal layer slow axis direction of the liquid crystal cell, to form a liquid crystal display device 101.

### EXAMPLES 12 TO 15

Each of liquid crystal display devices 102 to 105 was formed in the same way as that in Example 11 except that the backlight side polarizing plate was replaced with polarizing plates 102 to 105, respectively.

### EXAMPLES 16 TO 18

Each of liquid crystal display devices 106 to 108 was formed in the same way as that in Example 14, except that the optically anisotropic film R-02 to optically anisotropic film R-04, respectively, were used as the optically anisotropic film for use in the viewer side polarizing plate in place of the optically anisotropic film R-01.

### COMPARATIVE EXAMPLE 3

Each of liquid crystal display devices 201 to 202 were formed in the same way as that in Example 11 except that polarizing plates 201 to 202, respectively, were used for the backlight side polarizing plate.

For liquid crystal display device thus formed, visually evaluated was the hue change relative to the front side in an azimuthal angle direction of 45° and a polar angle direction of 60° from the front side of the apparatus at the time of black level, on the basis of the following standard.

### (Judgment Standard for Hue Change)

A: no coloring is recognized
B: slightly colored
C: weakly colored
D: strongly colored

In Table 3, the evaluation results are listed.

TABLE 3

| | | Liquid crystal | | |
|---|---|---|---|---|
| | | cell side | | |
| Liquid | | protective film | | |
| crystal | Optically | of polarizing | | |
| display | anisotropic | plate on | Hue change | |
| device | film | backlight side | of black | Remarks |
| 101 | R-01 | 301 | B | Invention |
| 102 | R-01 | 301 | B | Invention |
| 103 | R-01 | 301 | A | Invention |
| 104 | R-01 | 301 | A | Invention |
| 105 | R-01 | 301 | A | Invention |
| 106 | R-02 | 301 | A | Invention |
| 107 | R-03 | 302 | A | Invention |
| 108 | R-04 | 303 | A | Invention |
| 201 | R-01 | 301 | C | Comparative |
| | | | | Example |
| 202 | R-01 | 301 | D | Comparative |
| | | | | Example |

From the evaluation results shown in Table 3, it is known that the liquid crystal display device using the forward wavelength dispersion low retardation film of the invention shows a small hue change irrespective of the viewing angle and is preferred.

While the present invention has been described in detail and with reference to specific embodiments thereof, it will be apparent to one skilled in the art that various changes and modifications can be made therein without departing from the spirit and scope thereof.

The present disclosure relates to the subject matter contained in Japanese Patent Application No. 092083/2006 filed on Mar. 29, 2006, which is expressly incorporated herein by reference in its entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

1. A polymer film having Rth and Re that satisfy the following formulae (1) to (4):
−25 nm≦Rth(548)≦25 nm (1)
0≦Rth(446)−Rth(548)≦50 (2)
0≦Rth(548)−Rth(629)≦20 (3)
0 nm≦Re(548)≦5 nm (4)
wherein Rth(λ) represents the value of Rth that is measured at a wavelength of λ nm.

2. The polymer film according to claim 1 comprising mainly cellulose acylate.

3. The polymer film according to claim 1 comprising a compound having at least one absorption maximum within a wavelength range of 250 nm to 400 nm in 1% by mass to 30% by mass.

4. The polymer film according to claim 1 comprising mainly cellulose acylate having an acyl substitution degree of 2.90 to 3.00.

5. The polymer film according to claim 1 comprising mainly a mixed aliphatic acid ester of cellulose having a total acyl substitution degree of 2.70 to 3.00.

6. The polymer film according to claim 1 comprising at least one of compounds as shown by the following formula (B): 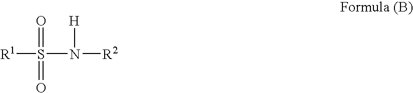
wherein R¹ and R² each independently represents an alkyl group or an aryl group.

7. The polymer film according to claim 1 comprising acrylic polymer having a weight average molecular weight of 500 to 10,000.

8. A polarizing plate protective film comprising the polymer film according to claim 1.

9. A polarizing plate comprising a polarizer and a protective film that is disposed at least on one side of the polarizer, wherein the protective film is the polymer film according to claim 1.

10. A liquid crystal display device comprising a liquid crystal cell and two polarizing plates that are disposed on both sides thereof, the polarizing plate comprising a polarizer and two protective films that are disposed on both sides thereof, wherein at least one of the protective films on the liquid crystal cell side of the polarizing plate is the polarizing plate protective film according to claim 1.

11. The liquid crystal display device according to claim 10 wherein the liquid crystal cell is of the IPS mode.
